(19) United States
(12) Patent Application Publication
(10) Pub. No.: US 2024/0422575 A1
(43) Pub. Date: Dec. 19, 2024

(54) SAVING POWER IN A COMMUNICATION DEVICE WITH A CONDITIONAL CONFIGURATION

(71) Applicant: GOOGLE LLC, Mountain View, CA (US)

(72) Inventor: Chih-Hsiang Wu, Taoyuan City (TW)

(21) Appl. No.: 18/004,878

(22) PCT Filed: Jul. 9, 2021
(86) PCT No.: PCT/US2021/041063

§ 371 Date: Jan. 9, 2023

Related U.S. Application Data
(60) Provisional application No. 63/050,089, filed on Jul. 9, 2020.

(51) Int. Cl. H04W 24/02; H04W 36/00; H04W 36/36; H04W 60/06; H04W 76/15

(52) U.S. Cl. CPC H04W 24/02; H04W 36/008355; H04W 36/362; H04W 60/06; H04W 76/15

(57) ABSTRACT

A method in a user device (UE) capable of operating in dual-mode connectivity (DC) with a master node (MN) and a secondary node (SN) of a radio access network (RAN) includes receiving, from the RAN, a configuration related to a DC procedure and a network-specified condition to be satisfied before the UE applies the configuration (3402); determining whether a single connectivity (SC) condition of the UE is satisfied (3404); and, when SC condition is satisfied, inhibiting the UE from applying the configuration (3406).

### TECHNICAL FIELD

This disclosure relates generally to wireless communications and, more particularly, to determining whether a communication device should perform a conditional procedure related to dual connectivity under certain conditions.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides signaling radio bearers (SRBs) and data radio bearers (DRBs) to the Radio Resource Control (RRC) sublayer. Generally speaking, the UE and a base station can use SRBs to exchange RRC messages as well as non-access stratum (NAS) messages, and can use DRBs to transport data on a user plane.

UEs can use several types of SRBs and DRBs. When operating in dual connectivity (DC), the cells associated with the base station operating the master node (MN) define a master cell group (MCG), and the cells associated with the base station operating as the secondary node (SN) define the secondary cell group (SCG). So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. Further, DRBs using the lower-layer resources of only the MN can be referred as MCG DRBs, DRBs using the lower-layer resources of only the SN can be referred as SCG DRBs, and DRBs using the lower-layer resources of both the MCG or and the SCG can be referred to as split DRBs.

The UE in some scenarios can concurrently utilize resources of multiple RAN nodes (e.g., base stations or components of a distributed base station), interconnected by a backhaul. When these network nodes support different radio access technologies (RATs), this type of connectivity is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN (via the PCell) and the SN (via the PSCell). In other scenarios, the UE utilizes resources of one base station at a time. One base station and/or the UE determines that the UE should establish a radio connection with another base station. For example, one base station can determine to hand the UE over to the second base station, and initiate a handover procedure.

3GPP technical specifications (TS) 36.300 and 38.300 describes procedures for handover (or called reconfiguration with sync) scenarios. These procedures involve messaging (e.g., RRC signaling and preparation) between RAN nodes that generally causes latency, which in turn increases the probability of handover procedures. These procedures do not involve conditions associated with the UE, and can be referred to as “immediate” handover procedures. R2-1914640 and R2-1914834 describes procedures for conditionally handover scenarios.

3GPP specification TS 37.340 (v16.0.0) describes procedures for a UE to add or change an SN in DC scenarios. These procedures involve messaging (e.g., RRC signaling and preparation) between radio access network (RAN) nodes. This messaging generally causes latency, which in turn increases the probability that the SN addition or SN change procedure will fail. These procedures, which do not involve conditions that are checked at the UE, can be referred to as “immediate” SN addition and SN change procedures.

UEs can also perform handover procedures to switch from one cell to another, whether in single connectivity (SC) or DC operation. The UE may handover from a cell of a first base station to a cell of a second base station, or from a cell of a first distributed unit (DU) of a base station to a cell of a second DU of the same base station, depending on the scenario. 3GPP specifications 36.300 v16.0.0 and 38.300 v16.0.0 describe a handover procedure that includes several steps (RRC signaling and preparation) between RAN nodes, which causes latency in the handover procedure and therefore increases the risk of handover failure. This procedure, which does not involve conditions that are checked at the UE, can be referred to as an “immediate” handover procedure.

More recently, for both SN or PSCell addition/change and handover, “conditional” procedures have been considered (i.e., conditional SN or PSCell addition/change and conditional handover). Unlike the “immediate” procedures discussed above, these procedures do not add or change the SN or PSCell, or perform the handover, until the UE determines that a condition is satisfied. As used herein, the term “condition” may refer to a single, detectable state or event (e.g., a particular signal quality metric exceeding a threshold), or to a logical combination of such states or events (e.g., “Condition A and Condition B,” or “(Condition A or Condition B) and Condition C”, etc.).

To configure a conditional procedure, the RAN provides the condition to the UE, along with a configuration (e.g., a set of random-access preambles, etc.) that will enable the UE to communicate with the appropriate base station, or via the appropriate cell, when the condition is satisfied. For a conditional addition of a base station as an SN or a candidate cell as a PSCell, for example, the RAN provides the UE with a condition to be satisfied before the UE can add that base station as the SN or that candidate cell as the PSCell, and a configuration that enables the UE to communicate with that base station or PSCell after the condition has been satisfied.

A UE operating in DC with an MN and an SN generally consumes more power than when operating in SC. Moreover, when the MN and the SN operate according to different RATs, the UE may need to operate two separate chipsets. When the battery level is low, DC operation can consume enough power to render the UE unable to make emergency calls, or shut down completely.

### SUMMARY

A UE of this disclosure receives, from a radio access network (RAN), a conditional configuration related to a dual connectivity (DC) procedure and a condition for applying this conditional configuration. The DC procedure can be for example conditional SN addition or change (CSAC) or conditional PSCell addition or change (CPAC). The UE then detects a UE condition for inhibiting DC. The UE condition is not specified by the RAN. Because the UE condition inhibits the UE from performing a DC procedure, the condition can be referred to as the single connectivity (SC) condition.

One example condition is related to the battery (e.g., the remaining power level being below a certain threshold). Another example condition is that the minimum required data rate, which can satisfy the QoS requirements for the UE, is below a certain threshold. Yet another example condition is that none of the applications known to require DC for optimal operation is running currently on the UE. Still another example condition is that the carrier of the SN of the DC procedure does not satisfy a quality or strength requirement.

An example embodiment of these techniques is a method in a UE capable of operating in dual connectivity (DC) with a master node (MN) and a secondary node (SN) of a radio access network (RAN). The method includes receiving, by processing hardware and from the RAN, a configuration related to a DC procedure and a network-specified condition to be satisfied before the UE applies the configuration; determining, by processing hardware, whether a single connectivity (SC) condition of the UE is satisfied; and, when SC condition is satisfied, inhibiting, by the processing hardware, the UE from applying the configuration.

Another example embodiment of these techniques is a UE including processing hardware and configured to implement the method above.

Another example embodiment of these techniques is a a method in a radio access network (RAN) for configuring a UE. The method includes transmitting, by processing hardware and to the UE, a configuration related to a dual connectivity (DC) procedure and a network-specified condition to be satisfied before the UE applies the configuration; and providing, by the processing hardware to the UE, an indication of whether the UE is allowed to apply a single connectivity (SC) condition to determine whether the UE should apply the configuration.

Yet another example embodiment of these techniques is a base station including processing hardware and configured to implement the method above.

### BRIEF DESCRIPTION OF THE DRAWINGS

FIG. 1A is a block diagram of an example wireless communication network in which a UE, capable of operating in DC with an MN and an SN, determines whether to operate in DC in view of a low-power condition of a battery of the UE;

FIG. 1A is a block diagram of an example wireless communication network in which a UE, capable of operating in DC with an MN and an SN, determines whether to operate in DC in view of an SC condition of the UE;

FIG. 1B is a block diagram of another example wireless communication network, with multiple pairs of base station potentially supporting DC connectivity, in which the UE of this disclosure can operate;

FIG. 1C is a block diagram of modem-level modules and application-layer modules of the UE of this disclosure, which control DC operation of the UE;

FIG. 1D is a block diagram of another example implementation of the UE, where a DC controller also operates on the application layer;

FIG. 2 is a flow diagram of an example method for determining whether a UE should disable DC capability and (optionally) CA capability in view of a low-power condition of a battery, which can be implemented in the UE of FIG. 1;

FIG. 3 is a flow diagram of an example method for determining whether a UE should disable DC capability in view of one SC condition, and whether the UE should disable CA capability in view of a non-CA condition, which can be implemented in the UE of FIG. 1;

FIG. 4 is a messaging diagram of an example scenario in which a UE inhibits an MN from initiating an SN addition procedure, using an explicit indication that the UE has disabled DC capability;

FIG. 5 is a messaging diagram of an example scenario in which a UE, operating in an idle or inactive state of the RRC protocol, disables DC capability in response to detecting an SC condition;

FIG. 6 is a messaging diagram of an example scenario in which a UE, operating in a connected state of the RRC protocol, postpones the disabling of DC capability after detecting an SC condition;

FIG. 7 is a flow diagram of an example method for determining whether a UE should disable DC capability and (optionally) CA capability in response to detecting a predetermined operational condition prior to detecting an SC condition, which can be implemented in the UE of FIG. 1;

FIG. 8 is a flow diagram of an example method for determining whether the UE should disable DC capability and (optionally) CA capability in response to detecting a low-power condition of the battery prior to detecting a predetermined operational condition, which can be implemented in the UE of FIG. 1;

FIG. 9 is a flow diagram of another example method for determining whether a UE should disable DC capability and (optionally) CA capability in response to detecting a predetermined operational condition prior to detecting an SC condition, which can be implemented in the UE of FIG. 1;

FIG. 10 is a flow diagram of an example method for determining whether a UE should disable DC capability in response to detecting an SC condition prior to detecting a predetermined operational condition, and whether the UE should disable CA capability in view of detecting another an SC condition prior to detecting the predetermined operational condition, which can be implemented in the UE of FIG. 1;

FIG. 11 is a messaging diagram of an example scenario in which a UE, operating in an idle or inactive state of the RRC protocol, inhibits an MN from initiating an SN addition procedure by not providing a measurement report pertaining to the SN, in response to the UE detecting an SC condition;

FIG. 12 is a messaging diagram of an example scenario in which a UE, operating in a connected state of the RRC protocol, inhibits an MN from initiating an SN addition procedure, by not providing a measurement report pertaining to the SN;

FIG. 13 is a messaging diagram of an example scenario in which a UE inhibits an MN from initiating an SN addition procedure by transmitting an indication of SCG failure to the MN;

FIG. 14 is a messaging diagram of an example scenario in which a UE inhibits an MN from initiating an SN addition procedure by transmitting an indication of MCG failure to the MN;

FIG. 15 is a messaging diagram of an example scenario in which a UE causes an MN to initiate an SN release, by providing an “artificial” measurement report pertaining to the SN;

FIG. 16 is a messaging diagram of an example scenario in which a UE causes an SN to initiate an SN release, by providing an “artificial” measurement report pertaining to the SN;

FIG. 17 is a flow diagram of an example method for determining whether the UE should disable 5G NR operation for DC and (optionally) CA capability in view of detecting an SC condition, which can be implemented in the UE of FIG. 1;

FIG. 18 is a flow diagram of an example method for determining whether a UE operating in a connected state of the RRC protocol should disable 5G NR operation for DC in view of detecting an SC condition, which can be implemented in the UE of FIG. 1;

FIG. 19 is a flow diagram of an example method for determining whether a UE operating in an idle or inactive state of the RRC protocol should disable 5G NR operation for DC in view of detecting an SC condition, which can be implemented in the UE of FIG. 1;

FIG. 20 is a flow diagram of an example method for determining whether the UE should disable 5G NR operation for DC in view of an SC condition, and whether the UE should disable CA capability in view of a non-CA condition, which can be implemented in the UE of FIG. 1;

FIG. 21 is a flow diagram of an example scenario in which a UE releases one or more carrier frequencies of an SN in view of detecting an SC condition;

FIG. 22 is a flow diagram of an example scenario in which a UE inhibits an MN from initiating an SN addition procedure in view of an “artificial” measurement report and indication of SCG failure; and

FIG. 23 is a flow diagram of an example method for inhibiting the UE from operating in DC in view of an SC condition, which can be implemented in the UE of FIG. 1;

FIG. 24 is a messaging diagram of an example scenario in which a UE operating in SC or MR-DC receives a conditional configuration for a conditional SN addition or change (CSAC) procedure and performs a CSAC operation to connect to a C-PSCell, in accordance with know techniques;

FIG. 25 is a messaging diagram of an example scenario in which a UE detects an SC condition and stops monitoring the network-specified condition for a CSAC procedure;

FIG. 26 is a messaging diagram of an example scenario in which a UE detects an SC condition and inhibits a CSAC procedure from proceeding;

FIG. 27A is a messaging diagram of an example scenario in which a UE operating in MR-DC receives a conditional configuration for conditional PSCell addition or change (CPAC) and performs a CPAC operation to connect to a C-PSCell, in accordance with known techniques;

FIG. 27B is a messaging diagram of an example scenario similar to the scenario of FIG. 27A, but with the SN rather than the MN providing the conditional configuration, in accordance with known techniques;

FIG. 28 is a messaging diagram of an example scenario in which a UE detects an SC condition and stops monitoring the network-specified condition for a CPAC procedure;

FIG. 29 is a messaging diagram of an example scenario in which a UE detects an SC condition and inhibits a CPAC procedure from proceeding;

FIG. 30 is a flow diagram of an example method for disabling a conditional procedure in view of an SC condition, which can be implemented in the UE of this disclosure;

FIG. 31 is a flow diagram of an example method for disabling a conditional procedure in view of an SC condition and a type of the conditional procedure, which can be implemented in the UE of this disclosure;

FIG. 32 is a flow diagram of an example method for processing an SC condition and a condition for connecting to a PSCell, which can be implemented in the UE of this disclosure;

FIG. 33 is a flow diagram of an example method for processing an SC condition and a conditional handover, which can be implemented in the UE of this disclosure;

FIG. 34 is a flow diagram of an example method for processing conditional configuration related to DC, which can be implemented in a UE; and

FIG. 35 is a flow diagram of an example method for managing conditional configuration at a UE, which can be implemented in a base station.

### DETAILED DESCRIPTION OF THE DRAWINGS

As discussed below, a UE storing a conditional configuration related to a DC procedure can detect a single connectivity (SC) condition of the UE, such as a low-battery condition or a small required data rate condition, and determine whether the UE should apply the conditional configuration in view of the SC condition.

The RAN in some implementations provides an indication of whether the UE is allowed to apply a UE condition, such as the SC condition, to determine whether the conditional DC procedure should proceed. The indication can be a flag for example which the RAN transmits specifically to the UE or broadcasts in a cell, a cell group, etc.

In some implementations, after the UE determines that the SC condition no longer applies, the UE begins to check the network-specified condition for applying the conditional configuration.

The UE in some cases can determine that it should disable DC in response to detecting the SC condition. To this end, when the UE uses different chips or chipsets to communicate with the MN and the SN using the same or different RATs, the UE can enable or disable DC operation by enabling or disabling one of the chips. In another implementation, the UE continues operating both chipsets but stops monitoring the frequencies of the SN.

In some implementations, the UE transmits an explicit indication to the MN (e.g., a UE capability information message) to notify the MN regarding the current status of DC at the UE. For example, the UE in some implementations includes information such as a DC band combination, a DC support indicator, or a list of DC-supported bands in the radio access capability IE of the UE capability information message to indicate that the UE has enabled DC. To indicate that the UE has disabled DC, the UE does not include this information in the UE capability information message.

Alternatively, the UE can implicitly notify the MN DC regarding the current status of DC at the UE. For example, the UE in one implementation suspends measurement reports for a carrier frequency of the SN or transmits “artificial” reports that indicate to the MN low signal strength and/or low signal quality of the carrier frequency of the SN, regardless of whether the signal strength and/or the signal quality are in fact low. In this manner, the UE averts the MN from configuring the UE to use the carrier frequency of the SN in DC.

In addition to enabling or disabling DC operation, the UE in some implementations also enables or disables MN carrier aggregation (CA) in response to detecting a low-power condition of the battery. For example, the UE can include a CA band combination in the radio access capability IE to indicate that the UE continues to support CA, and not include a CA band combination to indicate that the UE has disabled CA. The UE in some implementations disables DC when the power level of the battery reaches a certain power level, and disables CA when the power level of the battery reaches another, lower power level.

Alternatively, the UE can implicitly notify the MN regarding the current status of CA at the UE. For example, the UE in one implementation suspends measurement reports for a carrier frequency of the MN or transmits “artificial” reports that indicate to the MN low signal strength and/or low signal quality of the carrier frequency of the MN, regardless of whether the signal strength and/or the signal quality are in fact low. In this manner, the UE averts the MN from configuring the UE to use the carrier frequency of the MN in CA.

In some implementations, to avoid dropping calls for example, the UE disables DC operation based not only on the low-power condition of the battery but also on an operational condition (such as a call being in progress, the screen being active, or the power-saving feature having been deactivated). As a more specific example, the UE postpones disabling DC when a call is in progress.

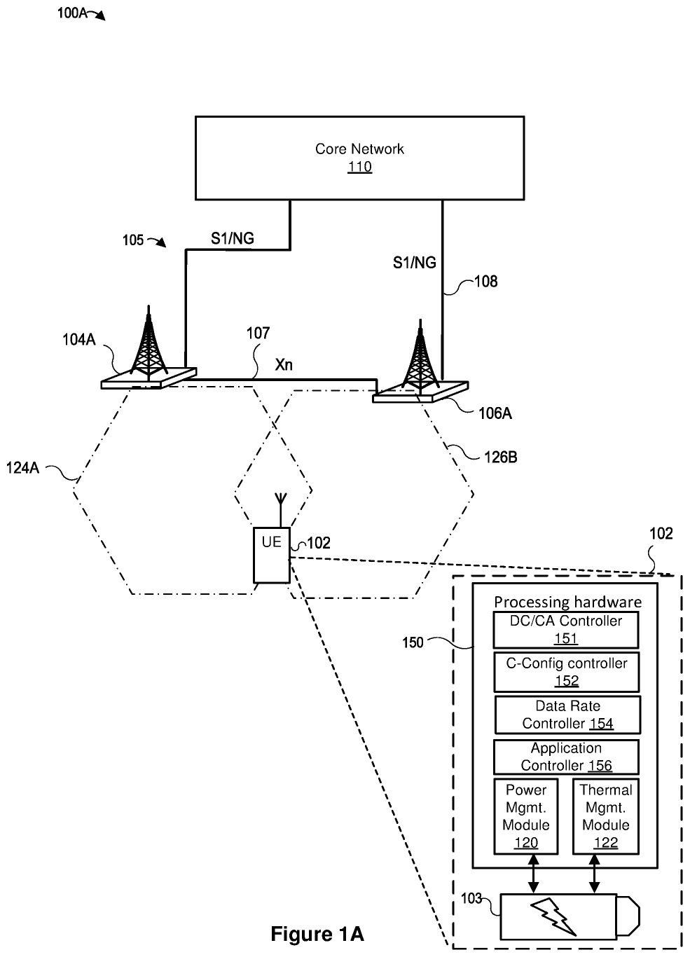

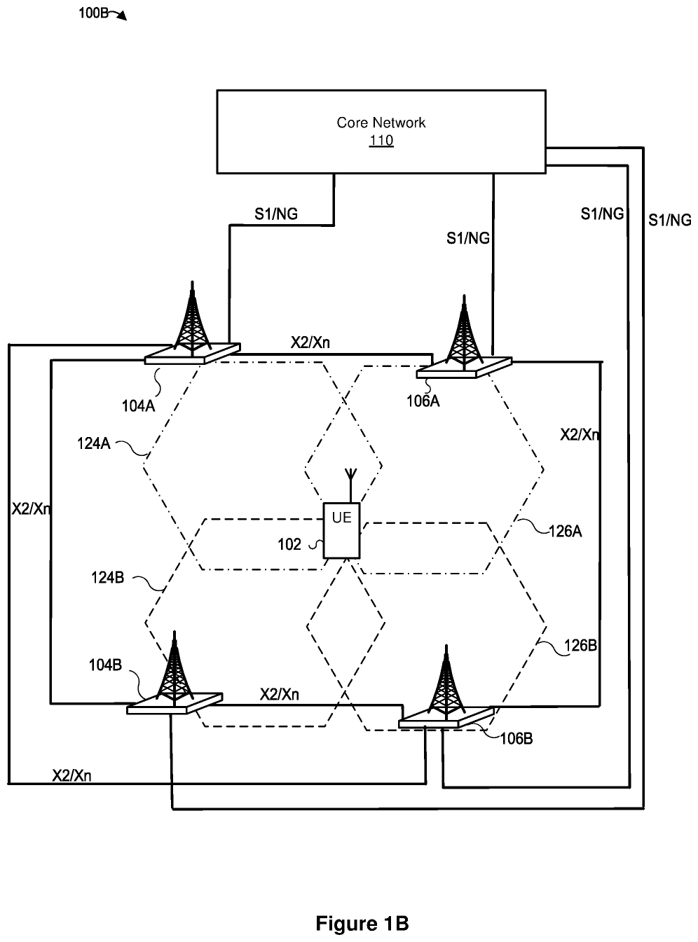

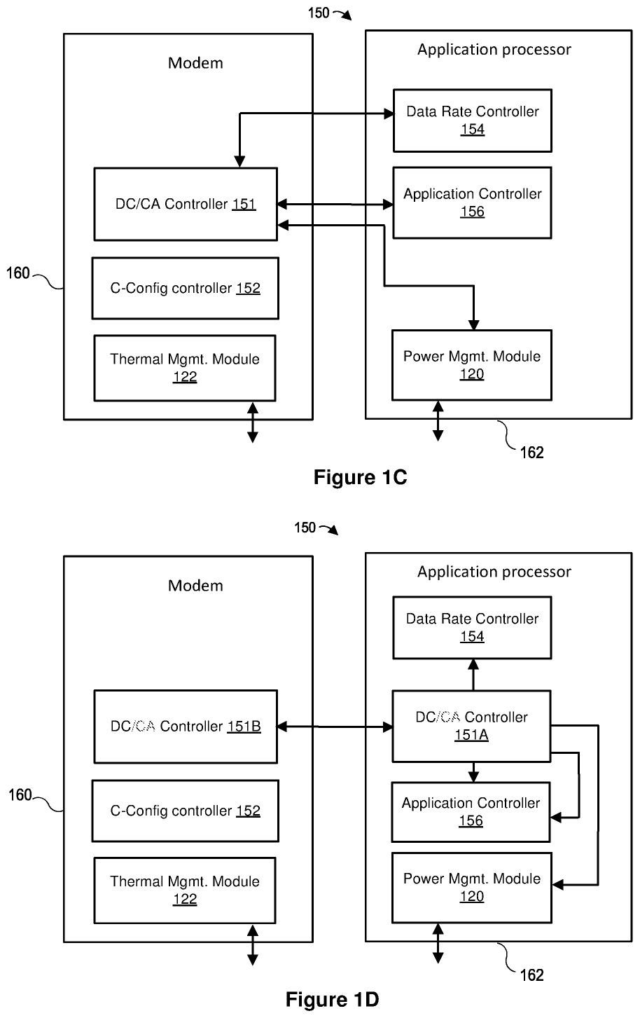

An example system in which these techniques can be implemented is discussed with reference to FIGS. 1A and 1B, and an example implementation of the UE is discussed with reference to FIGS. 1C and 1D.

Referring first to FIG. 1A, a UE 102 operates in an example wireless communication network 100A that includes a RAN 105. The UE 102 is equipped with a battery 103 and is capable of operating in DC with base stations 104A and 106A, operating as an MN and an SN respectively, or in SC with the base station 104A and 106A, operating as an MN. To utilize the power of the battery 103 more efficiently, the UE 102 (which can be any suitable device capable of wireless communications, as discussed below) implements the techniques below to inhibit certain conditional procedures related to DC and, in some cases, disable DC capability, while continuing to use SC and/or the previous DC configuration. Further, the UE 102 can explicitly or implicitly indicate to the MN 104A that the UE 102 will not apply the conditional configuration and/or has disabled DC capability.

The base station 104A supports a cell 124A, and the base station 106A supports a cell 126A. The cells 124A and 126A can partially overlap, so that the UE 102 can communicate in DC with the MN 104A and the SN 106A. When the base station 104A operates as an MN, the cell 124A can belong to a master cell group (MCG) for the UE 102. When the base station 106A operates as an SN, the cell 126B can belong to a secondary cell group (SCG).

To directly exchange messages during DC scenarios and other scenarios discussed below, the MN 104A and the SN 106A can support an interface 107, which can be an X2 or Xn interface. In different configurations of the network 100, the MN 104A can be implemented as a master eNB (MeNB) or a master gNB (MgNB) node, the SN 106A 104A can be implemented as a secondary eNB (SeNB) or a secondary gNB (SgNB) node, and the UE 102 communicates with the MN 104A and SN 106A via the same RAT such as EUTRA or NR, or different RATs such as EUTRA and NR.

In some cases, the MeNB or SeNB is implemented as an ng-eNB rather than an eNB.

The MN 104A and the SN 106A can connect to a core network (CN) 110 via an interface 108, which can be an SI interface. For example, the CN 110 can be a 5G core network (5GC) or an evolved packet core (EPC). In general, the CN 110 can connect to any suitable number of base stations supporting NR cells and/or EUTRA cells. An example configuration in which the EPC 110 is connected to additional base stations is discussed below with reference to FIG. 1B.

The UE 102 can use a radio bearer (RB) (e.g., a DRB or an SRB) that at different times terminates at the MN 104A or the SN 106A. The UE 102 can apply one or more security keys when communicating on the radio bearer, in the uplink (from the UE 102 to a base station) and/or downlink (from a base station to the UE 102) direction. Further, the UE 102 in some cases can use different RATs to communicate with the base stations 104A and 106A. Although the examples below may refer specifically to specific RAT types, 5G NR or EUTRA, in general the techniques of this disclosure also can apply to other suitable radio access and/or core network technologies.

The UE 102 is equipped with processing hardware 150 that can include one or more general-purpose processors such as central processing units (CPUs) and non-transitory computer-readable memory storing machine-readable instructions executable on the one or more general-purpose processors, and/or special-purpose processing units. The processing hardware 150 can include at least a modem chipset and an application chipset (illustrated in FIGS. 1C and 1D) and implement a power management module 120 and a thermal management module 122 that interact with the battery 103, as well as a DC or CA (DC/CA) controller 151, a conditional configuration (C-Config) controller 152, a data rate controller 154, and an application controller 156.

In particular, the DC/CA controller 151 is configured to support DC functionality and implement functions for communicating with an MN as well as functions for communicating with an SN. In some scenarios, the DC controller 151 determines when the UE 102 should operate in DC or only in SC. In other scenarios, the CA controller 151 determines when the UE 102 should operate in CA or non-CA with the MN. The DC/CA controller 151 can make these determinations in view of the status of the battery 103 and in some cases, one or more other operational conditions such as whether the screen of the UE 102 (not shown to avoid clutter) is active at this time, whether the UE 102 currently is in an audio or a video call, whether the user of the UE 102 has activated a power-saving feature, etc., and in some cases, temperature level(s) of the UE 102 or one or more components of the processing hardware 110.

The DC/CA controller 151 can receive an indication of the current status of the battery 103 from the power management module 120. The indication can be for example a periodic report that indicates the current power level of the battery 103 (e.g., 90%, 55%, 8%), a real-time indication that the power level has reached a certain threshold value, or any other suitable value or a set of values. The power management module 120 can operate as a component of the operating system (OS) of the UE 102 or as a firmware component, for example. Further, the power management module 120 in some implementations determines the initial capacity of the battery 103, the rate at which the power level of the battery 103 changes, the rate at which the UE 102 currently is consuming power, the overall capacity of the battery 103, and/or other metrics using of which the DC/CA controller 151 can determine whether the UE 102 should operate in DC or CA or limit the UE 102 to SC or non-CA.

Further, in some scenarios, the power management module 120 determines that the UE 102 is connected to a power source, such as an alternating current (AC) source charger or a direct current (DC) source external battery, “power bank” portable charger, or wireless charger. The power management module 120 in one example implementation determines that the low-power condition does not apply even if the current power level of the battery 103 is below a certain threshold value. In other words, the power management module 120 in this case determines that the power source will likely restore the power level of the battery 103 in the near future.

The thermal management module 122 determines the temperature of one or more of the various components of the processing hardware 150. The thermal management module 122 can include a temperature sensor of any suitable type. The DC/CA controller 151 can receive an indication of the temperature of the UE 102 from thermal management module 122. The indication can be for example a periodic report that indicates the current temperature level of the battery 103, NR EUTRA module, NR module, and/or DC/CA controller 151, (e.g., 90° F., 96° F., 75° F., 26° C.), a real-time indication that the temperature level has reached a certain threshold value, or any other suitable value or a set of values.

With continued reference to FIG. 1A, the conditional configuration controller 152 is configured to determine when the UE 102 should inhibit application of conditional configuration related to a DC procedure. The controller 151 also can receive indications of power level and temperature from the components 120 and 122, respectively, and additionally receive indications of a minimum required data rate from the date rate controller 154 and the status of DC-based applications from the application controller 156.

More particularly, the data rate controller 154 can be configured to obtain, estimate or determine the data rate which specific application executing on the UE 102 requires. When multiple applications requiring a data connection are running on the UE 102, the data rate controller 154 can calculate the aggregate data rate to obtain an aggregate data rate from the data rate required for each application running in the UE 102. The application controller 156 can be configured to determine whether an application requiring DC and/or CA has been activated. The application controller 156 also can determine whether a particular application can request DC or CA.

To support communications over one or more radio interfaces, the processing hardware 150 can include a EUTRA module and an NR module (not shown to avoid clutter). The EUTRA module can be an RF chip, such as a modem, configured to modulate a carrier frequency of a EUTRA-capable base station to encode digital information for transmission, and demodulate the carrier frequency to decode transmitted information from the EUTRA-capable base station. Similarly, the NR module can be a RF chip, such as a modem, configured to handle communications with a NR-capable base station. The UE 102 thus is capable of communicating with the MN 104A and SN 106A via different RATs such as EUTRA and NR, respectively.

In another implementation, the processing hardware 150 includes only the EUTRA module and communicates with the MN 104A and the SN 106A via EUTRA, when both the MN 104A and the SN 106A are eNBs. In yet another example implementation, the processing hardware 150 includes only the NR module and communicates with the MN 104A and SN 106A via 5G NR, when both the MN 104A and the SN 106A are gNBs. In still another implementation, the MN 104A is a gNB and the SN 106A is a 6G base station that provides radio resources on a carrier frequency greater than 100 GHz or even in the THz range. More generally, each of the MN 104A and the SN 106A can operate according to any suitable RAT, and the UE 102 can include the corresponding single- or dual-RAT capability.

In operation, the DC/CA controller 151 can detect a low-power condition of the battery 103 using one or more reports from the power management module 120. For example, the DC/CA controller 151 can detect a low-power condition of the battery 103 by comparing the remaining power level with a certain threshold level stored in memory of the UE 102. The threshold level can correspond to a certain remaining battery capacity (e.g., percentage or value of battery charge or capacity remaining, e.g., 10%).

As discussed in more detail below, the DC/CA controller 151 can disable DC capability in response to detecting a low-power condition of the battery 103. Disabling DC capability may prevent the UE 102 from operating in DC with the SN 106A, so that the UE 102 and the MN 104A operate in SC. The DC/CA controller 151 can generate and transmit an indication to the MN 104A, or alternatively prevent the MN 104A from acquiring measurement of a frequency carrier of the MN 104A or the SN 106A, for example by suspending measurement reports for the carrier frequency of the MN 104A or the SN 106A, suspending measurements entirely for the carrier frequency of the SN 106A, or transmitting “artificial” measurement reports that indicate to the MN 104A low signal strength and/or low signal quality of the carrier frequency of the MN 104A or the SN 106A, regardless of whether the signal strength and/or the signal quality are in fact low. In some implementations, the UE 102 can disable either the EUTRA module or NR module entirely or disable the frequency measuring functionality of the module without disabling the module entirely.

The conditional configuration controller 152 in operation can detect an SC condition and inhibit (and, in some cases, completely prevent) the UE 102 from applying conditional configuration related to a DC, such as a CPAC and CSAC. However, as discussed below, the conditional configuration controller 152 in some cases allows the UE 102 to apply the conditional configuration when the conditional procedure is conditional handover (CHO), even when the SC condition is satisfied.

FIG. 1B depicts another example wireless communication system 100B in which the techniques of this disclosure can be implemented. The wireless communication system 100A includes a UE 102, a base station 104A, a base station 104B, a base station 106A, a base station 106B and a CN 110. The UE 102 initially connects to the base station 104A. The BSs 104B and 106B may have similar processing hardware as the base station 106A. The UE 102 initially connects to the base station 104A.

In some scenarios, the base station 104A can perform immediate SN addition to configure the UE 102 to operate in DC with the base station 104A (via a PCell) and the base station 106A (via a PSCell other than cell 126A). The base stations 104A and 106A operate as an MN and an SN for the UE 102, respectively. The UE 102 in some cases can operate using the MR-DC connectivity mode, e.g., communicate with the base station 104A using 5G NR and communicate with the base station 106A using 5G NR, or communicate with the base station 104A using EUTRA and communicate with the base station 106A using 5G NR.

At some point, the MN 104A can perform an immediate SN change to change the SN of the UE 102 from the base station 106A (source SN, or “S-SN”) to the base station 104B (target SN, or “T-SN”) while the UE 102 is in DC with the MN 104A and the S-SN 106A. In another scenario, the SN 106A can perform an immediate PSCell change to change the PSCell of the UE 102 to the cell 126A. In one implementation, the SN 106A can transmit a configuration changing the PSCell to cell 126A to the UE 102 via a signaling radio bearer (SRB) (e.g., SRB3) for the immediate PSCell change. In another implementation, the SN 106A can transmit a configuration changing the PSCell to the cell 126A to the UE 102 via the MN 104A for the immediate PSCell change. The MN 104A may transmit the configuration immediately changing the PSCell to the cell 126A to the UE 102 via SRB1.

In other scenarios, the base station 104A can perform a conditional SN Addition procedure (CSAC) to first configure the base station 106B as a C-SN for the UE 102. At this time, the UE 102 can be in SC with the base station 104A or in DC with the base station 104A and the base station 106A. If the UE 102 is in DC with the base station 104A and the base station 106A, the MN 104A may determine to perform the CSAC procedure in response to a request received from the base station 106A or in response to one or more measurement results received from the UE 102 or obtained by the MN 104A from measurements on signals received from the UE 102. In contrast to the immediate SN Addition case discussed above, the UE 102 does not immediately attempt to connect to the C-SN 106B. In this scenario, the base station 104A again operates as an MN, but the base station 106B initially operates as a C-SN rather than an SN.

More particularly, when the UE 102 receives a configuration for the C-SN 106B, the UE 102 does not connect to the C-SN 106B until the UE 102 has determined that a certain condition is satisfied (the UE 102 in some cases can consider multiple conditions, but for convenience only the discussion below refers to a single condition). When the UE 102 determines that the condition has been satisfied, the UE 102 connects to the C-SN 106B, so that the C-SN 106B begins to operate as the SN 106B for the UE 102. Thus, while the base station 106B operates as a C-SN rather than an SN, the base station 106B is not yet connected to the UE 102, and accordingly is not yet servicing the UE 102. In some implementations, the UE 102 may disconnect from the SN 106A to connect to the C-SN 106B.

In yet other scenarios, the UE 102 is in DC with the MN 104A (via a PCell) and SN 106A (via a PSCell other than cell 126A and not shown in FIG. 1A). The SN 106A can perform conditional PSCell addition or change (CPAC) to configure a candidate PSCell (C-PSCell) 126A for the UE 102. If the UE 102 is configured to use a signaling radio bearer (SRB) (e.g., SRB3) to exchange RRC messages with the SN 106A, the SN 106A may transmit a configuration for the C-PSCell 126A to the UE 102 via the SRB, e.g., in response to one or more measurement results which may be received from the UE 102 via the SRB or via the MN 104A or may be obtained by the SN 106A from measurements on signals received from the UE 102. When the SN 106A transmits the configuration for the C-PSCell 126A to the UE 102 via the MN 104A, the MN 104A receives the configuration for the C-PSCell 126A. In contrast to the immediate PSCell change case discussed above, the UE 102 does not immediately disconnect from the PSCell and attempt to connect to the C-PSCell 126A.

More particularly, when the UE 102 receives a configuration for the C-PSCell 126A, the UE 102 does not connect to the C-PSCell 126A until the UE 102 has determined that a certain condition is satisfied (the UE 102 in some cases can consider multiple conditions, but for convenience only the discussion below refers to a single condition). When the UE 102 determines that the condition has been satisfied, the UE 102 connects to the C-PSCell 126A, so that the C-PSCell 126A begins to operate as the PSCell 126A for the UE 102. Thus, while the cell 126A operates as a C-PSCell rather than a PSCell, the SN 106A may not yet connect to the UE 102 via the cell 126A. In some implementations, the UE 102 may disconnect from the PSCell to connect to the C-PSCell 126A.

In some scenarios, the condition associated with CSAC or CPAC can be signal strength/quality, which the UE 102 detects on the C-PSCell 126A of the SN 106A or on a C-PSCell 126B of C-SN 106B, exceeding a certain threshold or otherwise corresponding to an acceptable measurement. For example, when the one or more measurement results the UE 102 obtains on the C-PSCell 126A are above a threshold configured by the MN 104A or the SN 106A or above a pre-determined or pre-configured threshold, the UE 102 determines that the condition is satisfied. When the UE 102 determines that the signal strength/quality on the C-PSCell 126A of the SN 106A is sufficiently good (again, measured relative to one or more quantitative thresholds or other quantitative metrics), the UE 102 can perform a random access procedure on the C-PSCell 126A with the SN 106A to connect to the SN 106A. Once the UE 102 successfully completes the random access procedure on the C-PSCell 126A, the C-PSCell 126A becomes a PSCell 126A for the UE 102. The SN 106A then can start communicating data (user-plane data or control-plane data) with the UE 102 through the PSCell 126A. In another example, when the one or more measurement results the UE 102 obtains on the C-PSCell 126B are above a threshold configured by the MN 104A or the C-SN 106B or above a pre-determined or pre-configured threshold, the UE 102 determines that the condition is satisfied. When the UE 102 determines that the signal strength/quality on the C-PSCell 126B of the C-SN 106B is sufficiently good, the UE 102 can perform a random access procedure on the C-PSCell 126B with the C-SN 106B to connect to the C-SN 106B. Once the UE 102 successfully completes the random access procedure on the C-PSCell 126B, the C-PSCell 126B becomes a PSCell 126B for the UE 102 and the C-SN 106B becomes an SN 106B. The SN 106B then can start communicating data (user-plane data or control-plane data) with the UE 102 through the PSCell 126B.

In various configurations of the wireless communication system 100, the base station 104A can be implemented as a master eNB (MeNB) or a master gNB (MgNB), and the base station 106A or 106B can be implemented as a secondary gNB (SgNB) or a candidate SgNB (C-SgNB). The UE 102 can communicate with the base station 104A and the base station 106A or 106B (106A/B) via the same RAT such as EUTRA or NR, or different RATs. When the base station 104A is an MeNB and the base station 106A is an SgNB, the UE 102 can be in EUTRA-NR DC (EN-DC) with the MeNB and the SgNB. In this scenario, the MeNB 104A may or may not configure the base station 106B as a C-SgNB to the UE 102. In this scenario, the SgNB 106A may configure cell 126A as a C-PSCell to the UE 102. When the base station 104A is an MeNB and the base station 106A is a C-SgNB for the UE 102, the UE 102 can be in SC with the MeNB. In this scenario, the MeNB 104A may or may not configure the base station 106B as another C-SgNB to the UE 102.

When the base station 104A is an MgNB and the base station 106A is an SgNB, the UE 102 may be in NR-NR DC (NR-DC) with the MgNB and the SgNB. In this scenario, the MeNB 104A may or may not configure the base station 106B as a C-SgNB to the UE 102. In this scenario, the SgNB 106A may configure cell 126A as a C-PSCell to the UE 102. When the base station 104A is an MgNB and the base station 106A is a C-SgNB for the UE 102, the UE 102 may be in SC with the MgNB. In this scenario, the MgNB 104A may or may not configure the base station 106B as another C-SgNB to the UE 102.

When the base station 104A is an MgNB and the base station 106A is a Secondary ng-cNB (Sng-eNB), the UE 102 may be in NR-EUTRA DC (NE-DC) with the MgNB and the Sng-eNB. In this scenario, the MgNB 104A may or may not configure the base station 106B as a C-Sng-eNB to the UE 102. In this scenario, the Sng-eNB 106A may configure cell 126A as a C-PSCell to the UE 102. When the base station 104A is an MgNB and the base station 106A is a candidate Sng-eNB (C-Sng-eNB) for the UE 102, the UE 102 may be in SC with the MgNB. In this scenario, the MgNB 104A may or may not configure the base station 106B as another C-Sng-eNB to the UE 102.

As illustrated in FIG. 1B, the base station 104A supports a cell 124A, the base station 104B supports a cell 124B, the base station 106A supports a cell 126A, and the base station 106B supports a cell 126B. The cells 124A and 126A can partially overlap, as can the cells 124A and 124B, so that the UE 102 can communicate in DC with the base station 104A (operating as an MN) and the base station 106A (operating as an SN) and, upon completing an SN change, with the base station 104A (operating as MN) and the SN 106B.

In general, the wireless communication network 100 can include any suitable number of base stations supporting NR cells and/or EUTRA cells, and the CN 110 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

As illustrated in FIG. 1C, the processing hardware 150 of the UE 102 in one implementation can include a modem chipset 160 and an application chipset 162. In his implementation, the DC/CA controller 151, the conditional configuration controller 152, and the thermal management module 122 are implemented in the modem chipset 160; and the application chipset 162 implements the data rate controller 154, the application controller 156, and the power management module 120. The DC/CA controller 151 is communicatively coupled to the components 154, 156, and 120 of the application chipset 162.

In an alternative implementation illustrated in FIG. 1D, the DC/CA controller includes an application-side component 151A and a modem-side component 151B. The DC/CA controller 151B communicates with the DC/CA controller 151A, which in turn communicates with the application-side components 154, 156, and 120.

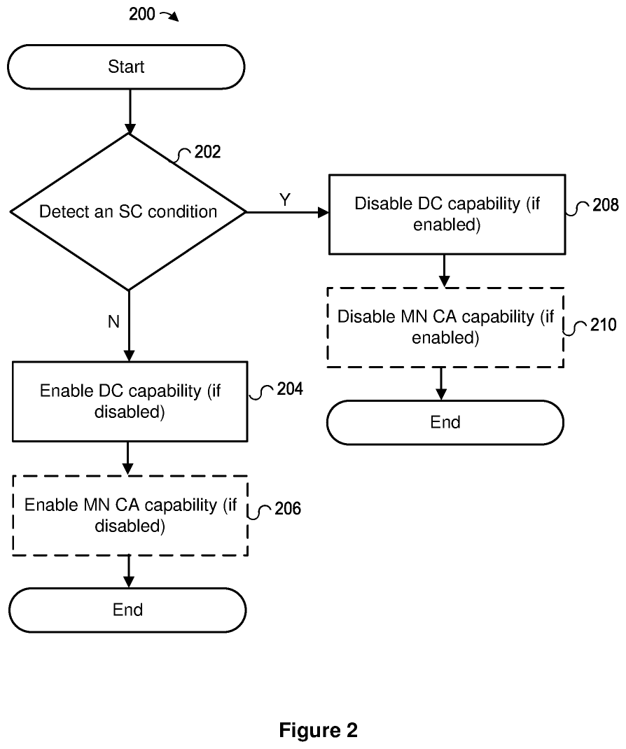

Next, several example methods and scenarios corresponding to different DC configurations and/or different UE implementations are discussed with reference to FIGS. 2-17. Each of the methods discussed below can be implemented using hardware, software, firmware, or any suitable combination of hardware, software, and firmware.

FIG. 2 depicts an example method 200 for determining whether the UE 102 should disable DC capability and (optionally) CA capability in view of a SC condition at the UE.

The method 200 begins at block 202, where the UE 102 determines whether a SC condition is satisfied. The SC condition can be for example (i) a low-power condition of the battery 103, (ii) a low data rate requirement of the UE 102, (iii) no applications requiring DC running on the UE 102, (iv) the quality or strength of the signal at the SN is below a certain threshold level. In some cases, the UE 102 determines that one of these SC conditions is satisfied while the other SC conditions are not satisfied. For example, the UE 102 can detect condition (ii) and determine that condition (i) is not satisfied (i.e., determine that the remaining power level is above a certain threshold level).

In other implementations, the UE 102 checks two or more of the example SC conditions above and prioritizes these conditions so that, for example, the flow proceeds to block 204 when there no applications requiring DC are running, but the aggregate data requirement exceeds a certain threshold. Thus, when condition (ii) is not satisfied but condition (iii) is satisfied, the UE 102 can consider the “overall” SC condition not satisfied. On the other hand, when the UE 102 determines that condition (i) is satisfied but condition (ii) is not satisfied, the UE 102 can consider the overall SC condition is satisfied, and the flow proceeds to block 208. In general, the UE 102 can check any suitable number of SC conditions and define any suitable interactions between these conditions to determine whether the overall SC condition is satisfied at block 202.

In one example, the DC/CA controller 151 can process one or more reports from the power management 120 to determine whether the remaining amount of power of the battery 103 is above a certain level, whether the rate at which the UE 102 is consuming power is above a certain level, etc. (see the discussion above). In yet another example, the data rate controller 154 can obtain, estimate or determine a data rate required by a specific application in the UE 102. When multiple applications concurrently run on the UE 102, the data rate controller 154 can sum up the data rate requirements to determine the aggregate required data rate. The data rate controller 154 can provide the required data rate to the DC/CA controller 151 (or the DC/CA controller 151A in the implementation of FIG. 1D), which can determine whether the data rate is below a certain level, whether the data rate is above a certain level, etc. If the DC/CA controller 151 determines that the data rate is below a certain level, the DC/CA controller 151 detects the low data rate requirement. In yet another example, the application controller 156 can detect (or monitor) whether an application requiring DC has been activated and notify the DC/CA controller 151 accordingly. If the DC/CA controller 151 detects no application requiring DC or CA has been activated, the DC/CA controller 151 determines a non-CA condition or the SC condition of no currently executing applications requiring DC or CA is satisfied.

If the UE 102 does not detect an SC condition, the UE 102 at block 204 enables DC capability when DC capability previously was disabled. In another scenario, the UE 102 keeps DC capability enabled, when DC capability is already enabled. However, if the UE 102 detects an SC condition, the UE 102 at block 208 disables DC capability, if DC capability previously was enabled. In another scenario, when DC capability is already disabled, the UE 102 keeps DC capability disabled.

In some implementations, in addition to enabling or disabling DC capability, the UE 102 enables or disables MN CA capability in view of the SC condition and a non-CA condition. In particular, if the UE 102 does not detect an SC condition, the UE 102 at block 206 enables MN CA capability, if MN CA capability previously was disabled. In another scenario, the UE 102 keeps MN CA capability enabled, if MN CA capability is already enabled. Thus, according to the method 200, when the battery 103 has sufficient power, or there are currently running applications requiring DC, or the aggregate data requirement for the UE 102 exceeds a certain threshold, the UE 102 uses MN CA to transmit and receive data at higher rates. However, if the UE 102 detects a non-CA condition (e.g., as described above), the UE 102 at block 210 disables MN CA capability, if MN CA capability previously was enabled. If MN CA capability is already disabled, the UE 102 keeps MN CA capability disabled.

Although the method 200 as illustrated in FIG. 2 completes after block 206 or block 210, in general the UE 102 can execute the method 200 in an iterative manner, e.g., by “looping back” to block 202 after executing block 206 or block 210.

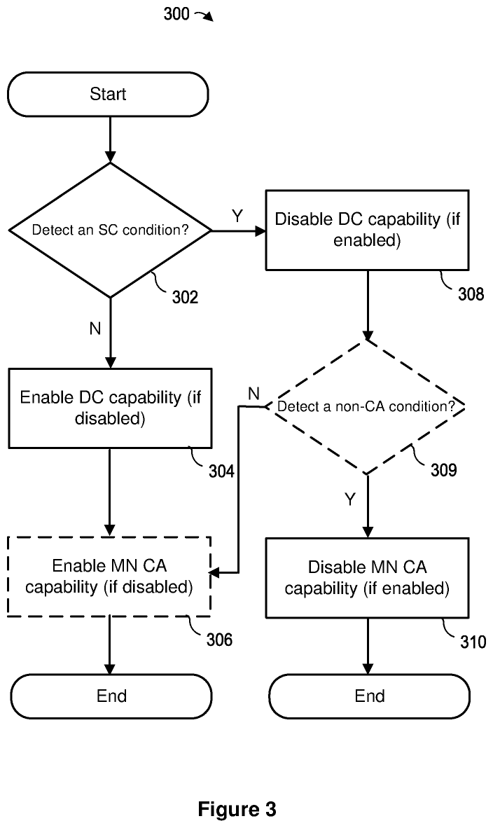

FIG. 3 depicts an example method 300 for determining whether the UE 102 should disable DC capability in view of an SC condition, and whether the UE should disable CA capability in view of a non-CA condition.

The method 300 begins at block 302, where the UE 102 determines whether an SC condition (e.g., the remaining power level is below a first threshold level, a required data rate is below a first threshold rate, no DC-required application is running, or the quality or strength of the SN carrier is below a certain threshold) is satisfied, similar to block 202 of FIG. 2. If the UE 102 does not detect the SC condition, the UE 102 at block 304 enables DC capability when DC capability previously was disabled. In another scenario, the UE 102 keeps DC capability enabled, when DC capability is already enabled. However, if the UE 102 detects an SC condition, the UE 102 at block 308 disables DC capability, if DC capability previously was enabled. In another scenario, when DC capability is already disabled, the UE 102 keeps DC capability disabled.

In some implementations, in addition to enabling or disabling DC capability, the UE 102 enables MN CA capability in view of the same SC condition and a CA condition (i.e., the UE 102 does not detect a non-CA condition), but disables MN CA capability in view of a non-CA condition (e.g., the remaining power level is below a second threshold level that is lower than the first threshold level, the required data rate is below a second threshold rate that is lower than the first threshold rate, no DC-required application and no CA-required application are running, or the UE 102 disconnects from and connects to a SN a certain number of times within a time period). In particular, if the UE 102 does not detect the same SC condition, the UE 102 at block 306 enables MN CA capability, if MN CA capability previously was disabled. In another scenario, the UE 102 keeps MN CA capability enabled, if MN CA capability is already enabled. However, if the UE 102 at block 309 detects a non-CA condition, the UE 102 at block 310 disables MN CA capability, if MN CA capability is already enabled. In another scenario, the UE 102 keeps MN CA capability disabled, if MN CA capability previously was disabled. If the UE 102 at block 309 does not detect a non-CA condition, the UE 102 at block 306 enables MN CA capability, if MN CA capability previously was disabled. In another scenario, the UE 102 keeps MN CA capability enabled, if MN CA capability is already enabled.

Although the method 300 as illustrated in FIG. 3 completes after block 306 or block 310, in general the UE 102 can execute the method 300 in an iterative manner, e.g., by “looping back” to block 302 or block 309, respectively, after executing block 306 or 310.

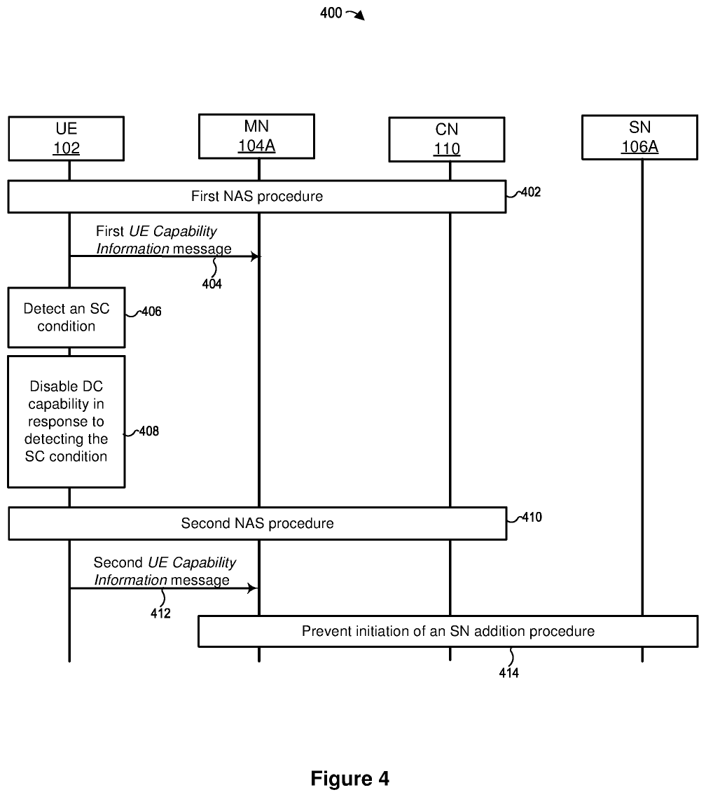

FIG. 4 depicts an example messaging diagram 400 of an example scenario in which the UE 102 prevents the MN 104A from initiating an SN addition procedure using an explicit indication that the UE 102 has disabled DC capability.

At the beginning of this scenario, the UE 102 performs 402 a first NAS procedure with the CN 110 via the MN 104. If the UE is capable of EN-DC and therefore in communication with the CN 110 implemented as an EPC, the first NAS procedure may be a first Attach procedure or a first Tracking Area Update procedure defined in 3GPP TS 24.301, for example.

To begin the first Attach procedure, the UE 102 sends an Attach Request message to a mobility management entity (MME) of the CN 110 and receives an Attach Accept message from the MME in response. The UE 102 then sends an Attach Complete message to the MME. As another example, to begin the first Tracking Area Update procedure, the UE 102 sends a Tracking Area Update Request message to the MME and receives a Tracking Area Update Accept message from the MME in response. The UE 102 then sends a Tracking Area Update Complete message to the MME in response to the Tracking Area Update Accept message.

If the UE 102 is capable of NGEN-DC, NR-NR DC, or NE-DC, and accordingly in communication with the CN 110 implemented as a 5GC, the first NAS procedure may be a Registration procedure defined in 3GPP TS 24.501. To begin the first Registration procedure, the UE 102 sends a Registration Request message to an access and mobility management function (AMF) of the CN 110 and receives a Registration Accept message from the AMF in response. The UE 102 then sends a Registration Complete message to the AMF.

In the scenario of FIG. 4, the UE 102 generates an explicit indication (e.g., a first UE capability information message) to notify 404 the MN 104A that the UE 102 supports DC capability. The MN 104A may transmit the indication to the CN 110. In some implementations, the UE 102 transmits 404 this indication during the first NAS procedure. In other implementations, the UE 102 transmits 404 this indication after completing the first NAS procedure.

In some implementations, the UE 102 indicates that the UE 102 is capable of DC in a NAS message (e.g., the Attach Request message, Attach Complete message, Registration Request message, or Registration Complete message) of the first NAS procedure. The CN 110 (e.g., the MME or the AMF) then may indicate to the MN 104A that the UE 102 is capable of DC.

As a more particular example, when generating the first UE capability information message, the UE 102 generates one or more radio access capability information elements (IEs) (e.g., a UE-EUTRA-Capability IE, a UE-MRDC-Capability IE and/or a UE-NR-Capability IE) (hereinafter referred as the radio access capability IE(s)) and includes at least one DC band combination in the radio access capability IE(s) of the first UE capability information message to indicate that the UE 102 has enabled DC, in one implementation.

In another implementation, the UE 102 includes a DC support indicator and/or a list of DC-supported bands in the radio access capability IE(s) of the first UE capability information message to indicate that the UE 102 has enabled DC. The UE 102 in some implementations can include the DC band combination and the DC support indicator and/or a list of DC-supported bands in the same radio access capability IE (i.e., a first radio access capability IE).

One of the radio access capability IE(s) can be a UE-EUTRA-Capability IE or a UE-NR-Capability IE. For example, the radio access capability IE is a UE-EUTRA-Capability IE if the MN 104A is an E-UTRA base station (e.g., eNB or ng-eNB). To indicate to the MN 104A that the UE 102 supports EN-DC capability, the DC support indicator may be an EN-DC support indicator (e.g., en-DC-r15), and the DC supported band list may be a supportedBandListEN-DCNR-r15. To indicate to the MN 104A that the UE 102 supports NGEN-DC capability, the UE 102 can reuse the DC support indicator and the DC supported band list for EN-DC. Alternatively, the DC support indicator may be a specific NGEN-DC support indicator (e.g., ng-en-DC-r15), and the DC supported band list may be specific for NR in NGEN-DC (e.g., a supportedBandListNGEN-DCNR-v1560).

As another example, one of the radio access capability IE(s) is a UE-NR-Capability IE if the MN 104A is an 5G NR base station implemented as a gNB. To indicate to the MN 104A that the UE 102 supports NE-DC capability, the DC support indicator may be a specific NE-DC support indicator (e.g., ne-DC), and the DC supported band list may be specific for EUTRA in NE-DC (e.g., a supportedBandListNE-DCEUTRA). Alternatively, the DC supported band list may be generic for EUTRA (e.g., supportedBandListEUTRA) irrespective of the DC configuration. To indicate to the MN 104A that the UE 102 supports NR-NR DC capability, the DC support indicator may be a specific NR-DC support indicator (e.g., nr-DC), and the DC supported band list may be specific for NR in NR-DC (e.g., a supportedBandListNR-DC-v1560 or a supportedBandCombinationList). Alternatively, the DC supported band list may be generic for NR (e.g., supportedBandListNR) irrespective of the DC configuration.

In some cases, a UE 102 can implement a combination of the techniques discussed above. For example, the UE 102 can include a DC band combination in a first radio access capability IE of the first UE capability information message, and additionally include a DC support indicator and/or a DC supported band list in a different radio access capability IE than the first radio access capability IE (i.e., a second radio access capability IE) of the first UE capability information message to indicate that the UE 102 has enabled DC. In another example, the UE 102 can include a DC support indicator and/or a DC supported band list in a first radio access capability IE of the first UE capability information message to indicate that the UE 102 has enabled DC, and additionally include a DC band combination in a second radio access capability IE of a different UE capability information message than the first UE capability information message (i.e., a third UE capability information message). The UE 102 transmits the first UE capability information message or the third UE capability information message to the MN 104A during or after the first NAS procedure.

Upon receiving the explicit indication, such as the first UE capability information message and/or the third UE capability information message (if transmitted), the MN 104A configures (when necessary) the UE 102 with resources to exchange EUTRA RRC messages or user plane data (when operating in EN-DC or NGEN-DC, for example) or exchange NR RRC messages or user plane data (when operating in NE-DC or NR-NR DC, for example) with the MN 104. The MN 104A also configures the UE 102 to communicate with the SN 106. Accordingly, the UE 102 is capable of communicating in DC with the MN 104A and the SN 106.

After the MN 104A configures the UE 102 for DC operation, the UE 102 detects 406 an SC condition (such as a low-power condition of the battery 103), similar to block 202 and block 308 in FIG. 2 and FIG. 3, respectively. In response, the UE 102 disables 408 DC capability, similar to block 208 and block 308 in FIG. 2 and FIG. 3, respectively.

By disabling DC capability, the UE 102 prevents the UE from operating in DC with the SN 106, so that the UE 102 and the MN 104A can operate only in SC.

To notify the MN 104A that the UE 102 has disabled DC capability, the UE 102 performs 410 a second NAS procedure with the CN 110 via the MN 104. The second NAS procedure is similar to the first NAS procedure described above, in that if the UE is operating in EN-DC and therefore in communication with the CN 110 implemented as an EPC, the second NAS procedure can be the Attach procedure or the Tracking Area Update procedure.

If the UE 102 is operating in NGEN-DC, NR-NR DC, or NE-DC, the second NAS procedure may be the Registration procedure.

During or after the second NAS procedure, for example, the UE 102 generates an explicit indication (e.g., a second UE capability information message) to notify 412 the MN 104A that the UE 102 will no longer be using DC. The MN 102 may transmit the indication to the CN 110. In some implementations, the UE 102 transmits 412 this indication during the second NAS procedure. In other implementations, the UE 102 transmits 412 this indication after completing the second NAS procedure.

In some implementations, the UE 102 indicates that the UE 102 will no longer be using DC in a NAS message (e.g., the Attach Request message, Attach Complete message, Registration Request message or Registration Complete message) of the second NAS procedure. The CN 110 (e.g., the MME or the AMF discussed above) then may indicate to the MN 104A that the UE 102 will no longer be using DC.

For example, when generating the second UE capability information message, the UE 102 generates a first radio access capability IE of the radio access capability IE(s) (e.g., a UE-EUTRA-Capability IE, a UE-MRDC-Capability IE and/or a UE-NR-Capability IE) and excludes the DC band combination in the first radio access capability IE of the second UE capability information message to indicate that the UE 102 has disabled DC. Alternatively, the UE 102 excludes the first radio access capability IE in the second UE capability information message at all.

In other implementations, the UE 102 excludes a DC support indicator or a list of DC-supported bands in a second radio access capability IE of the radio access capability IE(s) of the second UE capability information message to indicate that the UE 102 has disabled DC. Alternatively, the UE 102 excludes the second radio access capability IE in the second UE capability information message at all.

In yet other implementations, the UE 102 excludes the DC band combination in the first radio access capability IE of the second UE capability information message, nor does the UE 102 include a DC support indicator or a DC-supported band list in the second radio access capability IE, to indicate that the UE 102 has disabled DC. Alternatively, the UE 102 excludes the first radio access capability IE nor the second radio access capability IE in the second UE capability information message at all.

In some cases, the UE 102 may transmit the first and second radio access capability IEs in different UE capability information messages to the MN 104A as opposed to the same UE capability information message (i.e., the second UE capability information message). For example, the UE 102 excludes a DC support indicator or a DC-supported band list in the second radio access capability IE in the second UE capability information message nor does the UE 102 include the DC band combination in the first radio access capability IE of a fourth UE capability information message, to indicate that the UE 102 has disabled DC. Alternatively, the UE 102 excludes the first radio access capability IE nor the second radio access capability IE in the different UE capability information messages at all.

Upon receiving the explicit indication, the MN 104A prevents 414 initiation of an SN addition procedure with the SN 106, while continuing to support SC between the UE 102 and the MN 104. For example, the MN 104A does not configure the UE 102 with resources to communicate with the SN 106A but configures (when necessary) the UE 102 with resources to exchange EUTRA RRC messages and user plane data (when the MN 104A is an eNB or a ng-eNB, for example) or NR RRC messages and user plane data (when the MN 104A is a gNB, for example) with the MN 104. Accordingly, the UE 102 is capable of communicating with only the MN 104A (i.e., and not the SN 106).

The UE 102 also can enable MN CA during or after the first NAS procedure. To notify the MN 104A that the UE 102 enabled MN CA, the UE 102 includes at least one MN CA band combination in the first radio access capability IE or the second radio access capability IE of the first UE capability information message.

The UE 102 can disable MN CA during or after the second NAS procedure. To notify the MN 104A that the UE 102 disabled MN CA capability, the UE 102 excludes at least one MN CA band combination in the first radio access capability IE or the second radio access capability IE of the second UE capability information message and/or the fourth UE capability information message (if transmitted). Alternatively, the UE 102 excludes the first and second radio access capability IEs in the second UE capability information message and/or the fourth UE capability information message (if transmitted) at all.

In some implementations, the UE 102 transmits 404 the first UE capability information message in response to a first UE Capability Enquiry message received from the MN 104. The UE 102 can receive the first UE Capability Enquiry message during or after the first NAS procedure. The MN 104A can transmit the first UE Capability Enquiry message to the UE 102 after receiving an indication from the CN 110 that the UE 102 is capable of DC. The UE 102 transmits the third UE capability information message to the MN 104A in response to a third UE Capability Enquiry message received from the MN 104. The UE 102 can receive the third UE Capability Enquiry message during or after the first NAS procedure. The MN 104A can transmit the third UE Capability Enquiry message to the UE 102 after receiving an indication from the CN 110 that the UE 102 is capable of DC.

Similarly, the UE 102 can transmit the second UE capability information message to the MN 104A in response to a second UE Capability Enquiry message received from the MN 104A during or after the second NAS procedure, for example. The MN 104A can transmit the second UE Capability Enquiry message to the UE 102 after receiving an indication from the CN 110 that the UE 102 will no longer be using DC. The UE 102 can transmit the fourth UE capability information message to the MN 104A in response to a fourth UE Capability Enquiry message received from the MN 104A during or after the second NAS procedure, for example. The MN 104A can transmit the fourth UE Capability Enquiry message to the UE 102 after receiving an indication from the CN 110 that the UE 102 will no longer be using DC. The first, second, third, and fourth UE Capability Enquiry messages and the first, second, third, and fourth UE capability information messages in these examples are RRC messages, but in general the UE 102 and the MN 104A can use any suitable messages to query and report UE capabilities.

After the UE 102 disables the DC capability, the UE 102 can determine that the SC condition is no longer satisfied. For example, when the SC condition is the lower-power condition of the battery 103, a user may charge or replace the battery 103, or the user can connect the UE 102 to a power source. The DC controller 151 can determine that the remaining power level is at or above the same threshold level that previously caused the DC controller 151 to disable DC capability, or at a different threshold level (i.e., a second threshold level stored in memory of the UE 102). In any case, the DC controller 151 at some point can determine that the UE 102 can again operate in DC. In this case, the DC controller 151 can again perform 402 the first NAS procedure to re-enable DC capability and (optionally) re-enable MN CA capability.

In some implementations, the UE 102 may perform a NAS detach procedure or a NAS deregistration procedure and then the second NAS procedure, to disable the DC capability. The UE 102 may perform a NAS detach procedure or a NAS deregistration procedure and then the first NAS procedure, to re-enable the DC capability. In other implementations, the UE 102 does not perform the NAS detach procedure nor the NAS deregistration procedure to disable or re-enable the DC capability.

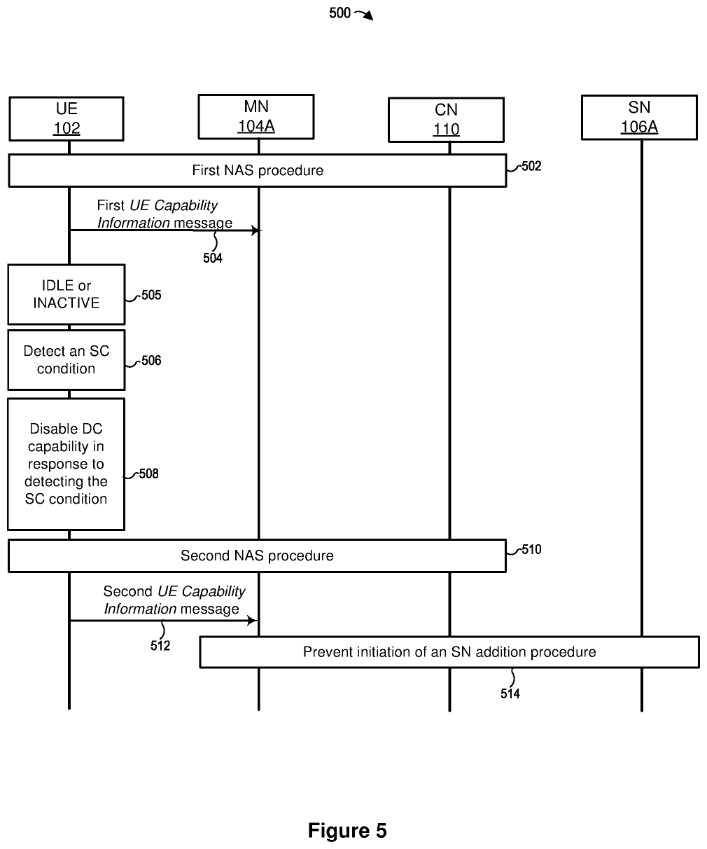

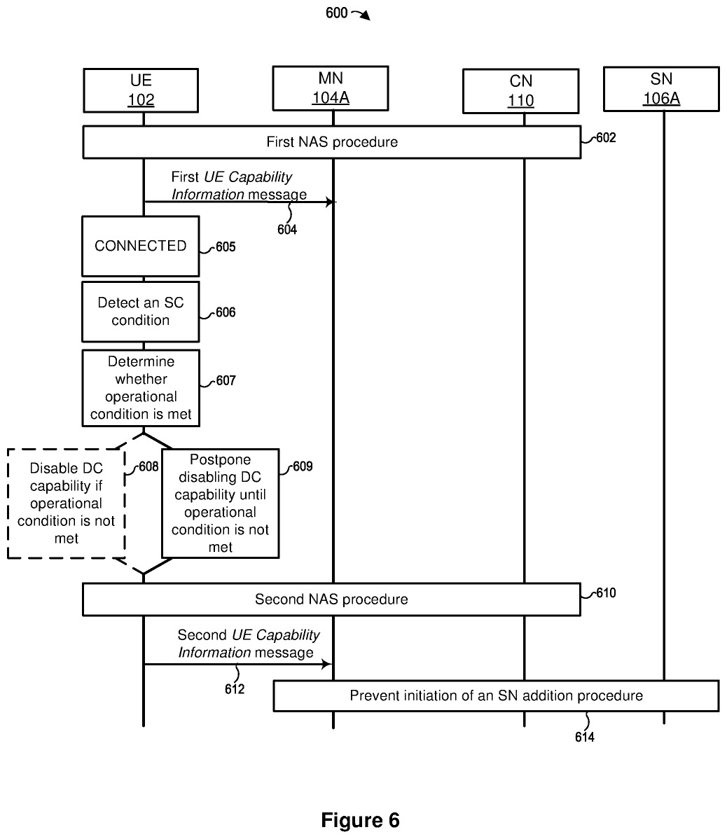

Further, the UE 102 in some implementations can postpone disabling DC operation in view of the current RRC state (e.g., idle, connected, inactive) of the UE 102. To avoid dropping calls or otherwise disrupting ongoing data sessions when the UE 102 is in a connected state, the UE 102 can postpone disabling DC operation in view of the connected state (e.g., EUTRA-RRC_CONNECTED when the MN is an eNB or an ng-eNB, NR-RRC CONNECTED when the MN is a gNB). As illustrated in FIGS. 5-6, the UE 102 can consider such RRC states and/or other conditions to determine the timing of disabling DC.

Referring first to FIG. 5, the UE 102, operating in an idle or inactive state of the RRC protocol, disables DC capability in response to detecting a SC condition. The UE 102 at the beginning of this scenario performs 502 a first NAS procedure with the CN 110 via the MN 104, similar to event 402 in the scenario of FIG. 4. Also similar to the event 404 of FIG. 4, the UE 102 during or after the first NAS procedure generates an explicit indication that the UE 102 supports DC capability, and transmits 504 the indication to the MN 104. Upon receiving the explicit indication, the MN 104A configures the UE 102 with the requisite resources to communicate with the MN 104A as well as the SN 106A in DC.

After the MN 104A configures the UE 102 for DC operation, the UE 102 operates 505 in an idle state (e.g., EUTRA-RRC_IDLE, NR-RRC IDLE) or an inactive state (e.g., EUTRA-RRC INACTIVE, NR-RRC INACTIVE). In some cases, the MN 104A configures the UE 102 to enter the idle or inactive state if there is no data activity between the MN 104, the SN 106A and the UE 102. The UE 102 then detects 506 a SC condition, similar to event 406 in the scenario of FIG. 4.

In response, the UE 102 disables 508 DC capability, similar to event 408, except that the UE 102 in this scenario disables DC capability in view of the idle state or the inactive state as well as the SC condition. By disabling DC capability, the UE 102 prevents the UE from operating in DC with the SN 106, so that the UE 102 and the MN 104A can operate only in SC.

Although the UE 102 in the example scenario of FIG. 5 operates 505 in the idle state or the inactive state before detecting 506 the SC condition, in other implementations, the UE 102 can detect 506 the SC condition before operating 505 in the idle state or the inactive state. In any event, because the user of the UE 102 may not experience interruptions in data usage when the UE 102 is in idle state or inactive state, the UE 102 need not postpone disabling the DC capability.

To notify the MN 104A that the UE 102 has disabled DC capability, the UE 102 performs 510 a second NAS procedure with the CN 110 via the MN 104, similar to event 410. Events 512 and 514 also are similar to events 412 and 414 discussed above.

After the UE 102 disables the DC capability, the DC controller 151 can determine that the SC condition no longer applies (e.g., the remaining power level is at or above the same threshold level that previously caused the DC controller 151 to disable DC capability, or at a different threshold level; a required data rate is at or above the same threshold rate that previously caused the DC controller 151 to disable DC capability, or at a different threshold rate; or an application requiring DC has been activated). In any case, the DC controller 151 at some point can determine that the UE 102 can again operate in DC. In response, the UE 102 can perform 402 the first NAS procedure to re-enable the DC capability and (optionally) re-enable MN CA capability (if disabled) as described above if the UE 102 is in idle state or inactive state. If the UE 102 is in connected state, the UE 102 can postpone the first NAS procedure until the UE 102 is in idle state or inactive state. In some implementations, the UE 102 may need to perform a NAS detach procedure or a NAS deregistration procedure to disable or re-enable the DC capability. The UE 102 performs the NAS detach procedure or the NAS deregistration procedure if the UE 102 is in idle state or inactive state. If the UE 102 is in connected state, the UE 102 can postpone the NAS detach procedure or the NAS deregistration procedure until the UE 102 is in idle state or inactive state. In other words, the UE 102 can postpone the disabling or re-enabling of the DC capability and (optionally) the MN CA capability until the UE 102 is in idle state or inactive state.

Some exemplary implementations described for the scenario of FIG. 4 can be applied to the scenario of FIG. 5.

In contrast to the scenario of FIG. 5, the UE 102 in the scenario 600 of FIG. 6 initially operates in a connected state of the RRC protocol and accordingly postpones the disabling of DC capability after detecting a SC condition.

The UE 102 first performs 602 a first NAS procedure with the CN 110 via the MN 104, similar to the event 502 in the scenario of FIG. 5. During or after the first NAS procedure, the UE 102 generates an explicit indication to notify the MN 104A that the UE 102 supports DC capability, and transmits 604 the indication to the MN 104, similar to the event 504 in the scenario of FIG. 5.

Upon receiving the explicit indication, the MN 104A configures (when necessary) the UE 102 with requisite resources to communicate with the MN 104A as well as with the SN 106A in DC.

After the MN 104A configures the UE 102 for DC operation, the UE 102 operates 605 in a connected state (e.g., EUTRA-RRC_CONNECTED, NR-RRC CONNECTED).

The UE 102 then detects 606 an SC condition, similar to event 506 in the scenario of FIG. 5, except that the UE 102 detects the low-power condition in view of the connected state.

In response, the UE 102 determines 607 whether a predetermined operational condition is met. If a predetermined operational condition is not met (e.g., the UE 102 is not engaged in a voice or video call, a live streaming, a screen of the UE 102 is off, or a power-saving feature of the UE 102 has been activated), the UE 102 disables 608 DC capability, similar to event 508 in the scenario of FIG. 5, except that the UE 102 disables DC capability in view of the connected state and not detecting a predetermined operational condition. However, if a predetermined operational condition is met (e.g., the UE 102 is engaged in a voice or video call, a screen of the UE 102 is on, or a power-saving feature of the UE 102 has been deactivated), the UE 102 postpones 609 disabling of the DC capability until the operational condition no longer applies. Although the UE 102 in the example scenario of FIG. 6 operates 605 in a connected state before detecting 606 the SC condition, in other implementations, the UE 102 can detect 606 the SC condition before operating 605 in the connected state.

To notify the MN 104A that the UE 102 has disabled DC capability, the UE 102 performs 610 a second NAS procedure with the CN 110 via the MN 104, similar to event 510 in the scenario of FIG. 5. Events 612 and 614 also are similar to events 512 and 514 discussed above.

After the UE 102 disables DC, the DC controller 151 can determine that SC condition no longer applies (e.g., the remaining power level is at or above the same threshold level that previously caused the DC controller 151 to disable DC capability, or at a different threshold level; a required data rate is at or above the same threshold rate that that previously caused the DC controller 151 to disable DC capability, or at a different threshold rate; or an application requiring DC has been activated). In any case, the DC controller 151 at some point can determine that the UE 102 can again operate in DC. In response, the UE 102 can perform 602 the first NAS procedure to re-enable the DC capability and (optionally) re-enable MN CA capability (if disabled) as described above if the predetermined operational condition is not met. If the predetermined operational condition is met, the UE 102 postpones re-enabling of the DC capability and (optionally) MN CA capability (if disabled) until the predetermined operational condition no longer applies. In some implementations, the UE 102 may need to perform a NAS detach procedure or a NAS deregistration procedure to disable or re-enable the DC capability. The UE 102 performs the NAS detach procedure or the NAS deregistration procedure if the predetermined operational condition is not met. If the predetermined operational condition is met, the UE 102 can postpone the NAS detach procedure or the NAS deregistration procedure. In other words, the UE 102 can postpone the disabling or re-enabling of the DC capability and (optionally) the MN CA capability until the predetermined operational condition is not met.

Some exemplary implementations described for the scenarios of FIGS. 4 and 5 can be applied to the scenario of FIG. 6.

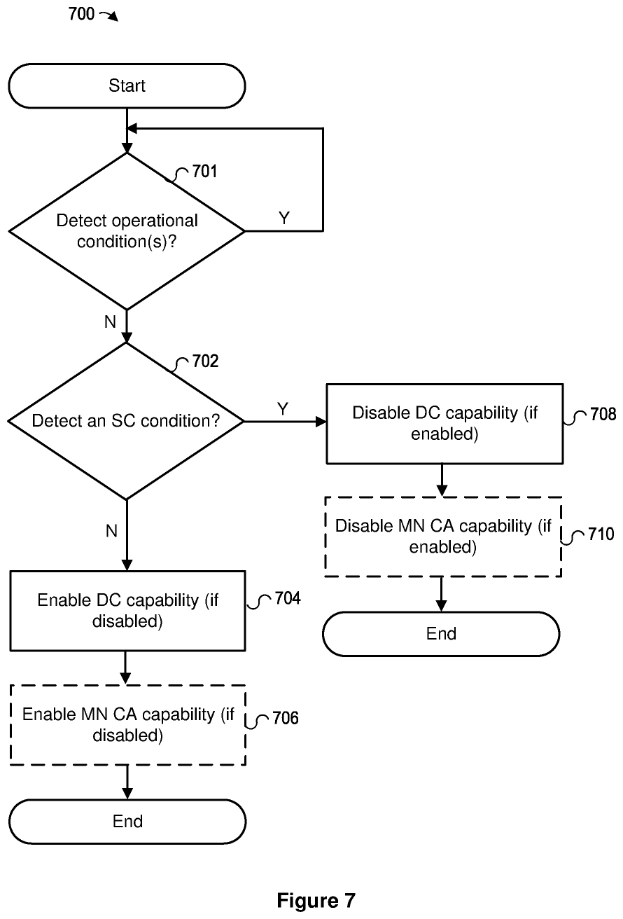

Next, FIGS. 7-10 depict methods of determining whether a UE should disable DC capability and (optionally) CA capability in response to detecting a predetermined operational condition and a SC condition.

FIG. 7 depicts an example flow diagram 700 of an example method for determining whether the UE 102 should disable DC capability and (optionally) CA capability in response to detecting a predetermined operational condition prior to detecting a SC condition.

The method 700 begins at block 701, where the UE 102 determines whether a predetermined operational condition is met. If the UE 102 determines that a predetermined operational condition is met, the UE 102 continues (e.g., aperiodically, periodically) to determine whether a predetermined operational condition is not met. If the UE 102 determines that a predetermined operational condition is not met, the UE 102 at block 702 determines whether a SC condition is satisfied, similar to block 202 in the scenario of FIG. 2. The operational condition detected at block 701 may be one operational condition (e.g., the screen is on) or may include a combination of more than one operational condition (e.g., the screen is on and a power-saving feature of the UE 102 has been activated). Blocks 704, 706, 708, and 710 are similar to blocks 204, 206, 208, and 210 discussed above. Accordingly, if a predetermined operational condition is met, the UE 102 postpones disabling of the DC capability until the operational condition no longer applies.

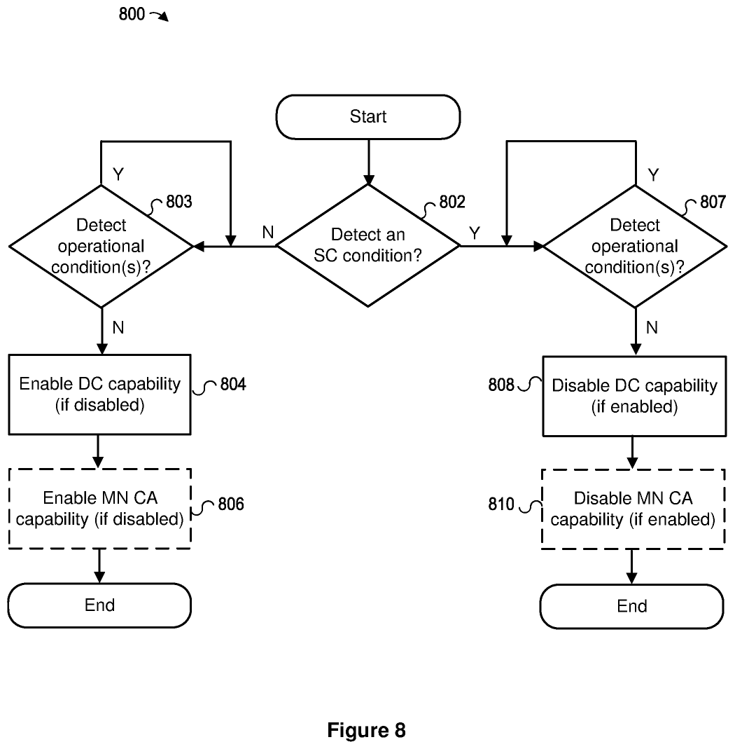

FIG. 8 depicts an example flow diagram 800 of an example method in which the UE 102 determines whether the UE 102 should disable DC capability and (optionally) CA capability in view of detecting a SC condition prior to detecting an operational condition.

The method 800 begins at block 802, where the UE 102 determines whether a SC condition has occurred.

If the UE 102 does not detect a SC condition, the UE 102 at block 803 determines whether a predetermined operational condition is met. If the UE 102 determines that a predetermined operational condition is met, the UE 102 continues to determine whether a predetermined operational condition is not met. If the UE 102 determines that a predetermined operational condition is not met, the UE 102 at block 804 enables DC capability when DC capability previously was disabled, similar to block 704 of FIG. 7. Block 806 is also similar to block 706 discussed above.

However, if the UE 102 detects a SC condition at block 802, the UE 102 at block 807 determines whether a predetermined operational condition is met. If the UE 102 determines that a predetermined operational condition is met, the UE 102 continues to determine whether a predetermined operational condition is not met. If the UE 102 determines that a predetermined operational condition is not met, the UE 102 at block 808 disables DC capability when DC capability previously was enabled, similar to block 708 of FIG. 7. Block 810 is also similar to block 710 discussed above. The operational condition detected at blocks 803 and 807 may be the same or different operational conditions or may include a combination of more than one operational condition. For example, an operational condition that causes the UE 102 to postpone the enabling of the DC capability is a voice call (e.g., to avoid dropped calls), whereas an operational condition that causes the UE 102 to postpone the disabling of the DC capability is a more data intensive activity, such as a video call.

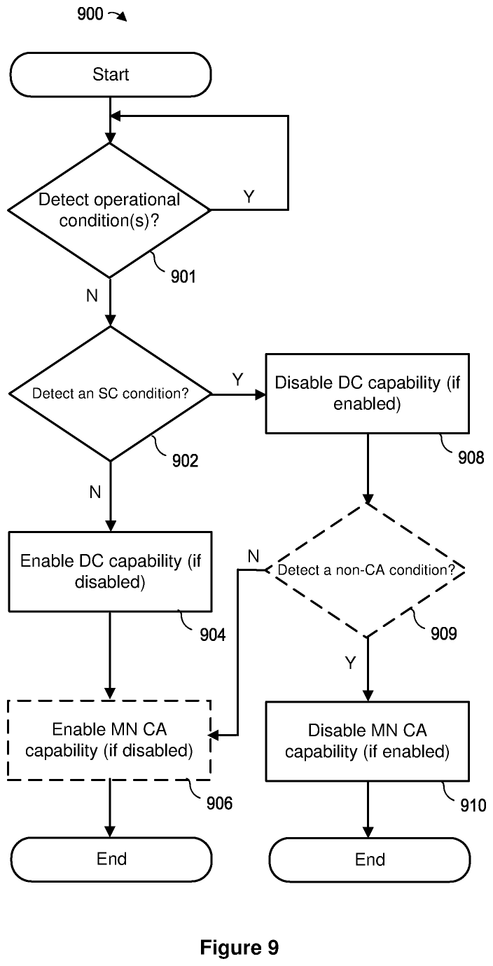

FIG. 9 depicts an example flow diagram 900 of another example method for determining whether the UE 102 should disable DC capability and (optionally) CA capability in response to detecting a predetermined operational condition prior to detecting a SC condition.

The method 900 begins at block 901, where the UE 102 determines whether a predetermined operational condition is met, similar to block 701 of FIG. 7. If the UE 102 determines that a predetermined operational condition is met, the UE 102 continues to determine whether a predetermined operational condition is not met. If the UE 102 determines that a predetermined operational condition is not met, the UE 102 at block 902 determines whether a SC condition has occurred (e.g., by comparing the remaining power level with a certain threshold level), similar to block 302 of FIG. 3.

If the UE 102 does not detect a SC condition, the UE 102 at block 904 enables DC capability when DC capability previously was disabled, similar to block 704 of FIG. 7. Block 906 is also similar to block 706 discussed above.

However, if the UE 102 detects a SC condition, the UE 102 at block 908 disables DC capability, if DC capability previously was enabled, similar to block 708 of FIG. 7.

In some implementations, in addition to disabling DC capability, the UE 102 enables MN CA capability in view of the same SC condition of block 902, but disables MN CA capability in view of a non-CA condition (e.g., the remaining power level is below a second threshold level that is lower than the first threshold level, the required data rate is below a second threshold rate that is lower than the first threshold rate, or that an no application requiring DC and no CA-required application are running). In particular, if the UE 102 does not detect the same SC condition, the UE 102 at block 906 enables MN CA capability, if MN CA capability previously was disabled, similar to block 706 discussed above. If the UE 102 at block 909 detects a non-CA condition, the UE 102 at block 910 disables MN CA capability, similar to block 710 discussed above.

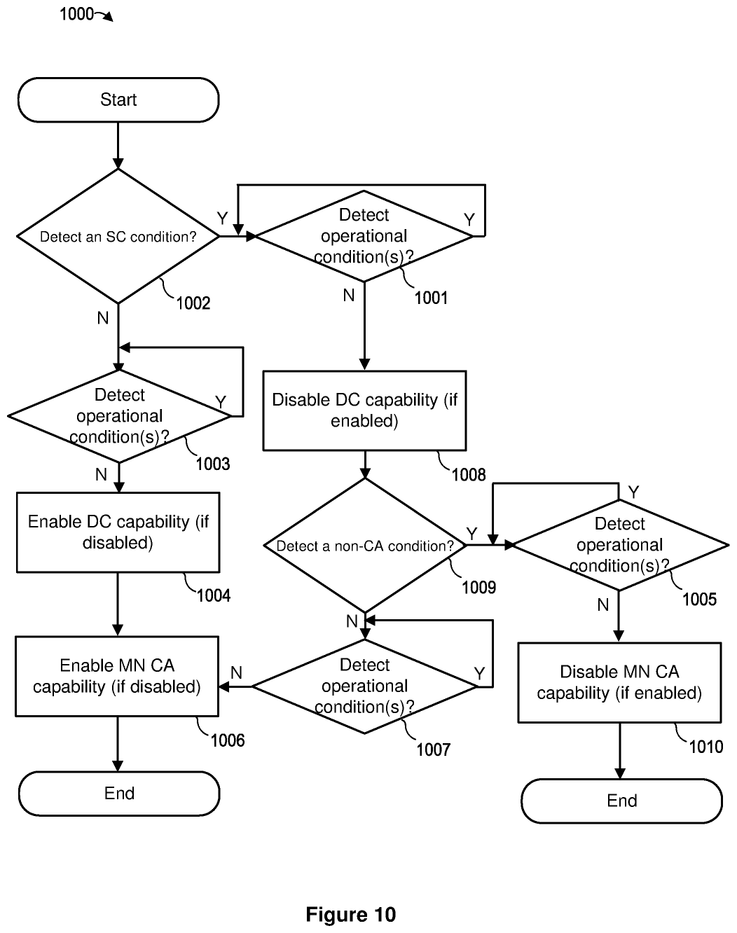

FIG. 10 depicts an example flow diagram 1000 for determining whether the UE 102 should disable DC capability in response detecting a SC condition prior to detecting a predetermined operational condition, and whether the UE 102 should disable CA capability in view of detecting non-CA condition prior to detecting the predetermined operational condition.

The method 1000 begins at block 1002, where the UE 102 determines whether a low-power condition of the battery 103 has occurred (e.g., by comparing the remaining power level with a certain threshold level), similar to block 902 of FIG. 9.

If the UE 102 does not detect a SC condition, the UE 102 at block 1003 determines whether a predetermined operational condition is met, similar to block 803 of FIG. 8. The operational condition detected at block 1003 may be the same or different operational condition as the operational condition detected at block 803. Blocks 1004 and 1006 also are similar to blocks 804 and 806 discussed above.

However, if the UE 102 detects a SC condition at block 1002, the UE 102 at block 1001 determines whether a predetermined operational condition is met, similar to block 807 of FIG. 8. The operational condition detected at block 1001 may be the same or different operational condition as the operational condition detected at block 807. Block 1008 also is similar to block 808 discussed above. The operational condition detected at blocks 1003 and 1001 may be the same or different operational conditions or may include a combination of more than one operational condition.

In some implementations, in addition to disabling DC capability, if the UE 102 at block 1009 does not detect a non-CA condition (e.g., the remaining power level is below a second threshold level that is lower than the first threshold level, the required data rate is below a second threshold rate that is lower than the first threshold rate or no application requiring DC and no CA-required application are running), the UE 102 at block 1007 determines whether a predetermined operational condition is met. If the UE 102 determines that a predetermined operational condition is met, the UE 102 continues to determine whether a predetermined operational condition is not met. If the UE 102 determines that a predetermined operational condition is not met, the UE 102 at block 1006 enables MN CA capability when MN CA capability previously was disabled, similar to block 806 discussed above.

However, if the UE 102 detects a non-CA condition at block 1009, the UE 102 at block 1005 determines whether a predetermined operational condition is met. If the UE 102 determines that a predetermined operational condition is met, the UE 102 continues to determine whether a predetermined operational condition is not met. If the UE 102 determines that a predetermined operational condition is not met, the UE 102 at block 1010 disables MN CA capability when MN CA capability previously was enabled, similar to block 810 discussed above. The operational condition detected at blocks 1007 and 1005 may be the same or different operational conditions or may include a combination of more than one operational condition with respect to the each other as well, as with respect to the operational condition detected at blocks 1003 and 1001.

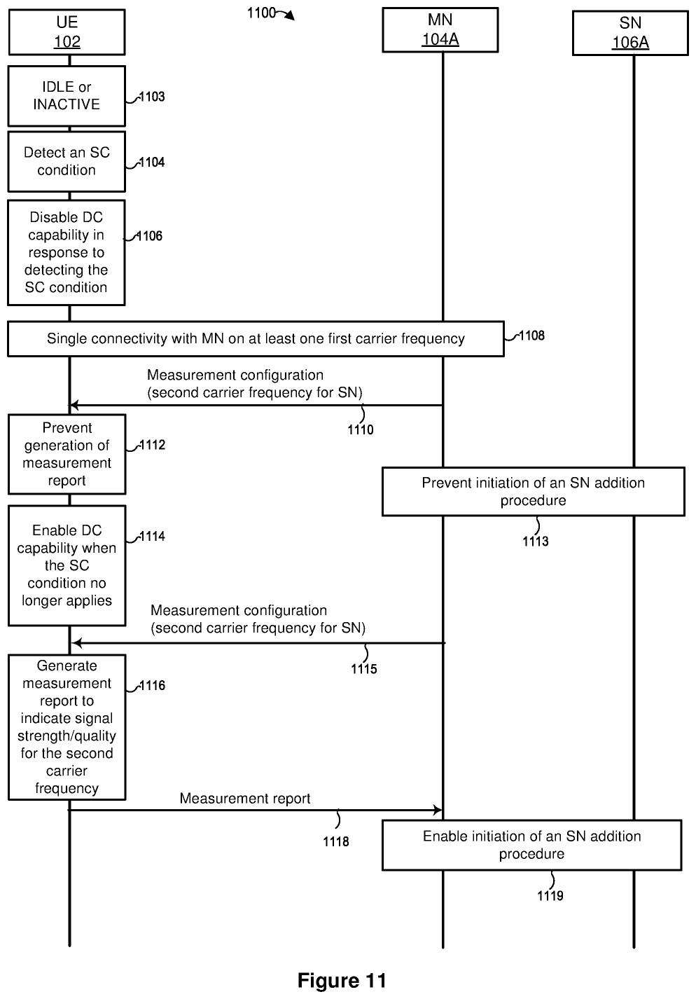

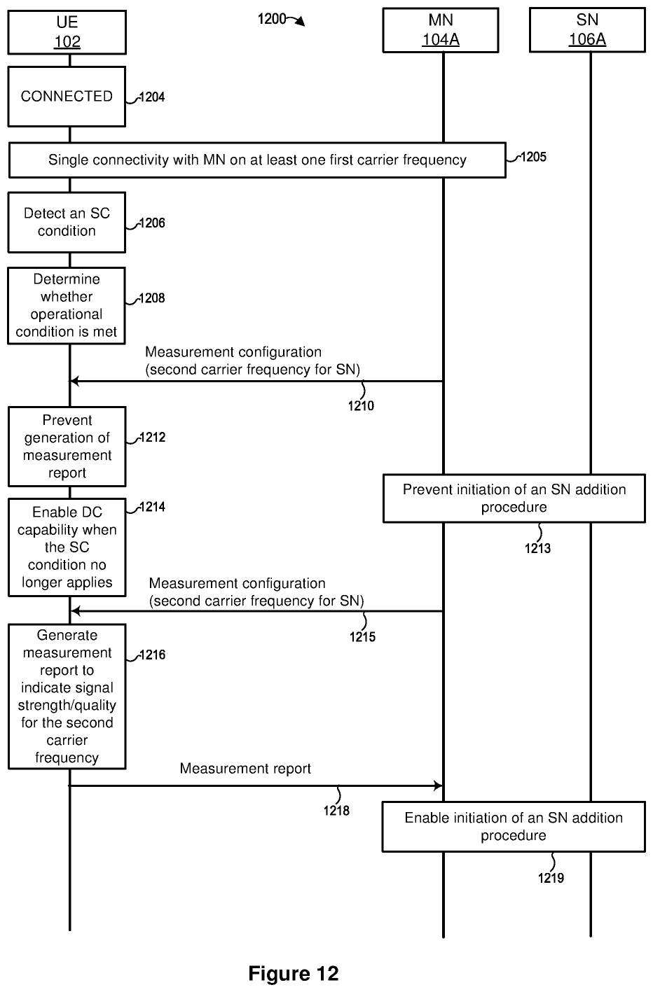

FIGS. 11-12 depict scenarios in which the UE 102 averts the MN 104A from initiating an SN addition procedure by not providing a measurement report pertaining to the SN 106, in contrast to FIGS. 2-3, which describe scenarios in which the UE 102 prevents the MN 104A from initiating an SN addition procedure by providing an explicit indication.

FIG. 11 depicts a messaging diagram 1100 for averting, by the UE 102, an MN 104A from initiating an SN addition procedure by not providing a measurement report pertaining to the SN 106, in response to the UE 102 detecting a SC condition.

At the beginning of this scenario, the UE 102 operates 1103 in an idle state or an inactive state, similar to event 505 in the scenario of FIG. 5. Events 1104 and 1106 also are similar to events 506 and 508 discussed above. Accordingly, the UE 102 operates 1108 in SC with the MN 104A on a carrier frequency of the MN 104.

The UE 102 can notify the MN 104A that the UE 102 has disabled DC capability to prevent the MN 104A from configuring the UE 102 to connect to the SN 106. In some implementations, the UE 102 implicitly notifies 1112 the MN 104A by not generating measurement reports of the carrier frequency of the SN 106A (or by not measuring a carrier frequency of the SN 106A at all). The measurement reports may cause the MN 104A to configure the UE 102 to connect the SN 106A in DC. The UE 102 may still be able to measure a carrier frequency of the SN 106A if the UE 102 disables the DC capability. Alternatively, the UE 102 may disable measuring a carrier frequency of the SN 106A if the UE 102 disables the DC capability. Further, in some implementations, the UE 102 implicitly notifies 1112 the MN 104A in response to the MN 104A transmitting 1110 a measurement configuration in an RRC message for the carrier frequency of the SN 106A to the UE 102 if the UE 102 disables the DC capability. Accordingly, the UE 102 prevents 1113 the MN 104A from initiating an SN addition procedure with the SN 106, while continuing to support SC between the UE 102 and the MN 104. In some implementations, the MN 104A can transmit 1110 the RRC message including the measurement configuration before, during or after event 1108.

In some implementations, the UE 102 transmits an RRC request message to establish the single connectivity with the MN 104A at event 1108. In response, the MN 104A transmits an RRC response message to the UE 102. The UE 102 then transmits an RRC complete message to the MN 104A in response to the RRC response message. In one implementation, the RRC request message can be a RRCConnectionRequest message, a RRCConnectionSetup message and a RRCConnectionSetupComplete message. In another implementation, the RRC request message can be a RRCConnectionResumeRequest message, a RRCConnectionResume message and a RRCConnectionResumeComplete message. In yet another implementation, the RRC request message can be a RRCSetupRequest message, a RRCSetup message and a RRCSetupComplete message. In yet another implementation, the RRC request message can be a RRCResumeRequest message, a RRCResume message and a RRCResumeComplete message.

Exemplary implementations of the UE 102 are described below for the UE 102 disabling the DC capability. In one implementation, instead of preventing generation of measurement reports, the UE 102 generates and transmits “artificial” measurement reports that simulate to the MN 104A low signal strength and/or low signal quality of the carrier frequency of the SN 106, regardless of whether the signal strength and/or the signal quality are in fact low. In another implementation, the UE 102 transmits an explicit indication to the MN 104A to notify the MN 104A that the UE 102 supports DC capability as described with respect to FIGS. 4-6, but the UE 102 does not generate measurement results nor transmit “artificial” reports, described above. In this manner, regardless of implementation, the UE 102 prevents the MN 104A from configuring the UE 102 to use the carrier frequency of the SN 106A in DC. More specifically, the UE 102 does not inform the MN 104A of the carrier frequency measurements of the SN 106. Alternatively, the UE 102 informs the MN 104A or of a low signal strength and/or low signal quality of the carrier frequency of the SN 106A when in actuality the quality of the carrier frequency of the SN 106A may be high enough to configure the UE 102 to use the carrier frequency of the SN 106A in DC. In yet another implementation, if the UE 102 in the idle or inactive state disables DC as described above at event 1106, the UE 102 in the idle or inactive state may disable measuring a carrier frequency of the SN 106A. In this case, the UE 102 may indicate no measurement result for the carrier frequency of the SN 106A is available in the RRC complete message. If the UE 102 in the idle or inactive state enables DC as described above before the event 1108, the UE 102 in the idle or inactive state may measure a carrier frequency of the SN 106A. In this case, the UE 102 may indicate that a measurement result for the carrier frequency of the SN 106A is available in the RRC complete message.

Implicitly notifying the MN 104A that the UE 102 has disabled DC capability may also prevent scenarios in which the UE 102 transmits SN measurement results to the MN 104, causing the MN 104A to configure the UE 102 to be DC (i.e., to connect the SN 106) after the UE 102 transitions from idle state or inactive state to a connected state while the SC condition remains. The MN 104A may transmit a measurement configuration configuring the UE 102 to measure a carrier frequency of the SN 106A in an RRC message when the UE is in the connected state. Without implicitly notifying the MN 104A by the UE 102, the MN 104A configures the UE 102 to be in DC with the SN 106, despite the SC condition.

When the UE 102 detects that the SC condition no longer applies, the UE 102 enables 1114 DC capability. To notify the MN 104A that the UE 102 enabled DC capability, the UE 102 measures a carrier frequency of the SN 106, generates 116 a measurement report message, and transmits 1118 the measurement report message to the MN 104. To this end, the UE 102 may use SRB1 to transmit the measurement report message to the MN 104A if the measurement report message is to be transmitted 104A to the SN 106A via the MN 104. Alternatively, the UE 102 may use SRB3 to transmit the measurement report message to the SN 106A if the measurement report message is to be transmitted to the SN 106.

Exemplary implementations of the UE 102 are described below for the UE 102 enabling the DC capability. In some implementations, the UE 102 transmits 1118 the measurement report message to the MN 104A in response to the MN 104A transmitting 1110 or 1115 a measurement configuration (e.g., MeasConfig) in an RRC message for the carrier frequency of the SN 106A to the UE 102. The measurement configuration can include a carrier frequency configuration configuring the carrier frequency of the SN 106A to be measured. The MN 104A can include the measurement configuration in the RRC message or in a system information block (SIB). The MN 104A transmits the RRC message to the UE 102 via an SRB or broadcasts the SIB to the UE 102. In one particular implementation, if the MN 104A is an E-UTRA base station (e.g., eNB or ng-eNB) and the SN 106A is a 5G NR base station (e.g., gNB), the carrier frequency configuration is a 5G NR carrier frequency configuration (e.g., CarrierFreqListNR-r15), the SIB can be a SystemInformationBlockType24, and the RRC message can be an RRCConnectionReconfiguration message, an RRCConnectionResume message, an RRCConnectionRelease message, or a new RRC message configuring the UE 102 to perform measurements in idle or inactive state. In response, the UE 102 measures a 5G NR carrier frequency configured in the 5G NR carrier frequency configuration, and reports the measurement results in the measurement report message back to the MN 104.

In another implementation, if both the MN 104A and the SN 106A are 5G NR base stations (e.g., gNBs), the measurement configuration is a MeasConfig, the SIB is an existing SIB (e.g., SIB4) or a new SIB, and the RRC message is an RRCCReconfiguration message, an RRCResume message, an RRCRelease message, or a new RRC message configuring the UE 102 to perform measurements in idle or inactive state. The MN 104A transmits the RRC message or broadcasts the SIB to the UE 102 on a first 5G NR carrier frequency (e.g., in a frequency range 1 (FR1)). The MeasConfig configures a second 5G NR carrier frequency (e.g., in a FR1 or a frequency range 2 (FR2)) for the SN 106. In response, the UE 102 measures the second 5G NR carrier frequency, and reports the measurement results in the measurement report message back to the MN 104.

Provided that the measurement report message indicates that the signal strength or quality of the carrier frequency of the SN 106A is suitable (e.g., meets a certain threshold) for DC, the UE 102 enables 1119 the MN 104A to initiate an SN addition procedure with the SN 106. In some implementations, the measurement report message can be a MeasurementReport message, a UEInformationResponse message, or an RRC message defined to include measurement results measured during idle state or inactive state.

FIG. 12 depicts a messaging diagram 1200 for preventing, by the UE 102 operating in a connected state of the RRC protocol, the MN 104A from initiating an SN addition procedure by not providing a measurement report pertaining to the SN 106.

At the beginning of this scenario, the UE 102 operates 1204 in a connected state, similar to event 605 in the scenario of FIG. 6. Accordingly, the UE 102 operates 1205 in SC with the MN 104A on a carrier frequency of the MN 104. Events 1206, 1208, 1210, 1212, 1213, 1214, 1215, 1216, and 1218 also are similar to events 1104, 607, 1110, 1112, 1113, 1114, 1115, 1116, and 1118 discussed above.

Exemplary implementations of the UE 102 are described below for the UE 102 enabling the DC capability. In some implementations, the UE 102 transmits 1218 a measurement report message to the MN 104A in response to the MN 104A transmitting 1210 or 1215 a measurement configuration (e.g., MeasConfig) for the carrier frequency of the SN 106A to the UE 102. The measurement configuration can include a carrier frequency configuration configuring the carrier frequency of the SN 106A to be measured. The MN 104A can include the measurement configuration in an RRC message or in an SIB. The MN 104A transmits the RRC message to the UE 102 via an SRB or broadcasts the SIB to the UE 102. In one particular implementation, if both the MN 104A and the SN 106A are 5G NR base stations (e.g., gNBs), the RRC message can be an RRCReconfiguration message, an RRCResume message, or an RRCRelease message, and the SIB can be an existing SIB (e.g., SIB4) or a new SIB. The MN 104A transmits the RRC message to the UE 102 on a first 5G NR carrier frequency (e.g., in a frequency range 1 (FR1)). The measurement configuration configures a second 5G NR carrier frequency (e.g., in FR1 or a frequency range 2 (FR2)) for the SN 106. In response, the UE 102 measures the second 5G NR carrier frequency, and reports the measurement results in the measurement report message back to the MN 104. In some implementations, the measurement report message can be a MeasurementReport message, a UEInformationResponse message, or an RRC message defined to include measurement results measured in idle state or inactive state.

In another implementation, if the MN 104A is an E-UTRA base station (e.g., eNB or ng-eNB) and the SN 106A is a 5G NR base station (e.g., gNB), the SIB can be a SystemInformationBlockType24, and the RRC message can be an RRCConnectionReconfiguration message, an RRCConnectionResume message, an RRCConnectionRelease message, or a new RRC message configuring the UE 102 to perform measurements in idle or inactive state. The MN 104A transmits the RRC message or broadcasts the SIB to the UE 102 on an E-UTRA carrier frequency. The measurement configuration configures a 5G NR carrier frequency for the SN 106. In response, the UE 102 measures the 5G NR carrier frequency, and reports the measurement results in the measurement report message back to the MN 104.

Provided that the measurement report message indicates that the signal strength or quality of the carrier frequency of the SN 106A is suitable (e.g., meets a threshold) for DC, the UE 102 enables 1219 the MN 104A to initiate an SN addition procedure with the SN 106, similar to event 1119.

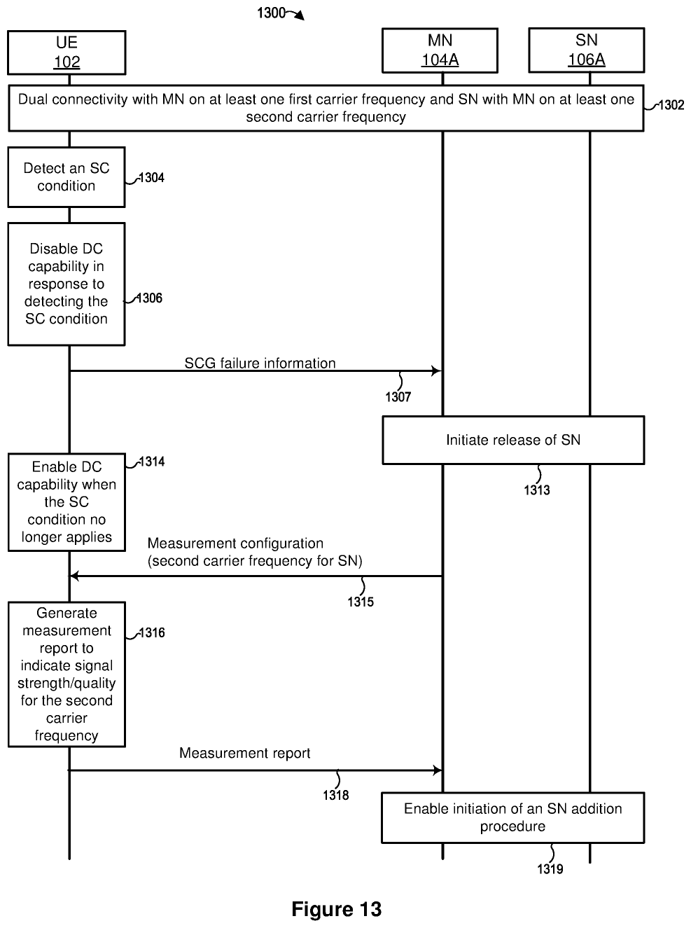

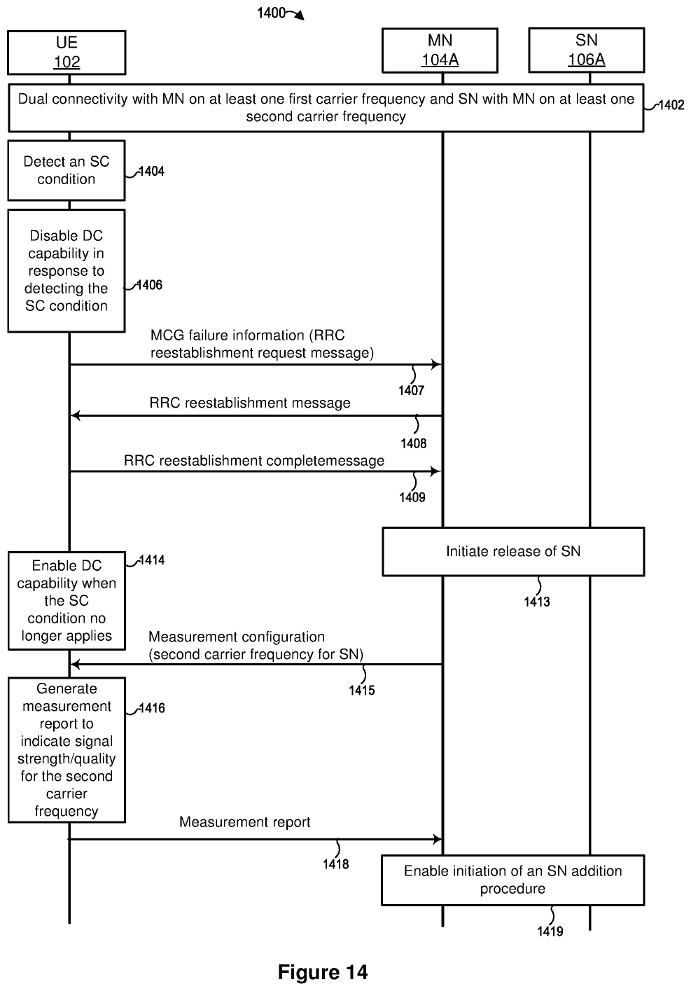

FIG. 13 depicts a messaging diagram 1300 of an example scenario in which the UE 102 prevents the MN 104A from initiating an SN addition procedure, by transmitting an indication of SCG failure to the MN 104.

At the beginning of this scenario, the UE 102 operates 1302 in DC with the MN 104A on a carrier frequency of the MN 104A and the SN 106A on a carrier frequency of the SN 106. The UE 102 disables 1306 DC capability in response to event 1304. Event 1304 is similar to the event 406 discussed above.

The UE 102 then detects SCG failure and suspends SCG transmission for all SRBs and DRBs configured to use the resources provided by the SN 106A in response to disabling 1306 DC capability. In other words, if the UE 102 detects event 1304, the UE 102 reports SCG failure occurs, even though the UE 102 may still be capable of communicating with the SN 106. The UE 102 generates an indication of SCG failure to notify 1307 the MN 104A that the UE 102 will no longer be using DC. In some implementations, the UE 102 indicates that the UE 102 will no longer be using DC in an SCG failure message. The SCG failure message can be an SCG Failure Information message, an SCG Failure Information NR message, or an SCG Failure Information EUTRA message. The UE 102 transmits an SCG failure message to the MN 104A via an SRB (e.g., SRB1). The SCG failure message can include a first failure type and/or a second failure type. The first failure type can be set to t310-Expiry, randomAccessProblem, rlc-MaxNumRetx, synchReconfigFailure-SCG, scg-reconfigFailure, or srb3-IntegrityFailure, for example, and the second failure type can be set to an indication of the SC condition. By sending the indication of SCG failure to the MN 104, the UE 102 can cause the MN 104A to initiate 1313 release of the SN 106A SN (SN release or DC release) while continuing to support SC between the UE 102 and the MN 104. The UE 102 in this case prevents the MN 104A from performing a procedure for recovering from SCG failure.

In some implementations, the UE 102 may include an “artificial” measurement result in the SCG failure message that simulates to the MN 104A or the SN 106A low signal strength and/or low signal quality of the carrier frequency of the SN 106, regardless of whether the signal strength and/or the signal quality are in fact low, or even though the signal strength and/or the signal quality are in fact high or sufficient for communication. In other implementations, the UE 102 excludes measurement results in the SCG failure message that indicate to the MN 104A or the SN 106A high signal strength and/or high signal quality of the carrier frequency of the SN 106. In further implementations, the UE 102 excludes any measurement result in the SCG failure message.

In some cases, the MN 104A may transmit an RRC reconfiguration message to the UE 102 in response to the SCG failure message. The MN 104A indicates the UE 102 to release the SN 106A in the RRC reconfiguration message. In response to the RRC reconfiguration message, the UE 102 releases configurations (e.g., SCG configuration or cell group configuration) for communicating with the SN 106.

In some implementations, if the UE 102 is configured to measure at least one carrier frequency of the SN 106A (or another SN) in response to a measurement configuration received from the MN 104A or the SN 106A (or another SN), similar to event 1210, the UE 102 can stop measuring one or more of the at least one carrier frequency of the SN 106A upon disabling 1306 DC capability. The UE 102 can also continue measuring the remaining at least one second carrier frequency in response to another measurement configuration received from the MN 104A or the SN 106A (or another SN). In other implementations, if the UE 102 is configured to measure carrier frequencies of the SN 106A (or another SN) in response to a measurement configuration received from the MN 104A or the SN 106A (or another SN), the UE 102 can still continue measuring at least one carrier frequency of the SN 106A upon disabling 1306 DC capability. In this case, the UE 102 does not transmit a measurement report to the MN 104A that indicates high signal strength and/or signal quality of the at least one carrier frequency, or the UE 102 transmits one or more artificial measurement reports to the MN 104A for the at least one carrier frequency as described above. In further implementations, the UE 102 can stop measuring all of the at least one carrier frequency upon disabling 1306 DC capability. In additional implementations, the UE 102 disables one or more RF chains/chips used to receive the at least one carrier frequency of the SN 106, upon disabling the DC capability, thereby reducing power consumption. The at least one carrier frequency may or may not include carrier frequency/frequencies in the at least one second carrier frequency.

Events 1314, 1315, 1316, and 1318 are similar to the events 1114, 1115, 1116, and 1118 discussed above. In some implementations, the SC condition of the event 1314 can be the same SC condition (e.g., the remaining power level is below a first threshold level, the required data rate is below a first threshold rate) as in the event 1304 or a non-CA condition (e.g., the remaining power level is below a second threshold level that is higher than or lower than the first threshold level, the required data rate is below a second threshold rate that is lower than the first threshold rate, or no application requiring DC and no application requiring CA is running). If the UE 102 is configured to measure a carrier frequency of the SN 106A (or another SN) in response to a measurement configuration 1315 received from the MN 104A or the SN 106A (or another SN), the UE 102 begins measuring the carrier frequency. The UE 102 can generate 1316 the measurement report message including the measurement result, and transmit 1318 the measurement report message to the MN 104. Accordingly, the MN 104A can configure the UE 102 to connect to the SN 106A (or another SN) if the measurement report message indicates that the UE 102 has high signal strength and/or high signal quality on the carrier frequency (i.e., the UE 102 is within the coverage area of the SN 106A (or another SN)).

In some implementations, the UE 102 does not transmit 1318 the measurement report message to the MN 104A if the temperature of the UE 102 (or one of the components of the processing hardware of the UE 102, such as the DC controller 151, power management module 120, MN module 114, and/or the SN module 116) measured by the thermal management module exceeds the a certain level (e.g., the temperature level is above a third threshold level). The UE 102 can transmit 1318 the measurement report message to the MN 104A if the temperature of the UE 102 does not exceed a certain level (e.g., the temperature level is below the third threshold level or a fourth level which is lower than the third level).

Event 1319 is similar to the event 1119 discussed above. The MN 104A can perform a procedure for recovering from SCG failure or configuring the SCG of the SN 106A or another SN (not shown to avoid clutter). To this end, the MN 104A can transmit an RRC reconfiguration message to the UE 102 to resume the SCG transmission that was suspended previously, using a DRB. In response, the UE 102 resumes the SCG transmission using the DRB to communicate data to the MN 104. The UE 102 may also transmit an RRC reconfiguration complete message to the MN 104A in response to the RRC reconfiguration message. If the MN 104A is an E-UTRA base station (e.g., cNB or ng-eNB), the RRC reconfiguration message can be an RRC Connection Reconfiguration message and the RRC reconfiguration complete message can be an RRC Connection Reconfiguration Complete message. If the MN 104A is a 5G NR base station (e.g., gNBs), the RRC reconfiguration message can be an RRC Reconfiguration message and the RRC reconfiguration complete message can be an RRC Reconfiguration Complete message.

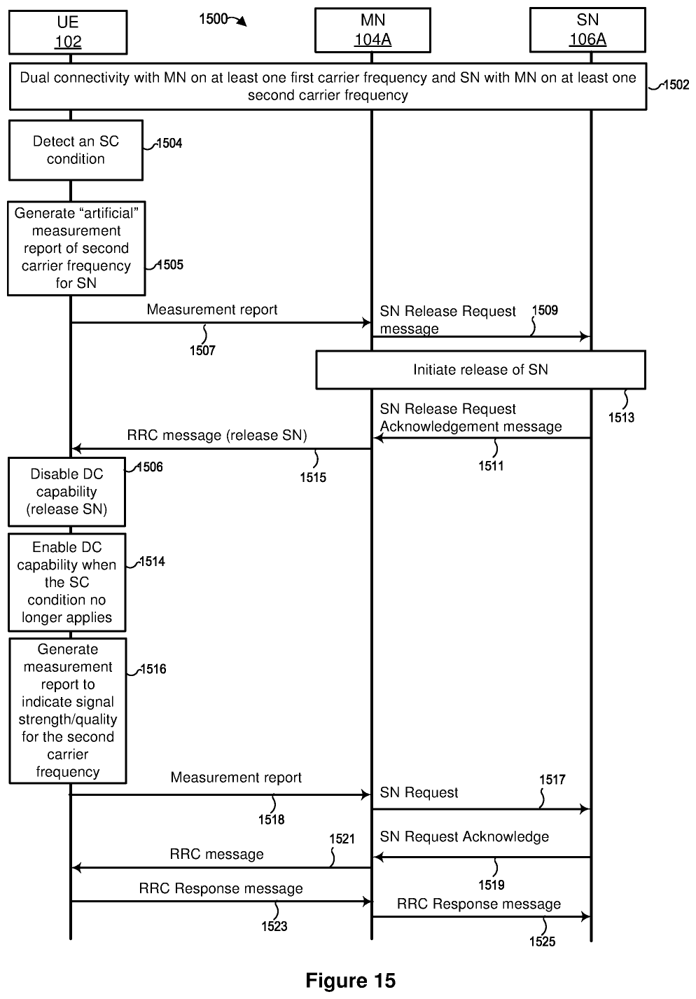

FIG. 14 depicts a messaging diagram 1400 of an example scenario in which the UE 102 prevents the MN 104A from initiating an SN addition procedure, by transmitting an indication of MCG failure to the MN 104.

At the beginning of this scenario, the UE 102 operates 1402 in DC with the MN 104A on a carrier frequency of the MN 104A and the SN 106A on a carrier frequency of the SN 106, similar to event 1302 in the scenario of FIG. 13. Events 1404 and 1406 are also similar to the events 1304 and 1306 discussed above.

In response to disabling 1406 DC capability, the UE 102 then detects MCG failure and suspends MCG transmission for all SRBs and DRBs configured to use the resources provided by the MN 104. In other words, if the UE 102 detects event 1404, the UE 102 reports MCG failure occurs, even though the UE 102 may still be capable of communicating with the MN 104. The UE 102 generates an indication of MCG failure to notify 1407 the MN 104A that the UE 102 will no longer be using DC. In some implementations, the UE 102 indicates that the UE 102 will no longer be using DC in an RRC reestablishment request message. The UE 102 transmits an RRC reestablishment request message to the MN 104A in an SRB (e.g., SRB0). The RRC reestablishment request message can indicate a failure type, which can be reconfiguration Failure, handoverFailure, otherFailure, or an indication of the SC condition. If the MN 104A is an E-UTRA base station (e.g., eNB or ng-CNB), the RRC reestablishment request message is an RRC Connection Reestablishment Request message. If the MN 104A is an 5G NR base station (e.g., gNBs), the RRC reestablishment request message is an RRC Reestablishment Request message.

In response to transmitting the RRC reestablishment request message to the MN 104, the UE 102 may receive 1408 an RRC reestablishment message from the MN 104. If the MN 104A is an E-UTRA base station (e.g., eNB or ng-eNB), the RRC reestablishment message is an RRC Connection Reestablishment message, and the UE 102 may receive the RRC reestablishment message from the MN 104A in SRB0. If the MN 104A is an 5G NR base station (e.g., gNBs), the RRC reestablishment message is an RRC Reestablishment message, and the UE 102 may receive the RRC reestablishment message from the MN 104A in an SRB1.

In response to receiving the RRC reestablishment message from the MN 104, the UE 102 may transmit 1409 an RRC reestablishment complete message to the MN 104A in SRB1, for example. If the MN 104A is an E-UTRA base station (e.g., eNB or ng-eNB), the RRC reestablishment complete message is an RRC Connection Reestablishment Complete message. If the MN 104A is an 5G NR base station (e.g., gNBs), the RRC reestablishment complete message is an RRC Reestablishment Complete message. By sending the RRC reestablishment complete message to the MN 104, the UE 102 can enable the MN 104A to initiate 1413 release of SN 106A (e.g., prevent the MN 104A from performing a procedure for recovering from the MCG failure), similar to the event 1313 discussed above.

Events 1414, 1415, 1416, and 1418 are similar to the events 1314, 1315, 1316, and 1318 discussed above.

Further, event 1419 is similar to the event 1319 discussed above. The MN 104A can perform a procedure for recovering from MCG failure (not shown to avoid clutter). To this end, the MN 104A can transmit an RRC reconfiguration message to the UE 102 to resume the MCG transmission that was suspended earlier using a DRB. In response, the UE 102 resumes the MCG transmission using the DRB to communicate data to the MN 104. The UE 102 may also transmit an RRC reconfiguration complete message to the MN 104A in response to the RRC reconfiguration message. If the MN 104A is an E-UTRA base station (e.g., eNB or ng-eNB), the RRC reconfiguration message can be an RRC Connection Reconfiguration message and the RRC reconfiguration complete message can be an RRC Connection Reconfiguration Complete message. If the MN 104A is an 5G NR base station (e.g., gNBs), the RRC reconfiguration message can be an RRC Reconfiguration message, and the RRC reconfiguration complete message can be an RRC Reconfiguration Complete message.

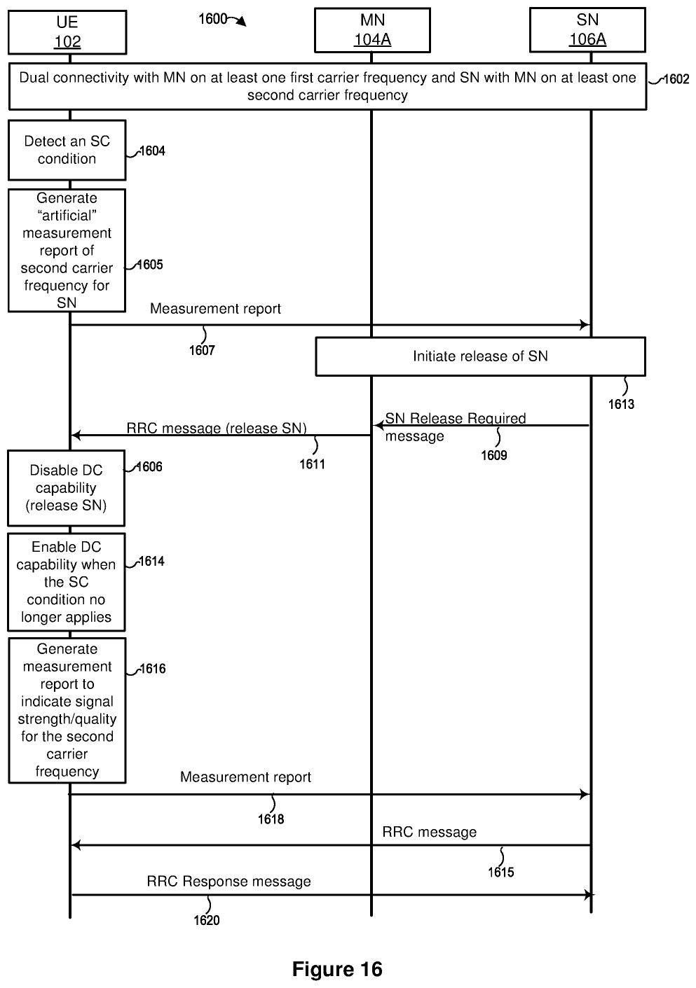

FIG. 15 depicts a messaging diagram 1500 of an example scenario in which the UE 102 enables the MN 104A to initiate an SN release, by providing an “artificial” measurement report pertaining to the SN 106.

At the beginning of this scenario, the UE 102 operates 1502 in DC with the MN 104A on at least one carrier frequency of the MN 104A and the SN 106A on at least one carrier frequency of the SN 106, similar to the event 1402 in the scenario of FIG. 14. Event 1504 is also similar to the event 1404 discussed above.

In response to detecting a SC condition, the UE 102 can notify the MN 104A that the UE 102 has disabled DC capability to prevent the MN 104A from configuring the UE 102 to connect to the SN 106. In some implementations, the UE 102 implicitly notifies the MN 104A by generating 1505 and transmitting 1507 an “artificial” measurement report message to the MN 104A that simulates to the MN 104A low signal strength and/or low signal quality of the carrier frequency of the SN 106, regardless of whether the signal strength and/or the signal quality are in fact low, or even though the signal strength and/or the signal quality are in fact high or sufficient for communication, similar to the event 1112 in the scenario of FIG. 11. Accordingly, the UE 102 causes the MN 104A to initiate 1513 release of the SN 106, similar to the events 1313 and 1413 discussed above. The MN 104A can transmit 1515 an RRC message to the UE 102 to configure the UE 102 to release the SN 106A (i.e., release all of the at least one second carrier frequency) in response. The UE 102 can transmit an RRC response message (not shown to avoid clutter) to the MN 104A in response. If the MN 104A is an E-UTRA base station (e.g., eNB or ng-eNB), the RRC message can be an RRC Connection Reconfiguration message and the RRC response message can be an RRC Connection Reconfiguration Complete message. If the MN 104A is an 5G NR base station (e.g., gNBs), the RRC message can be an RRC Reconfiguration message and the RRC response message can be an RRC Reconfiguration Complete message. In some scenarios (not shown to avoid clutter), the MN 104A can send an SN Release Request message to the SN 106A in response to the MN 104A initiating release of the SN 106, before or after transmitting 1515 the RRC message to the UE 102 described above. In such scenarios, the SN 106A may transmit an SN Release Acknowledge message to the MN 104A in response.

In other implementations, the UE 102 implicitly notifies the MN 104A by generating and transmitting an “artificial” measurement report message to the MN 104A that simulates low signal strength and/or low signal quality of some (i.e., one or more, but not all) of the carrier frequencies of the SN 106, regardless of whether the signal strength and/or the signal quality are in fact low. Accordingly, the “artificial” measurement report message triggers the MN 104A to initiate release of some (i.e., one or more, but not all) of the carrier frequencies of the SN 106. In one such implementation, the MN 104A determines to release some of the carrier frequencies of the SN 106A for the UE 102. In response to receiving the “artificial” measurement report message from the UE 102, the MN 104A sends 1509 an SN Request message to the SN 106, requesting the SN 106A to release some of the carrier frequencies. In response to the SN Request message, the SN 106A generates an RRC message indicating release of some of the carrier frequencies. The SN 106A sends 1511 an SN Request Acknowledge message, which includes the RRC message, to the MN 104A in response to the SN Request message. The MN 104A then transmits 1515 the RRC message to the UE 102. The UE 102 then releases some of the carrier frequencies of the SN 106A in response to the RRC message. The UE 102 may transmit an RRC response message in response to the RRC message. The MN 104A can forward the RRC response message to the SN 106. By not communicating with the SN 106A on some of the carrier frequencies of the SN 106A (i.e., communicating with the SN 106A on the remainder of the carrier frequencies of the SN 106), the UE 102 reduces the amount of heat the chip supporting the RAT of the SN 106A generates.

In some implementations, the UE 102 can indicate some (i.e., one or more, but not all) of the carrier frequencies of the SN 106A in a prioritized manner in “artificial” measurement report messages and transmit the “artificial” measurement report messages to the MN 104. For example, if the carrier frequencies of the SN 106A include an unlicensed carrier frequency and a licensed carrier frequency, the UE 102 can indicate the unlicensed carrier frequency in a first “artificial” measurement report message and transmits the first “artificial” measurement report message to the MN 104. The first “artificial” measurement report message may cause the MN 104A to configure the UE 102 to release the unlicensed carrier frequency. If the SC condition is still met after the UE 102 releases the unlicensed carrier frequency, the UE 102 indicates the licensed carrier frequency in a second “artificial” measurement report message and transmits the second “artificial” measurement report message to the MN 104. The second “artificial” measurement report message may cause the MN 104A to configure the UE 102 to release the unlicensed carrier frequency.

As another example, the UE 102 can prioritize indicating a higher carrier frequency of the SN 106A over a lower carrier frequency. For instance, if carrier frequencies of the SN 106A include carrier frequencies in a certain range, such as FR2 (e.g., above 6 Ghz or 7.125 Ghz), and another range, such as FR1 (e.g., below 6 Ghz or 7.125 Ghz), the UE 102 can indicate carrier frequencies in the range FR2 before indicating carrier frequencies in the range FR1. For example, if the carrier frequencies of the SN 106A include a first carrier frequency in FR2 and a second carrier frequency in FR1, the UE 102 can indicate the first carrier frequency in a first “artificial” measurement report message and transmits the first “artificial” measurement report message to the MN 104. The first “artificial” measurement report message may cause the MN 104A to configure the UE 102 to release the first carrier frequency. If the SC condition is still met after the UE 102 releases the first carrier frequency, the UE 102 indicates the second carrier frequency in a second “artificial” measurement report message and transmits the second “artificial” measurement report message to the MN 104. The second “artificial” measurement report message may cause the MN 104A to configure the UE 102 to release the second carrier frequency.

As another example, the UE 102 can prioritize indicating one or more carrier frequencies of the SN 106, usage of which causes the UE 102 to generate more heat. For example, if the carrier frequencies of the SN 106A include a first carrier frequency, usage of which causes the UE to generate more heat than using a second carrier frequency, the UE 102 can indicate the first carrier frequency in a first “artificial” measurement report message and transmits the first “artificial” measurement report message to the MN 104. The first “artificial” measurement report message may cause the MN 104A to configure the UE 102 to release the first carrier frequency. If the SC condition is still met after the UE 102 releases the first carrier frequency, the UE 102 indicates the second carrier frequency in a second “artificial” measurement report message and transmits the second “artificial” measurement report message to the MN 104. The second “artificial” measurement report message may cause the MN 104A to configure the UE 102 to release the second carrier frequency.

In some implementations of the UE 102 configured to release the SN 106, the DC controller 151 releases 1506 at least one of the carrier frequencies of the SN 106A in response to detecting 1504 a SC condition, rather than in response to receiving 1515 the RRC message. In such implementations, the UE 102 can release carrier frequencies of the SN 106A in a prioritized manner. For example, if carrier frequencies of the SN 106A include one or more unlicensed carrier frequencies and licensed carrier frequencies, the UE 102 can release one or more unlicensed carrier frequencies before releasing one or more licensed carrier frequencies. As another example, the UE 102 can prioritize releasing higher carrier frequencies of the SN 106A before lower carrier frequencies. For instance, if the carrier frequencies of the SN 106A include carrier frequencies in a certain range, such as FR2 (e.g., above 6 Ghz or 7.125 Ghz), and another range, such as FR1 (e.g., below 6 Ghz or 7.125 Ghz), the UE 102 can release a carrier frequency in the range FR2 before releasing a carrier frequency in the range FR1. As another example, the UE 102 can prioritize releasing some (e.g., one or more) of those carrier frequencies of the SN 106, usage of which causes the UE 102 to generate more heat.

In another implementation, in response to detecting 1504 a SC condition, the DC controller 151 transmits channel quality indicators (CQIs) on physical uplink control channel(s) (PUCCH(s)), where the CQIs simulate to the MN 104A low channel quality of at least one of the carrier frequencies of the SN 106, regardless of whether the channel quality is in fact low or even though the signal strength and/or the signal quality are in fact high or sufficient for communication. For example, zero or another predefined value (or a range of values) designates low channel quality. After the UE 102 determines that the SC condition no longer applies, the DC controller 151 transmits CQIs to the MN 104A indicating real channel quality of at least one of the carrier frequencies of the SN 106.

Accordingly, the MN 104A can transmit 1515 the RRC message to the UE 102 to configure the UE 102 to release the SN 106A in response to the RRC message. The UE 102 then disables 1506 DC operation with the SN 106A (i.e., releases the SN 106) in response to the RRC message.

Events 1514, 1516, and 1518 are similar to the events 1414, 1416, and 1418 discussed above.

When, according to the signal strength or quality of at least one carrier frequency indicated 1518 in the measurement report message, the UE 102 is within the area of coverage of the SN 106A (e.g., the UE 102 meets a threshold for DC), the UE 102 can enable the MN 104A to initiate an SN addition procedure with the SN 106. In some implementations, the UE 102 sends 1518 the measurement report message to the MN 104A so that the MN 104A can initiate a procedure for adding back at least one carrier frequency of the SN 106A for communication with the SN 106. In response, the MN 104A transmits 1517 an SN Request message (e.g., SN Addition Request message or SN Modification Request message) to the SN 106A to request that the SN 106A configure the UE 102 to receive downlink transmissions from the SN 106A on the at least one carrier frequency. In response to the SN Request message, the SN 106A generates an RRC message configuring the UE 102 to receive downlink transmissions from the SN 106A on the at least one carrier frequency and sends 1519 an SN Request Acknowledge message (e.g., SN Addition Request Acknowledge message or SN Modification Request Acknowledge message) including the RRC message to the MN 104. In response, the MN 104A transmits 1521 the RRC message to the UE 102. The UE 102 then can receive downlink transmissions from the SN 106A on the at least one carrier frequency according to the RRC message. The UE 102 can transmit 1523 an RRC Response message (e.g., RRC Reconfiguration Complete message) to the MN 104A in response to the RRC message (e.g., RRC Reconfiguration message). The MN 104A can forward 1525 the RRC response message to the SN 106.

FIG. 16 depicts a messaging diagram 1600 of an example scenario in which the UE 102 enables the SN 106A to initiate an SN release, by providing an “artificial” measurement report pertaining to the SN 106.

At the beginning of this scenario, the UE 102 operates 1602 in DC with the MN 104A on at least one carrier frequency of the MN 104A and the SN 106A on at least one carrier frequency of the SN 106, similar to the event 1502 in the scenario of FIG. 15. Event 1604 is similar to the event 1504 discussed above.

In response to detecting a SC condition, the UE 102 can notify the SN 106A that the UE 102 has disabled DC capability to prevent the SN 106A from configuring the UE 102 to connect to the SN 106. In some implementations, the UE 102 implicitly notifies the SN 106A or both the MN 104A and the SN 106A (i.e., in contrast to implicitly notifying the MN 104A described in FIG. 15) by generating 1605 and transmitting 1607 an “artificial” measurement report message to the SN 106A via the MN 104A that simulates to the SN 104A low signal strength and/or low signal quality of the carrier frequency of the SN 106, regardless of whether the signal strength and/or the signal quality are in fact low or even though the signal strength and/or the signal quality are in fact high or sufficient for communication. The UE 102 can transmit the “artificial” measurement report message to the SN 106A using radio resources of the MN 104A or radio resources of the SN 106, such as an SRB (e.g., SRB3). Accordingly, the “artificial” measurement report message triggers the SN 106A to initiate 1613 release of the SN 106. The SN 106A can transmit 1609 an SN Release Required message to the MN 104A in response, and the MN 104A can transmit 1611 the RRC message to the UE 102 to configure the UE 102 to release the SN 106A in response to the SN Release Required message. In some scenarios (not shown to avoid clutter), the MN 104A can send an SN Release Confirm message to the SN 106A in response to the SN Release Required message, before or after transmitting 1611 the RRC message to the UE 102 described above. In such scenarios, the UE 102 can transmit an RRC response message to the MN 104A in response. If the MN 104A is an E-UTRA base station (e.g., eNB or ng-eNB), the RRC message can be an RRC Connection Reconfiguration message and the RRC response message can be an RRC Connection Reconfiguration Complete message. If the MN 104A is an 5G NR base station (e.g., gNBs), the RRC message can be an RRC Reconfiguration message and the RRC response message can be an RRC Reconfiguration Complete message.

In other implementations, the UE 102 implicitly notifies the SN 106A by generating and transmitting an “artificial” measurement report message to the SN 106A that simulates low signal strength and/or low signal quality of some (i.e., one or more, but not all) of the carrier frequencies of the SN 106, regardless of whether the signal strength and/or the signal quality are in fact low. Accordingly, the “artificial” measurement report message triggers the SN 106A to initiate release of some (i.e., one or more, but not all) of the carrier frequencies of the SN 106. In one such implementation, the SN 106A determines to release some of the carrier frequencies of the SN 106A for the UE 102. In response to receiving the “artificial” measurement report message from the UE 102, the SN 106A generates an RRC message indicating release of some of the carrier frequencies. The SN 106A sends the RRC message to the UE 102 via the MN 104A using radio resources of the MN 104A or radio resources of the SN 106, such as an SRB (e.g., SRB3). The UE 102 then releases some of the carrier frequencies of the SN 106A in response to the RRC message, thereby reducing the amount of heat the chip supporting the RAT of the SN 106A generates. If the UE 102 receives the RRC message from the MN 104, the UE 102 transmits an RRC response message to the MN 104, as discussed above. If the UE 102 receives the RRC message from the SN 106A using an SRB, the UE 102 can transmit an RRC response message (e.g., RRC Reconfiguration Complete message) to the SN 106A by using radio resources of the SN 106A in response to the RRC message (e.g., RRC Reconfiguration message).

Accordingly, the SN 106A can transmit 1611 the RRC message to the UE 102 to configure the UE 102 to release the SN 106A in response to the RRC message. The UE 102 then disables 1606 DC operation with the SN 106A (i.e., releases the SN 106) in response to the RRC message, similar to event 1506 of FIG. 15.

Events 1614, 1616, and 1618 are similar to the events 1514, 1516, and 1518 discussed above.

When, according to the signal strength or quality of at least one carrier frequency indicated 1618 in the measurement report message, the UE 102 is within the area of coverage of the SN 106A (e.g., the UE 102 meets a threshold for DC), the UE 102 can enable the MN 104A to initiate an SN addition procedure with the SN 106. In some implementations, the UE 102 sends 1618 the measurement report message to the SN 106A via the MN 104A using radio resources of the MN 104A or radio resources of the SN 106, such as an SRB (e.g., SRB3) so that the SN 106A can initiate adding back at least one carrier frequency of the SN 106A for communication with the SN 106. Accordingly, the SN 106A can configure the UE 102 to receive transmissions from the SN 106A on the at least one carrier frequency. The SN 106A can transmit 1615 an RRC message (e.g., RRC Reconfiguration message) to the UE 102 in response to the measurement report message to configure the UE 102 to receive transmissions from the SN 106A on the at least one carrier frequency. The UE 102 can transmit 1620 an RRC response message (e.g., RRC Reconfiguration Complete message) to the SN 106A in response.

In some implementations, if the UE 102 is configured by the SN 106A to use a DRB, such as an SCG type bearer or an SCG split type bearer, the RRC message can reconfigure the DRB to be an MCG type bearer. The UE 102 then can communicate data with the MN 104A using the DRB in response to the RRC message.

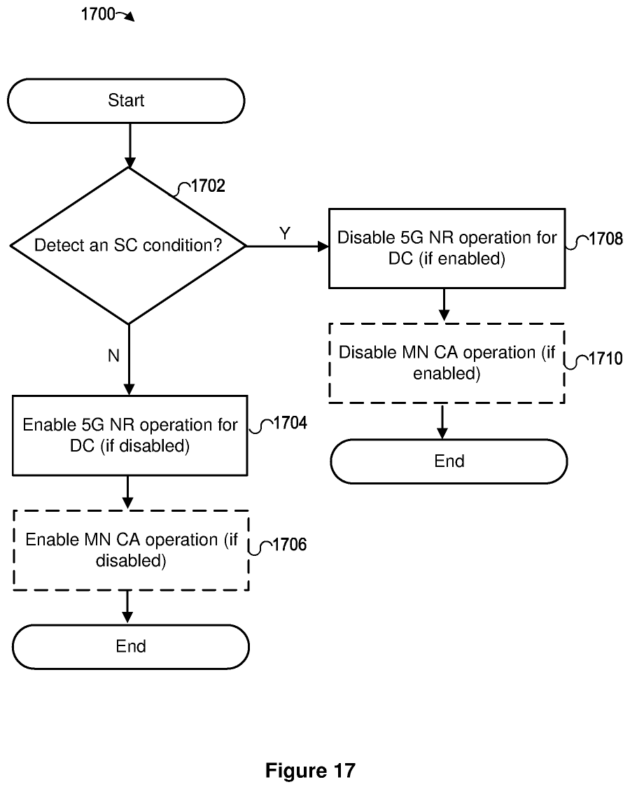

FIG. 17 depicts an example method 1300 for determining whether the UE 102 should disable 5G NR operation for DC and (optionally) CA capability in view of detecting a SC condition.

The method 1700 begins at block 1702, where the UE 102 determines whether a low-power condition of the battery 103 has occurred, similar to block 202 of FIG. 2. If the UE 102 does not detect a SC condition, the UE 102 at block 1704 enables 5G NR operation for DC when 5G NR operation previously was disabled. In another scenario, the UE 102 keeps 5G NR operation for DC enabled, when 5G NR operation is already enabled. Examples of an 5G NR operation include transmitting uplink transmissions (e.g., transmitting an uplink reference signal such as a sounding reference signal (SRS), transmissions on PUCCH, transmissions on PUSCH) over 5G NR to the SN 106, receiving downlink transmissions (e.g., receiving a reference signal, such as a channel state information reference signal (CSI-RS), and/or a synchronization signal block (SSB), transmissions on PDCCH, transmissions on PDSCH) over 5G NR from the SN 106, and/or measuring at least one 5G NR carrier frequency of the SN 106.

However, if the UE 102 detects a SC condition, the UE 102 at block 1708 disables 5G NR operation for DC, if 5G NR operation previously was enabled. For example, the UE 102 can stop receiving downlink transmissions over 5G NR from the SN 106, stop transmitting uplink transmissions over 5G NR to the SN 106, stop measuring at least one 5G NR carrier frequency, and/or keep measuring at least one 5G NR carrier frequency. In another scenario, when 5G NR operation is already disabled, the UE 102 keeps 5G NR operation for DC disabled. In an implementation, the UE 102 turns off or deactivates a 5G NR RF chip configured to communicate with the SN 106A implemented as a gNB to disable 5G NR operation for DC, thereby reducing power consumption. Blocks 1706 and 1710 are similar to blocks 206 and 210 discussed above.

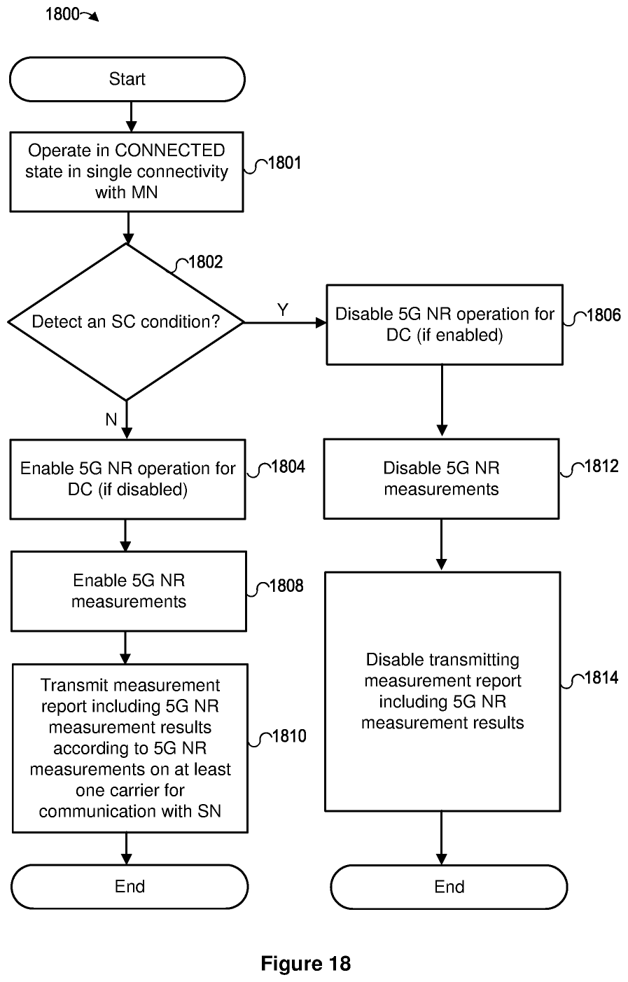

FIG. 18 depicts an example method 1800 for determining whether the UE 102 operating in a connected state of the RRC protocol should disable 5G NR operation for DC in view of detecting a SC condition.

The method 1800 begins at block 1801, where the UE 102 operates in a connected state so that the UE 102 can operate in SC with MN 104A on a carrier frequency of the MN 104. The UE 102 at block 1802 determines whether a low-power condition of the battery 103 has occurred, similar to block 1702 discussed above. Blocks 1804 and 1806 are also similar to blocks 1704 and 1708 discussed above.

In some implementations, in addition to enabling 5G NR operation for DC, the UE 102 at block 1808 enables 5G NR measurements. Then, the UE 102 at block 1810 transmits a measurement report message including 5G NR measurement results according to the 5G NR measurements on a carrier for communication with the SN 106A implemented as a gNB.

In some implementations, in addition to disabling 5G NR operation for DC, the UE 102 at block 1812 disables 5G NR measurements. Accordingly, the UE 102 at block 1814 disables transmitting a measurement report message including 5G NR measurement results to the MN 104. Accordingly, the UE 102 prevents the MN 104A from initiating an SN addition procedure with the SN 106A implemented as a gNB, while continuing to support SC between the UE 102 and the MN 104.

Although the method 1800 as illustrated in FIG. 14 completes after block 1810 or block 1814, in general the UE 102 can execute the method 1800 in an iterative manner, e.g., by “looping back” to block 1801 after executing block 1810 or block 1814.

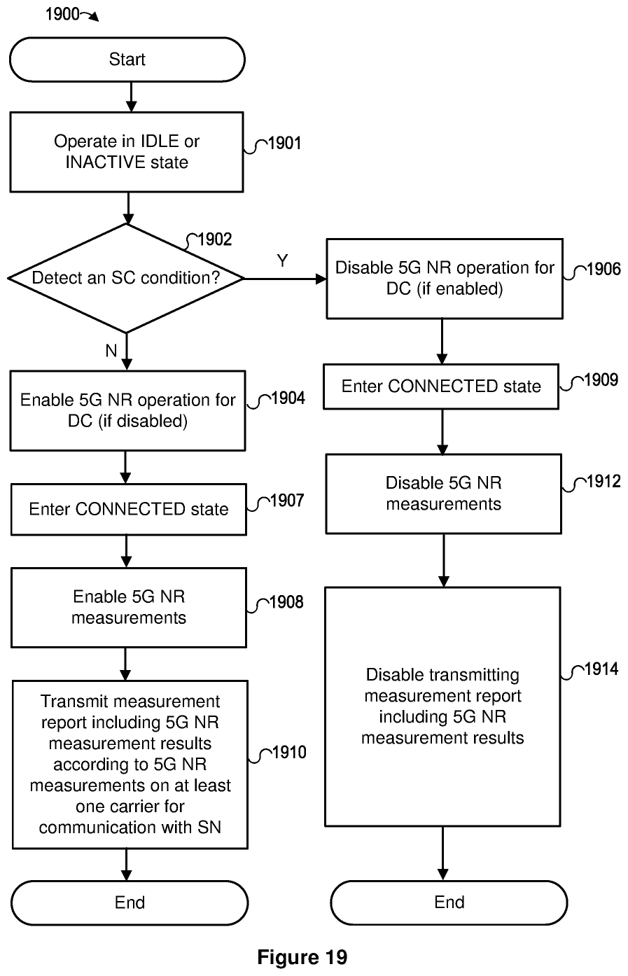

FIG. 19 depicts an example method 1590 for determining whether the UE 102 operating in an idle or inactive state of the RRC protocol should disable 5G NR operation for DC in view of detecting a SC condition.

As illustrated in FIG. 19, the UE 102 at block 1901 operates in an idle state or inactive state prior to detecting a low-power condition of a battery at block 1902. As such, the UE 102 may not yet be operating in a connected state, and therefore may not operate in SC with MN 104A on a carrier frequency of the MN 104. The UE 102 at block 1902 determines whether a SC condition 103 has occurred, similar to block 1802 discussed above. Blocks 1902, 1904, 1906, 1908, 1910, 1912, and 1914 are also similar to blocks 1802, 1804, 1806, 1808, 1810, 1812, and 1814 discussed above.

As illustrated, the UE 102 at blocks 1907 and 1909 is in a connected state after the UE 102 at block 1904 enables 5G NR operation for DC and at block 1906 disables 5G NR operation for DC, respectively.

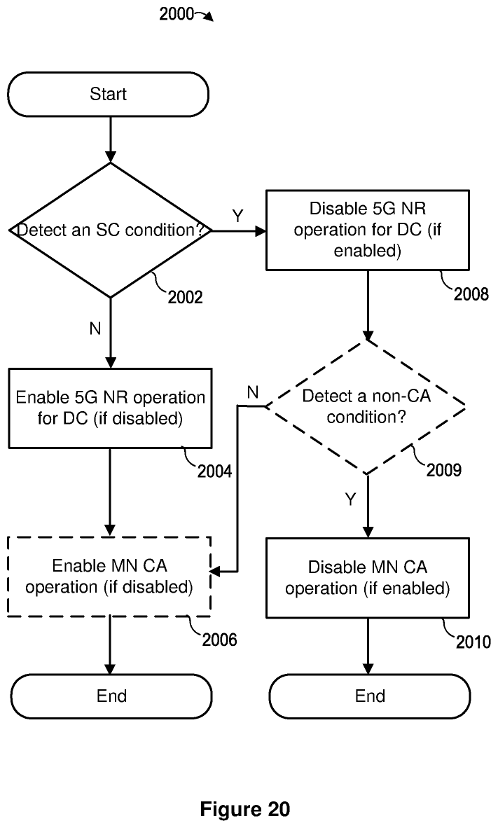

FIG. 20 depicts an example method 2000 for preventing the UE 102 from operating in DC in view of a SC condition.

The method 2000 begins at block 2002, where the UE 102 determines whether a SC condition (e.g., the remaining power level is below a first threshold level, a required data rate is below a first threshold rate or no application requiring DC is running) has occurred, similar to block 1702 discussed above. Blocks 2004, 2006, and 2008 are also similar to blocks 1704, 1706, and 1708 discussed above.

However, if the UE 102 at block 2009 detects a non-CA condition (e.g., the remaining power level is below a second threshold level that is lower than the first threshold level, the required data rate is below a second threshold rate that is lower than the first threshold rate, or no application requiring DC and no application requiring CA is running), the UE 102 at block 2010 disables MN CA capability, similar to block 1710 discussed above.

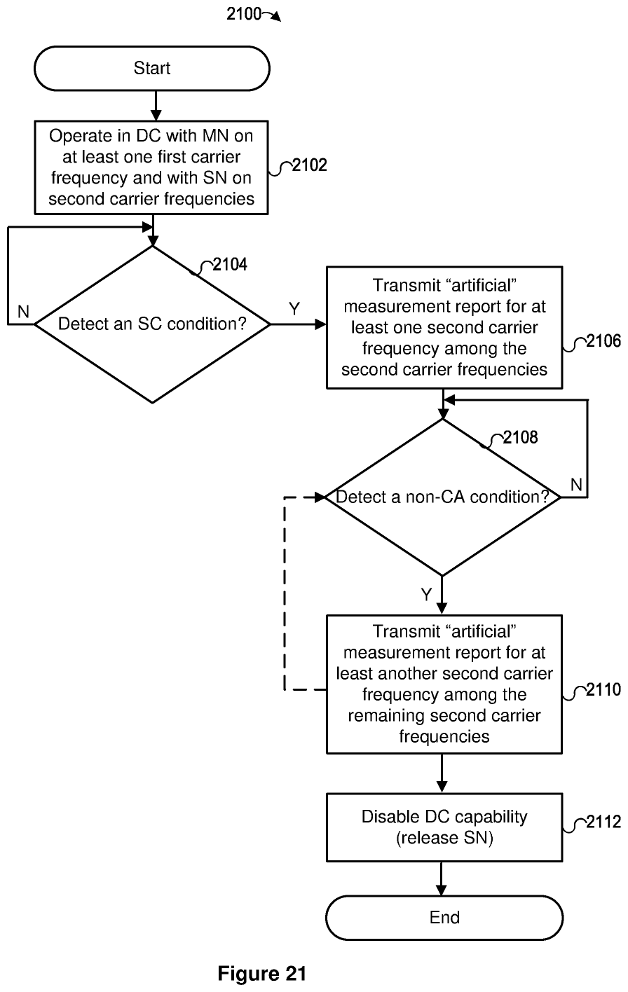

FIG. 21 depicts an example method 2100 in which the UE 102 releases one or more carrier frequencies of the SN 106A in view of detecting a SC condition.

The method 2100 begins at block 2102, where the UE 102 operates in DC with the MN 104A on at least one first carrier frequency of the MN 104A and the SN 106A on second carrier frequencies of the SN 106, similar to events 1502 and 1602 discussed above.

The UE 102 at block 2104 determines whether a SC condition (e.g., the remaining power level is below a first threshold level, a required data rate is below a first threshold rate or no application requiring DC is running) has occurred, similar to events 1504 and 1604 discussed above. If the UE 102 does not detect a SC condition, the UE 102 continues to determine whether a SC condition has occurred.

If the UE 102 detects a SC condition, the UE 102 at block 2106A transmits an “artificial” measurement report message to the MN 104A and/or the SN 106A that simulates to the MN 104A and/or the SN 106A low signal strength and/or low signal quality of at least one second carrier frequency of the SN 106, regardless of whether the signal strength and/or the signal quality are in fact low, similar to events 1507 and 1607 discussed above. Accordingly, the UE 102 suspends SCG transmission on the at least one second carrier frequency of the SN 106.

The UE 102 at block 2108 determines whether a SC condition has occurred, similar to events 1504 and 1604 discussed above. The low-power condition can be the same SC condition (e.g., the remaining power level is below a first threshold level, a required data rate is below a first threshold rate or no application requiring DC is running) as in block 2104 or a non-CA condition (e.g., the remaining power level is below a second threshold level that is lower than the first threshold level, the required data rate is below a second threshold rate that is lower than the first threshold rate, or no application requiring DC and no application requiring CA is running). If the UE 102 does not detect a SC condition, the UE 102 continues to determine whether a SC condition has occurred.

If the UE 102 detects a SC condition, the UE 102 at block 2110 transmits another “artificial” measurement report message to the MN 104A and/or the SN 106A that simulates to the MN 104A and/or the SN 106A low signal strength and/or low signal quality of at least another second carrier frequency of the SN 106A among the remaining second carrier frequencies, regardless of whether the signal strength and/or the signal quality are in fact low, similar to events 1507 and 1607 discussed above.

In some implementations, if the UE 102 continues to detect a SC condition at block 2110, the UE 102 can transmit yet another “artificial” measurement report message (i.e., a third “artificial” measurement report message) to the MN 104A and/or the SN 106A that simulate to the MN 104A and/or the SN 106A low signal strength and/or low signal quality of the remaining second carrier frequencies, regardless of whether the signal strength and/or the signal quality are in fact low. In some implementations, if the UE 102 continues to detect a SC condition at block 2110, the UE 102 can iteratively transmit the third “artificial” measurement report message to the MN 104A and/or the SN 106A to indicate low signal strength and/or low signal quality of the remaining second carrier frequencies one-by-one until the UE 102 accounts for all remaining second carrier frequencies.

Block 2112 is similar to events 1506 and 1606 and block 1708 discussed above. In an implementation, the UE 102 can stop measuring some or all of the 5G NR carrier frequencies configured by a measurement configuration received from the MN 104A or the SN 106. Accordingly, the UE 102 can consume less power (even no power) by disabling DC operation (e.g., by turning off or deactivating one of the chips that supports the RAT of the SN 106). Further, the UE 102 can reduce (or prevent) heat generation from the chip supporting the RAT of the SN 106.

Although the method 2100 as illustrated in FIG. 21 completes after block 2110, in general the UE 102 can execute the method 2100 in an iterative manner, e.g., by “looping back” to block 2102 after executing block 2110.

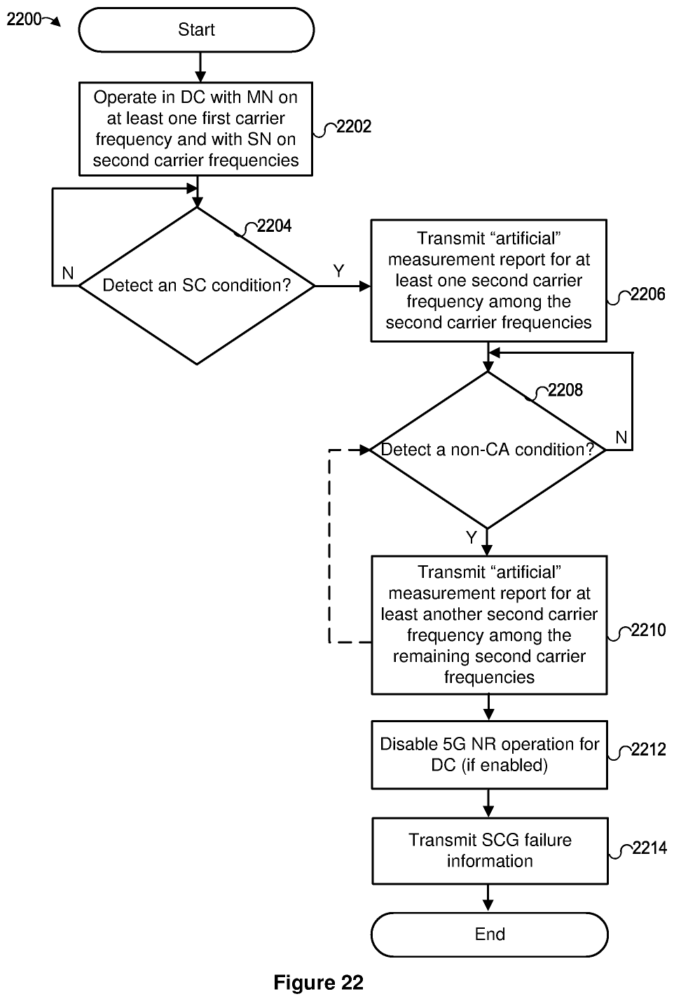

FIG. 22 depicts an example method 2200 in which the UE 102 prevents the MN 104A from initiating an SN addition procedure in view of an “artificial” measurement report and indication of SCG failure.

The method 2200 begins at block 2202, where the UE 102 operates in DC with the MN 104A on at least one first carrier frequency of the MN 104A and the SN 106A on at least one second carrier frequency of the SN 106, similar to block 2102 discussed above.

Blocks 2204, 2206, 2208, 2210, and 2212 are similar to blocks 2104, 2106, 2108, 2210, and 2212 discussed above.

The UE 102 at block 2214 generates an indication of SCG failure (e.g., an SCG failure message) or an indication of MCG failure (e.g., an RRC reestablishment request message) to notify the MN 104A that the UE 102 will no longer be using DC, similar to events 1307 and 1407, respectively.

Although the method 2200 as illustrated in FIG. 22 completes after block 2212, in general the UE 102 can execute the method 2200 in an iterative manner, e.g., by “looping back” to block 2202 after executing block 2212.

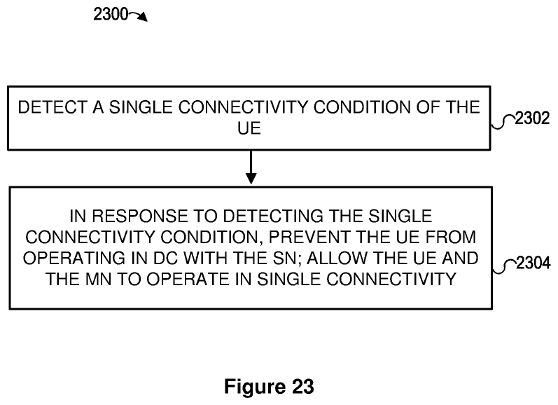

FIG. 23 depicts an example method 2300 for preventing the UE 102 from operating in DC in view of a SC condition.

The method 2300 begins at block 2302, where the UE 102 detects a low-power condition of a battery 103 (blocks or events 202, 302, 406, 506, 606, 702, 802, 902, 1002, 1104, 1204, 1304, 1404, 1504, 1604, 1702, 1802, 1902, 2002, 2104, and 2204 of FIGS. 2-22). In response to detecting the SC condition, the UE 102 at block 2304 prevents the UE 102 from operating in DC with the SN 106, so that the UE 102 and the MN 104A can operate only in SC. Particularly, the UE 102 at block 2304 prevents the UE 102 from operating in DC with the SN 106A by disabling DC capability, as described in blocks or events 208, 308, 408, 508, 608, 609, 708, 808, 908, 1008, 1106, 1206, 1207, 1306, 1406, 1506, 1606, 1708, 1806, 1906, 2008, 2112, and 2212 of FIGS. 2-22. In some implementations, the UE 102 at block 2304 prevents the UE 102 from operating in DC with the SN 106A by also disabling MN CA capability, as described in blocks or events 210, 310, 710, 810, 910, 1010, 1710, and 2010 of FIGS. 2-3, 8-10, 17, and 20.

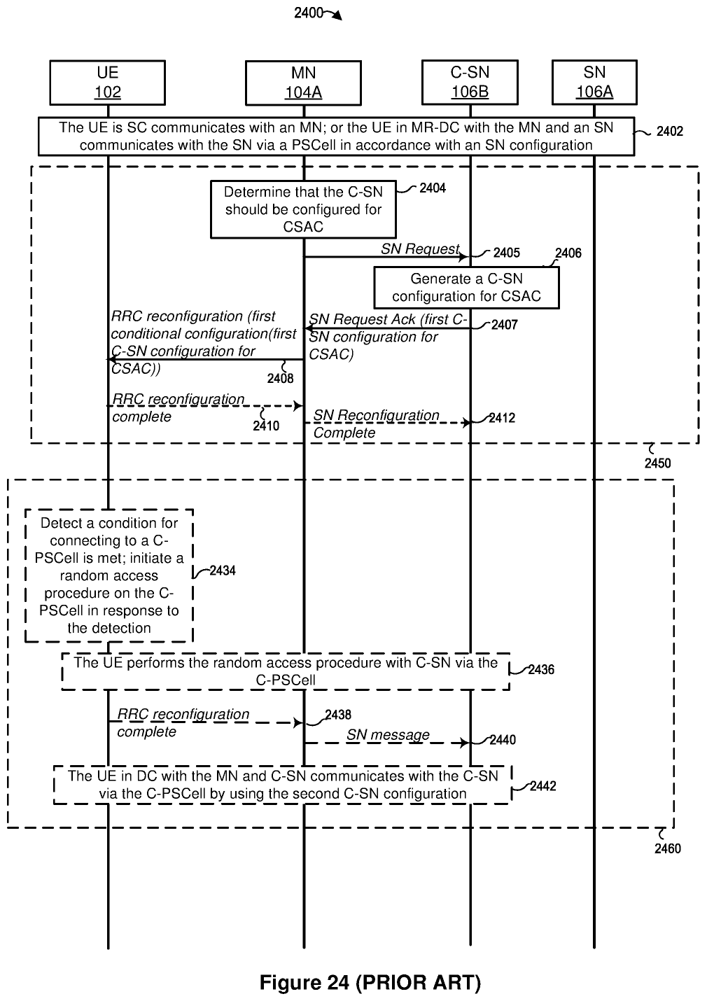

Several scenarios that involve conditional configuration related DC are discussed next with reference to FIGS. 24-35.

For clarity, FIG. 24 first illustrates a known scenario 2400 the base station 104A operates as an MN, the base station 106A operates as an SN, and the base station 106B operates as a C-SN. At the beginning of this scenario, the UE 102 operates 2402 in DC with the MN 104A and SN 106A and communicates UL PDUs and/or DL PDUs with MN 104A via a PCell, and communicates UL PDUs and/or DL PDUs with the SN 106A via a PSCell (i.e., a cell other than cell 126A). In some implementations, the scenario 500A may begin with the UE 102 operating 2402 in SC with the MN 104A.

The MN 104A determines 2404 that it should configure the base station 106B as a C-SN for CSAC, such that the SN for the UE 102 will change from the SN 106B to the C-SN 106B. The MN 104A can make this determination based on measurement result(s) from the UE 102, for example, or in response to an indication that the SN 106A requires a conditional SN change (e.g., SN Change Required message), which the SN 106A can send to the MN 104A. In some implementations, the MN 104A can derive or estimate that the UE 102 is moving toward coverage of the base station 106B according to uplink signals received from the UE 102 or positioning measurement result(s) received from the UE 102. In response to the determination, the MN 104A sends 2405 an SN Request message to the C-SN 106B for the CSAC. In response to receiving 2405 the SN Request message, the C-SN 106B determines 2406 that it should generate a C-SN configuration for CSAC, for the UE 102. The C-SN 106B transmits 2407 an SN Request Acknowledge message including the C-SN configuration for the CSAC to the MN 104A. The C-SN configuration can include a configuration for a C-PSCell and for zero, one, or more C-SCells. In some implementations, the MN 104A may include the C-SN configuration message in an RRC container message. The MN 104A then includes the C-SN configuration for CSAC or the RRC container message in a conditional configuration field/IE and transmits 2408 an RRC reconfiguration message including the conditional configuration field/IE to the UE 102. In some implementations, the UE 102 transmits 2410 an RRC reconfiguration complete message to the MN 104A in response to the RRC reconfiguration message. The MN 104A can transmit 2412 an SN message (e.g., SN Reconfiguration Complete message or SN Change Confirm message) to the C-SN 106B in response to the RRC reconfiguration complete message. Events 2404-2412 collectively define a CSAC configuration procedure 2450.

In some implementations, the C-SN 106B includes a radio bearer configuration for the conditional configuration in the SN Request Acknowledge message in event 2407, and in turn the MN 104A may include the radio bearer configuration in the RRC reconfiguration message in event 2408. The MN 104A may include the radio bearer configuration at the level of the RRC reconfiguration message, at the level of the conditional configuration element or at the level of the RRC container message described above.

When transmitting 2408 the RRC reconfiguration to the UE 102, the MN 104A can specify a condition that must be satisfied before the UE 102 applies the C-SN configuration for CSAC. Alternatively, the SN 106A can specify, in the indication that the SN 106A requires a conditional SN change, that a condition that must be satisfied before the UE 102 applies the C-SN configuration for CSAC. The MN 104A can include a configuration of this condition at the level of the RRC reconfiguration message, at the level of the conditional configuration element, or at the level of the C-SN configuration for CSAC. In the conditional configuration element in the RRC reconfiguration message of the 2404, the MN 104A for example can include a configuration ID to identify the C-SN configuration for CSAC.

In some implementations, the SN Request message is an SN Addition Request message, and the SN Request Acknowledge message is an SN Addition Request Acknowledge message. In other implementations, the SN Request message is an SN Modification Request message, and the SN Request Acknowledge message is an SN Modification Request Acknowledge message. In some implementations, the MN 104A indicates to the base station 106B, in the SN Request message, that the MN 104A requests that the base station 106A operate as a C-SN for the UE 102. The UE 102 can determine that the conditional configuration includes the C-SN configuration and apply the C-SN configuration for the CSAC to communicate with the C-SN 106B.

Optionally, the UE 102 detects 2434 that a condition (or conditions) for connecting to the C-PSCell 126B is satisfied, and initiates 2434 a random access procedure on the C-PSCell 126B in response to the detection. For convenience, this discussion may refer to the condition or a configuration in singular, but it will be understood that there may be multiple conditions, and that the conditional configuration can include one or multiple configuration parameters. In any case, the UE 102 performs 2436 the random access procedure with the C-SN 106B via the C-PSCell 126B using a random access configuration included in the C-SN configuration. The UE 102 (if the UE 102 is operating in DC) may disconnect from the SN 106A (i.e., the PSCell and all of SCell(s) of the SN 106A if configured) in response to the event 2434 or 2436. The UE 102 may transmit 2438 an RRC reconfiguration complete message to the MN 104A in response to the event 554 or 536. The UE 102 may transmit 2438 the RRC reconfiguration complete message before or after the event 536 or while the UE 102 performs 2436 the random access procedure. In turn, the MN 104A sends 2440 an SN message (e.g., an existing SN message such as a SN Reconfiguration Complete message or a newly defined SN message) to the C-SN 106B in response to the RRC reconfiguration complete message. The MN 104A may or may not include the RRC reconfiguration complete message in the SN message. The newly defined SN message can be specifically designed for the MN 104A to send the RRC reconfiguration complete message to the C-SN 106B or to notify the UE 102 applies the C-SN configuration.

In some implementations, the random access procedure can be a four-step random access procedure or a two-step random access procedure. In other implementations, the random access procedure can be a contention-based random access procedure or a contention-free random access procedure. After the UE 102 successfully completes 2436 the random access procedure, the C-SN 106B begins to operate as the SN 106B, and the UE 102 begins to operate 2442 in DC with the MN 104A and the SN 106B. In particular, the UE 102 communicates 2442 with the SN 106B via the C-PSCell 126B (i.e., new PSCell 126B) in accordance with the C-SN configuration for the CSAC.

In some implementations, the C-SN 106B identifies the UE 102 if the C-SN 106B finds an identity of the UE 102 in a medium access control (MAC) protocol data unit (PDU) received from the UE 102 in the random access procedure (event 2436). The C-SN 106B includes the identity of the UE 102 in the C-SN configuration. In other implementations, the C-SN 106B identifies the UE 102 if the C-SN 106B receives a dedicated random access preamble from the UE 102 in the random access procedure. The C-SN 106B includes the dedicated random access preamble in the C-SN configuration.

The SN configuration can include multiple configuration parameters for the UE 102 to communicate with the SN 106A via the PSCell 126A and zero, one, or more secondary cells (SCells) of the SN 106A. The multiple configuration parameters may configure radio resources for the UE 102 to communicate with the SN 106A via the PSCell 126A and zero, one, or more SCells of the SN 106A. The multiple configuration parameters may configure zero, one, or more radio bearers. The one or more radio bearers can include an SRB and/or DRBs.

In some implementations, the C-SN 106B specifies the one or more conditions in the C-SN configuration for CSAC. In other implementations, the MN 104A includes the C-SN configuration along with the one or more conditions in a conditional configuration element or in the RRC reconfiguration message 2408. The MN 104A may generate the conditional configuration for the UE 102A or receive 2407 the conditional configuration from the C-SN 106B.

In some implementations, the C-SN configuration includes a group configuration (CellGroupConfig) IE that configures the C-PSCell 126B and zero, one, or more C-SCells of the C-SN 106B. In one implementation, the C-SN configuration can be an RRCReconfiguration message, RRCReconfiguration-IEs or the CellGroupConfig IE conforming to 3GPP TS 38.331. In other implementations, the C-SN configuration includes an SCG-ConfigPartSCG-r12 IE that configures the C-PSCell and may configure zero, one, or more C-SCells of the C-SN 106B. In one implementation, the C-SN configuration is an RRCConnectionReconfiguration message, RRCConnectionReconfiguration-IEs or the ConfigPartSCG-r12 IE conforming to 3GPP TS 36.331.

In some implementations, the SN configuration includes a CellGroupConfig IE that configures the PSCell and may zero, one, or more SCells of the SN 106A. In one implementation, the SN configuration can be an RRCReconfiguration message, RRCReconfiguration-IEs or the CellGroupConfig IE conforming to 3GPP TS 38.331. In other implementations, the SN configuration can include an SCG-ConfigPartSCG-r12 IE that configures the PSCell and may configure zero, one, or more SCells of the SN 106A. In one implementation, the SN configuration can be an RRCConnectionReconfiguration message, RRCConnectionReconfiguration-IEs or the ConfigPartSCG-r12 IE conforming to 3GPP TS 36.331.

In some cases, the UE 102 receives 2408 one or more conditions in the conditional configuration or in the RRC reconfiguration message. The UE 102 can use the one or more conditions to determine whether to connect to the C-PSCell 126B. If the UE 102 detects that the condition is satisfied, the UE 102 connects to the C-PSCell 126B. That is, the condition (also referred to as the triggering condition) triggers the UE 102 to connect to the C-PSCell 126B or to execute the C-SN configuration. If the UE 102 does not detect that the condition is satisfied, the UE 102 does not connect to the C-PSCell 126B. Events 2434-2442 collectively define a CSAC operation 2460.

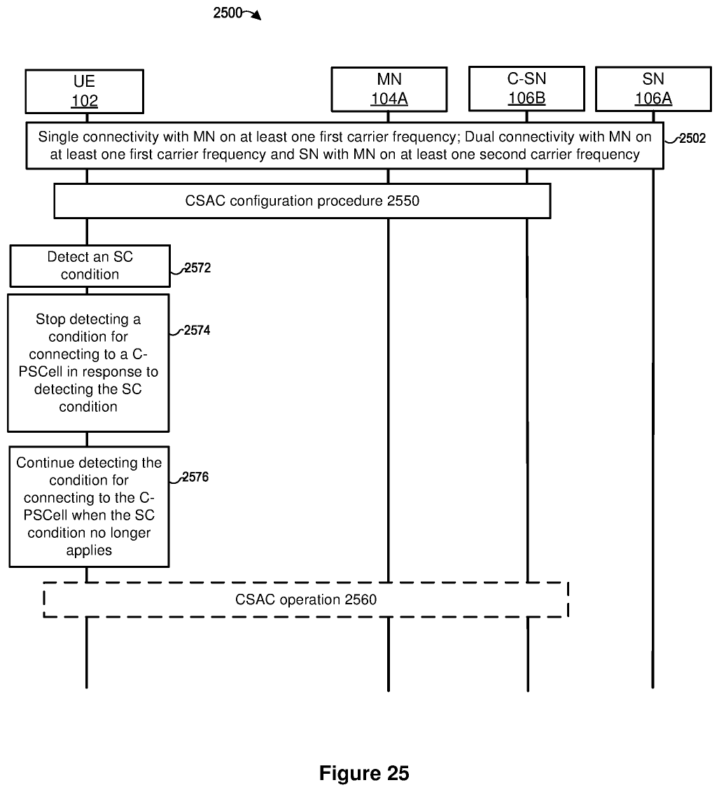

Now referring to FIG. 25, the UE 102 in a scenario 2500 detects an SC condition and stops monitoring the network-specified condition for a CSAC procedure. In particular, this scenario begins with the UE 102 operating 2502 in SC with the MN 104A or in DC with the MN 104A and SN 106A, similar to event 2402 discussed above with reference to FIG. 24. The UE 102, the MN 104A, and the C-SN 106B then perform a CSAC configuration procedure 2550, similar to procedure 2450.

The UE 102 at some point detects 2572 the SC condition. As discussed above, the SC condition is not network-specified (in this case, not specified by the RAN 105) but rather originates at the UE 102. The SC condition can be any of the remaining power level being below a certain threshold level, the required data rate being below a certain threshold rat, no application requiring DC currently running, the strength or quality of the carrier signal at the SN being below a certain threshold level, etc., or any combination of two or more of these conditions.

In response to the event 2572, the UE 102 stops 2574 detecting the one or more conditions for applying the configuration associated with the CSAC procedure. The UE 102 thus inhibits application of this configuration. When, a later time, the UE 102 determines 2576 that the SC condition no longer applies, the UE 102 can again begin attempting to detect the condition(s) of the CSAC procedure. If the UE 102 detects this condition, the UE 102, the MN 104A, and the C-SN 106B carry out the CSAC operation 2560, which is similar to the CSAC operation 2460 discussed above. In some implementations, the UE 102 disables DC as described above to stop 2574 detecting the condition(s) of the CSAC procedure. In some implementations, the UE 102 enables DC as described above to continue 2576 detecting the condition(s) of the CSAC procedure.

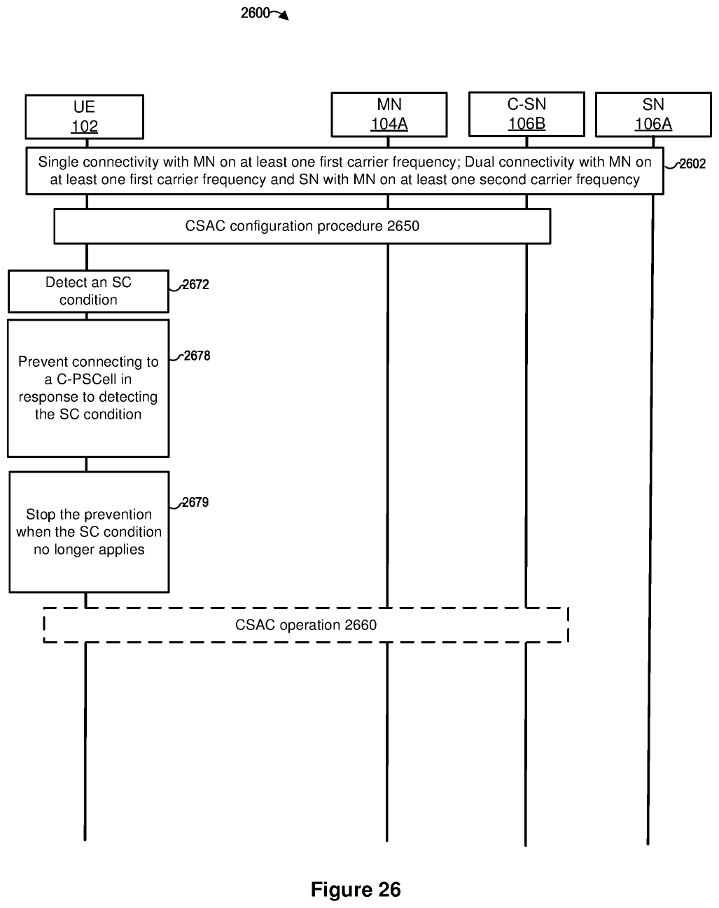

In FIG. 26, a scenario 2600 also involves CSAC and an SC condition. Events 2602, 2604, and 2672 are similar to events 2502, 2550, 2572 respectively. However, the UE 102 in this case inhibits 2678 application of the conditional configuration by directly preventing the UE 102 from connecting to the C-PSCell, in response to detecting the SC condition. Thus, the UE 102 can test the condition for CSAC and determine that this condition is satisfied, but the UE 102 will not carry out the CSAC procedure because of the SC condition. When, a later time, the UE 102 determines 2679 that the SC condition no longer applies, the UE 102 no longer prevents the UE 102 from connecting to the C-PSCell. If the UE 102 determines that the condition for CSAC, the UE 102, the MN 104A, and the C-SN 106B carry out the CSAC operation 2660, which is similar to the CSAC operation 2460 discussed above.

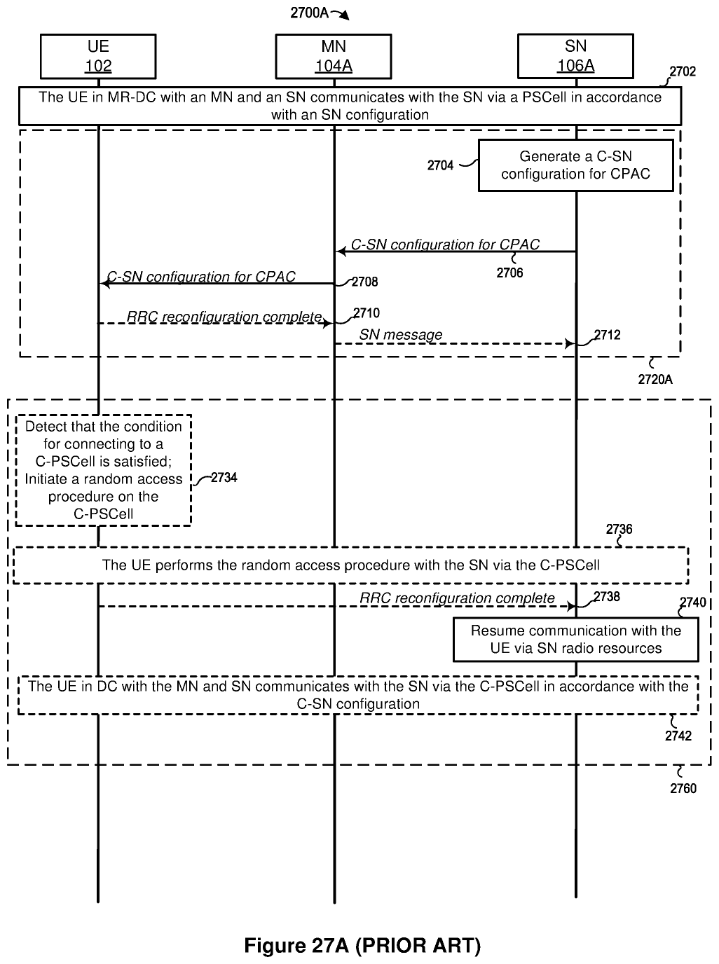

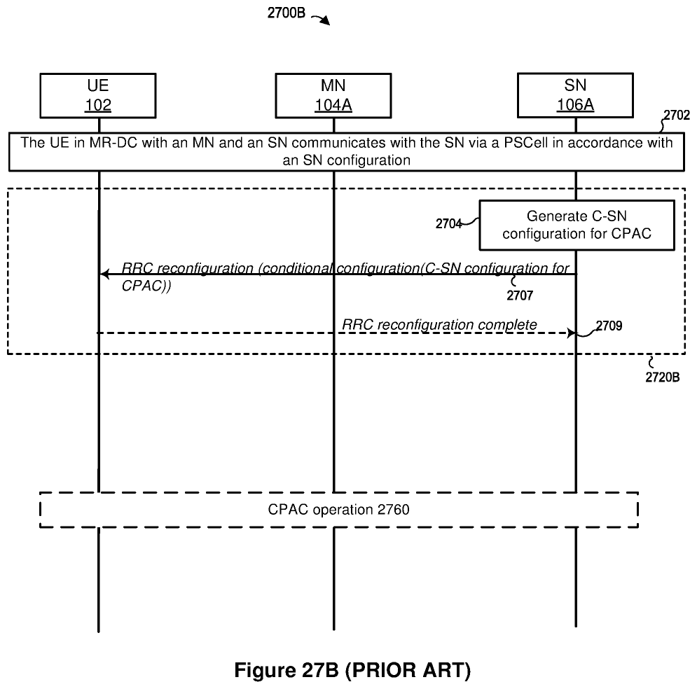

Next, FIGS. 27A and 27B for clarity illustrate known techniques for configuring and performing a CPAC procedure.

Referring first to FIG. 27A, the base station 104A in a scenario 2700A operates as an MN, and the base station 106A operates as an SN. Initially, the UE 102 is in MR-DC with the MN 104A and the SN 106A. The UE 102 communicates 2702 UL PDUs and/or DL PDUs with the SN 106A via a PSCell in accordance with a certain SN configuration. The SN 106A then determines 2704 that it should generate a C-SN configuration for conditional PSCell addition or change (CPAC). The SN 106A can make this determination based on one or more measurement results received from the UE 102 via the MN 104A, from the UE directly (e.g., via a signaling radio bearer (SRB) established between the UE 102 and the SN 106A or via a physical control channel), or obtained by the SN 106A from measurements on signals, control channels or data channels received from the UE 102, for example. More intelligently, the SN 106A can derive or estimate the UE 102 is moving toward coverage of the cell 126A according to uplink signals received from the UE 102 or positioning measurement result(s) received from the UE 102. In response to this determination, the SN 106A generates 2706 a C-SN configuration.

In the example scenario 2700A, the MN 104A then transmits 2706 the C-SN configuration to the MN 104A. The MN 104A in turn transmits 2708 the C-SN configuration to the UE 102. In some implementations, the SN 106A at event 2704 generates a conditional configuration including the C-SN configuration and generates an RRC reconfiguration message including the conditional configuration. The MN 104A then transmits 2706 the RRC reconfiguration message to the MN 104A. The MN 104A in turn transmits 2708 the RRC reconfiguration message including the conditional configuration to the UE 102. In other implementations, the MN 104A generates a conditional configuration including the C-SN configuration and generates an RRC reconfiguration message including the conditional configuration. The MN 104A transmits 2708 the RRC reconfiguration message including the conditional configuration to the UE 102.

In some implementations, the UE 102 transmits 2710 an RRC reconfiguration complete message to the MN 104A in response to the RRC reconfiguration message described above. The MN 104A may transmit 2712 an SN message (e.g., SN Reconfiguration Complete message) to the SN 106A in response to the RRC reconfiguration complete message. The events 2704-2712 collectively can define a CPAC configuration procedure 2720A.

To transmit the RRC reconfiguration message, the MN 104A in one implementation transmits an RRC container message including the RRC reconfiguration to the UE 102. In response, the UE 102 in one implementation transmits an RRC container response message including the RRC reconfiguration complete message to the MN 104A to transmit 2710 the RRC reconfiguration complete message. The MN 104A may send 2712 the SN message to the SN 106A in response to the RRC container response message. In turn, the MN 104A may include the RRC reconfiguration complete message in the SN message that the MN 104A transmits 2712. In another implementation, the UE 102 does not generate an RRC container response message to wrap the RRC reconfiguration complete message the UE transmits 2710.

When the SN 106A is implemented as an ng-eNB, the RRC reconfiguration message generated by the SN 106A is an RRCConnectionReconfiguration message, and the RRC reconfiguration complete message the MN 104A receives 2710 is RRCConnectionReconfigurationComplete. When the SN 106A is implemented as a gNB, the RRC reconfiguration message generated by the SN 106A is an RRCReconfiguration message, and the RRC reconfiguration complete message the MN 104A receives 2710 is an RRCReconfigurationComplete message. When the MN 104A is implemented as an eNB or ng-eNB, the RRC container message is an RRCConnectionReconfiguration message, and the RRC container response message is RRCConnectionReconfigurationComplete. When the MN 104A is implemented as a gNB, the RRC container message is an RRCReconfiguration message, and the RRC container response message is an RRCReconfigurationComplete message.

When the MN 104A is implemented as an eNB or ng-eNB, the RRC reconfiguration message generated by the MN 104A is an RRCConnectionReconfiguration message, and the RRC reconfiguration complete message is RRCConnectionReconfigurationComplete. When the MN 104A is implemented as a gNB, the RRC reconfiguration message generated by the MN 104A is an RRCReconfiguration message, and the RRC reconfiguration complete message is an RRCReconfiguration Complete message.

Optionally, the UE 102 can detect 2734 that the condition for connecting to a C-PSCell 126A is satisfied and initiate a random access procure on the C-PSCell 126A in response to the detection. For convenience, this discussion may refer to the condition or a configuration in singular, but it will be understood that there may be multiple conditions, and that the conditional configuration can include one or multiple configuration parameters to specify the condition or the multiple conditions. The UE 102 then performs 2736 the random access procedure with the SN 106A via the C-PSCell 126A, e.g., using one or more random access configurations in the C-SN configuration. The UE 102 may transmit 2738 an RRC reconfiguration complete message via the C-PSCell 126A (e.g., on SRB3) during or after the random access configuration to connect to the C-PSCell 126A. Alternatively, the UE 102 can transmit 2738 the RRC reconfiguration complete message to the SN 106A via the MN 104A. In this case, the UE 102 can transmit 1738 an RRC container message (e.g., a ULInformationTransferMRDC message or a newly defined RRC message) including the RRC reconfiguration complete message to the MN 104A (e.g., on SRB1) and in turn, the MN 104A transmits the RRC reconfiguration message to the SN 106A in a SN message (e.g., RRC Transfer message, a SN Reconfiguration Complete message or a newly defined SN message). The newly defined RRC message can be specifically designed for the UE 102 to transmit the RRC reconfiguration complete message in response to connecting to the C-PSCell 126A. The MN 104A can forward the RRC reconfiguration complete message to the SN 106A if the MN 104A receives the newly defined RRC message. The newly defined SN message can be specifically designed for the MN 104A to send the RRC reconfiguration complete message to the SN 106A. The SN 106A can determine the UE 102 connects to the C-PSCell 126A if the SN 106A receives the RRC reconfiguration message via the newly defined SN message. Yet alternatively, the UE 102 does not transmit 338 the RRC reconfiguration message to the SN 106A. If the SN 106A identifies the UE 102 in the random access procedure, the SN 106A resumes 340 communication with the UE 102 via SN radio resources. If the UE 102 successfully completes the random access procedure, the UE 102 communicates 2742 with the SN 106A via the C-PSCell 126A in accordance with configurations in the C-SN configuration.

In some implementations, the random access procedure can be a four-step random access procedure or a two-step random access procedure. In other implementations, the random access procedure can be a contention-based random access procedure or a contention-free random access procedure. In some implementations, the UE 102 includes the RRC reconfiguration complete message in a message 3 of the four-step random access procedure or in a message A of the two-step random access procedure.

In some implementations, the SN 106A includes a trigger condition configuration that configures the condition that the UE 102 detects 2734 in the conditional configuration generated by the SN 106A. The SN 106A may include a configuration ID identifying the conditional configuration or the C-SN configuration in the conditional configuration. In other implementations, the SN 106A can send the trigger condition configuration at event 2706 and in turn, the MN 104A can include the trigger condition configuration in the conditional configuration generated by the MN 104A. To simplify the description below, a CPAC configuration is used to represent the C-SN configuration and the trigger condition configuration, conditional configuration or the RRC reconfiguration message generated by the SN 106A described above.

With continued reference to FIG. 27A, the C-SN configuration in some implementations can be a complete and self-contained configuration (i.e. a full configuration). The C-SN configuration may include a full configuration indication (an information element (IE) or a field) that identifies the C-SN configuration as a full configuration. The UE 102 in this case can use the C-SN configuration to communicate with the SN 106A without relying on an SN configuration. On the other hand, the C-SN configuration in other cases can include a “delta” configuration, or one or more configurations that augment a previously received SN configuration. In these cases, the UE 102 can use the delta C-SN configuration together with the SN configuration to communicate with the SN 106A.

The C-SN configuration can include multiple configuration parameters for the UE 102 to apply when communicating with the SN 106A via a C-PSCell 126A. The multiple configuration parameters may configure the C-PSCell 126A and zero, one, or more candidate secondary cells (C-SCells) of the SN 106A to the UE 102. The multiple configuration parameters may configure radio resources for the UE 102 to communicate with the SN 106A via the C-PSCell 126A and zero, one, or more C-SCells of the SN 106A. The multiple configuration parameters may configure zero, one, or more radio bearers. The one or more radio bearers can include an SRB and/or one or more DRBs.

The SN configuration can include multiple configuration parameters for the UE 102 to communicate with the SN 106A via the PSCell and zero, one, or more secondary cells (SCells) of the SN 106A. The multiple configuration parameters may configure radio resources for the UE 102 to communicate with the SN 106A via the PSCell and zero, one, or more SCells of the SN 106A. The multiple configuration parameters may configure zero, one, or more radio bearers. The one or more radio bearers can include an SRB and/or one or more DRBs.

In some implementations, the SN 106A can include the CPAC configuration in an SN Modification Acknowledge message responding to an SN Modification Request message received from the MN 104A and send the SN Modification Request Acknowledge message to the MN 104A during the event 2706. In other implementations, the SN 106A can include the CPAC configuration in an SN Modification Required message and send the SN Modification Required message to the MN 104A during the event 2706. The SN 106A may indicate that the SN Modification Request Acknowledge message or the SN Modification Required message is for CPAC, so that the MN 104A can determine that the SN Modification Request Acknowledge message or the SN Modification Required message includes a conditional configuration for CPAC. In other implementations, the SN 106A does not indicate CPAC in the SN Modification Request Acknowledge message or the SN Modification Required message. In these implementations, the CPAC configuration from the SN 106A is transparent to the MN 104A, so the MN 104A simply tunnels the CPAC configuration through to the UE 102, without processing the CPAC configuration.

In some implementations, the C-SN configuration can include a group configuration (CellGroupConfig) IE that configures the C-PSCell 126A and zero, one, or more C-SCells of the SN 106A. In one implementation, the C-SN configuration includes a radio bearer configuration. In another implementation, the C-SN configuration does not include a radio bearer configuration. For example, the radio bearer configuration can be a RadioBearerConfig IE, DRB-ToAddModList IE or SRB-ToAddModList IE, DRB-ToAddMod IE or SRB-ToAddMod IE. In various implementations, the C-SN configuration can be an RRCReconfiguration message, RRCReconfiguration-IEs, or the CellGroupConfig IE conforming to 3GPP TS 38.331. The full configuration indication may be a field or an IE conforming to 3GPP TS 38.331. In other implementations, the C-SN configuration can include an SCG-ConfigPartSCG-r12 IE that configures the C-PSCell 126A and zero, one, or more C-SCells of the SN 106A. In some implementations, the C-SN configuration is an RRCConnectionReconfiguration message, RRCConnectionReconfiguration-IEs, or the ConfigPartSCG-r12 IE conforming to 3GPP TS 36.331. The full configuration indication may be a field or an IE conforming to 3GPP TS 36.331.

In some implementations, the SN configuration can include a CellGroupConfig IE that configures the PSCell and may configure zero, one, or more SCells of the SN 106A. In one implementation, the SN configuration can be an RRCReconfiguration message, RRCReconfiguration-IEs or the CellGroupConfig IE conforming to 3GPP TS 38.331. In other implementations, the SN configuration can include an SCG-ConfigPartSCG-r12 IE that configures the PSCell and may configure zero, one, or more SCells of the SN 106A. In one implementation, the SN configuration can be an RRCConnectionReconfiguration message, RRCConnectionReconfiguration-IEs or the ConfigPartSCG-r12 IE conforming to 3GPP TS 36.331.

In some cases, the UE 102 may receive one or more conditions (discussed in this disclosure in singular for convenience) in the trigger condition configuration during the event 2708. The UE 102 may use the one or more conditions to determine whether to connect to the C-PSCell 126A. If the UE 102 detects 334 that the condition is satisfied, the UE 102 connects to the C-PSCell 126A. That is, the condition (or “triggering condition”) triggers the UE 102 to connect to the C-PSCell 126A or to execute the C-SN configuration. However, if the UE 102 does not detect that the condition is satisfied, the UE 102 does not connect to the C-PSCell 126A.

Now referring to FIG. 27B, a scenario 2700B involves a CPAC without SN change, i.e., a conditional change of a PSCell of an SN when the UE is already in DC with the MN and SN. In this scenario, the base station 104A operates as an MN and the base station 106A operates as an SN. Events in this scenario similar to those discussed above are labeled with the same reference numbers. The differences between the scenarios of FIGS. 27A and 27B are discussed below.

The CPAC configuration procedure 2720B is generally similar to the CPAC configuration procedure 320A of FIG. 27A. However, in the scenario 2700B the SN 106A directly transmits 2707 the RRC reconfiguration message including the conditional configuration to the UE 102, rather than transmitting the RRC reconfiguration message to the UE 102 via the MN 104A, as the SN 106A does in the scenario 2700A of FIG. 3A. In some implementations, the SN 106A configures a first SRB to the UE 102 via the MN 104A and transmits the RRC reconfiguration message via the first SRB to the UE 102. For example, the SN 106A transmits an SRB configuration configuring the first SRB (e.g., SRB3) to the MN 104A, and the MN 104A transmits the SRB configuration to the UE via a second SRB (e.g., SRB1) between the MN 104A and the UE 102. In some implementations, the UE 102 can transmit 2709 an RRC reconfiguration complete message via the first SRB to the SN 106A in response to the RRC reconfiguration message, rather than transmitting 2710 the RRC reconfiguration complete message to the MN 104A as in the scenario 2700A. In some implementations, the UE 102 can transmit 2738 the RRC reconfiguration message via the first SRB to the SN 106A.

When the SN 106A is implemented as an ng-eNB, the RRC reconfiguration message the SN 106A transmits 2707 is an RRCConnectionReconfiguration message, and the RRC reconfiguration complete message SN 106A receives 2709 an RRCConnectionReconfiguration Complete message. When the SN 106A is an gNB, the RRC reconfiguration message the SN 106A transmits 2707 is an RRCReconfiguration message, and the RRC reconfiguration complete message the SN 106A receives 2709 is an RRCReconfigurationComplete message.

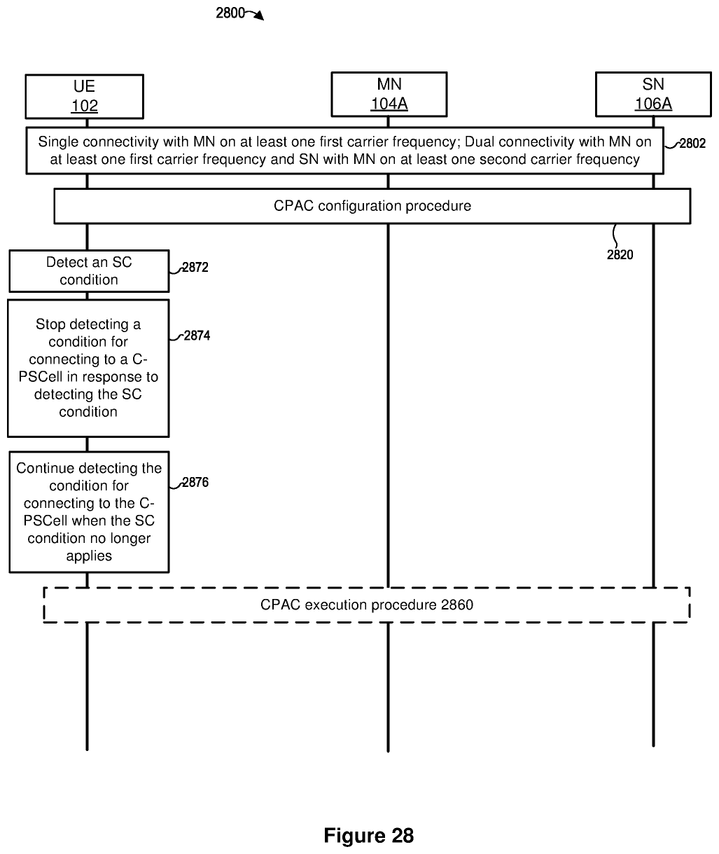

Now referring to FIG. 28, the UE 102 in a scenario 2800 detects an SC condition and stops monitoring the network-specified condition for a CPAC procedure. In particular, this scenario begins with the UE 102 operating 2802 in SC with the MN 104A or in DC with the MN 104A and SN 106A, similar to event 2702 discussed above with reference to FIGS. 27A and 27B. The UE 102, the MN 104A, and the SN 106A then perform a CPAC configuration procedure 2820, similar to procedure 2720A and 2720B.

The UE 102 at some point detects 2872 the SC condition. As discussed above, the SC condition is not network-specified (in this case, not specified by the RAN 105) but rather originates at the UE 102. The SC condition can be any of the remaining power level being below a certain threshold level, the required data rate being below a certain threshold rat, no application requiring DC currently running, the strength or quality of the carrier signal at the SN being below a certain threshold level, etc., or any combination of two or more of these conditions.

In response to the event 2772, the UE 102 stops 2874 detecting the one or more conditions for applying the configuration associated with the CPAC procedure. The UE 102 thus inhibits application of this configuration. When, a later time, the UE 102 determines 2876 that the SC condition no longer applies, the UE 102 can again begin attempting to detect the condition of the CPAC procedure. If the UE 102 detects this condition, the UE 102, the MN 104A, and the SN 106A carry out the CPAC operation 2860, which is similar to the CPAC operation 2760 discussed above. In some implementations, the UE 102 disables DC as described above to stop 2874 detecting the condition(s) of the CPAC procedure. In some implementations, the UE 102 enables DC as described above to continue 2876 detecting the condition(s) of the CPAC procedure.

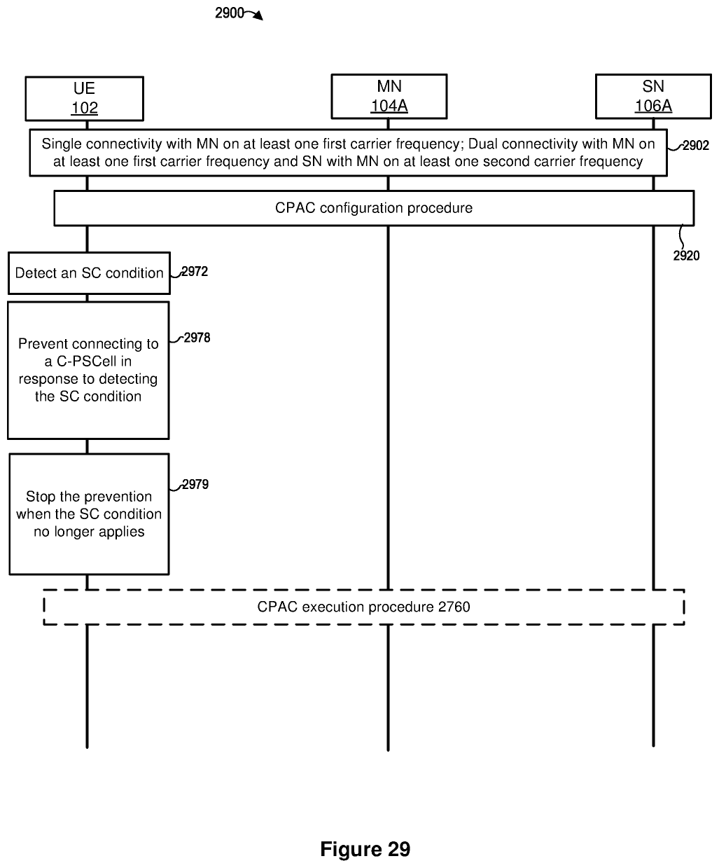

In FIG. 29, a scenario 2900 also involves CPAC and an SC condition. Events 2902, 2920, and 2972 are similar to events 2802, 2820, and 2872, respectively. However, the UE 102 in this case inhibits 2978 application of the conditional configuration by directly preventing the UE 102 from connecting to the C-PSCell, in response to detecting the SC condition. Thus, the UE 102 can test the condition for CPAC and determine that this condition is satisfied, but the UE 102 will not carry out the CPAC procedure because of the SC condition. When, a later time, the UE 102 determines 2979 that the SC condition no longer applies, the UE 102 no longer prevents the UE 102 from connecting to the C-PSCell. If the UE 102 determines that the condition for CPAC, the UE 102, the MN 104A, and the SN 106A carry out the CPAC operation 2960, which is similar to the CPAC operation 2860 discussed above.

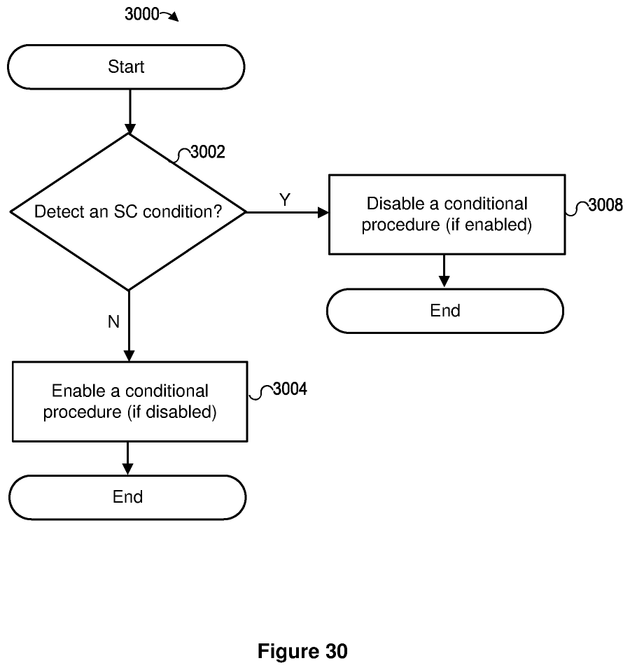

Next, FIG. 30 illustrates an example method 300 for disabling a conditional procedure related to DC in view of an SC condition, which can be implemented in the UE 102. The method 3000 begins at block 3002, where the UE 102 determines whether an SC condition has occurred. Similar to the examples above, the SC condition can be for example (i) a low-power condition of the battery 103, (ii) a low data rate requirement of the UE 102, (iii) no applications requiring DC running on the UE 102, (iv) the quality or strength of the signal at the SN is below a certain threshold level. As also discussed above with reference to FIG. 2 for example, the UE 102 can check any suitable number of SC conditions and define any suitable interactions between these conditions to determine whether the overall SC condition is satisfied at block 3002.

If the UE 102 does not detect an SC condition, the UE 102 at block 3004 enables the conditional procedure related to DC, such as CSAC or CPAC, when conditional procedure previously was disabled. In another scenario, the UE 102 keeps the conditional procedure enabled, when the conditional procedure is already enabled. However, if the UE 102 detects an SC condition, the UE 102 at block 3008 disables the conditional procedure, if the conditional procedure capability previously was enabled. In another scenario, when the conditional procedure is already disabled, the UE 102 keeps the conditional procedure disabled.

Although the method 3000 as illustrated in FIG. 30 completes after block 3004 or block 3008, in general the UE 102 can execute the method 3000 in an iterative manner, e.g., by “looping back” to block 3002 after executing block 3004 or block 3008.

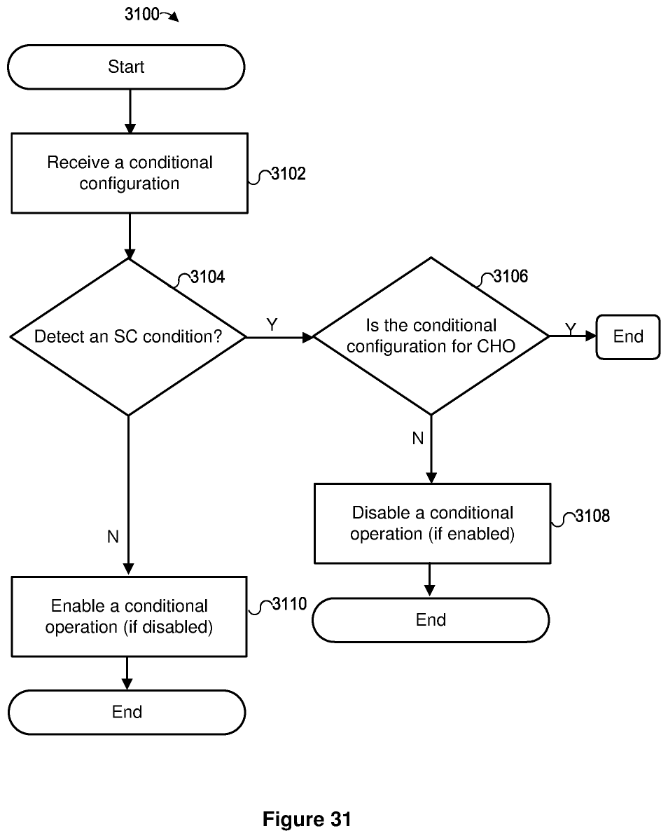

FIG. 31 illustrates an example method 3100 for disabling a conditional procedure in view of an SC condition and a type of the conditional procedure, which can be implemented in the UE 102. The method 3102 begins at block 3102, where a conditional configuration is received from the RAN 105, for example. The conditional configuration corresponds to a network-specified condition.

At block 3104, the UE 102 determines whether an SC condition has occurred, i.e., is satisfied. If the UE 102 does not detect an SC condition, the UE 102 at block 3110 enables the conditional procedure related to DC, such as CSAC or CPAC, when conditional procedure previously was disabled. In another scenario, the UE 102 keeps the conditional procedure enabled, when the conditional procedure is already enabled.

However, if the UE 102 detects an SC condition, the UE 102 at block 3106 determines whether the conditional procedure is CHO. If the conditional procedure is CHO, the method 3100 completes without affecting the conditional procedure. If the conditional procedure is a conditional procedure related to DC other than CHO, the UE 102 at block 3108 disables the conditional operation, if the conditional procedure was previously enabled.

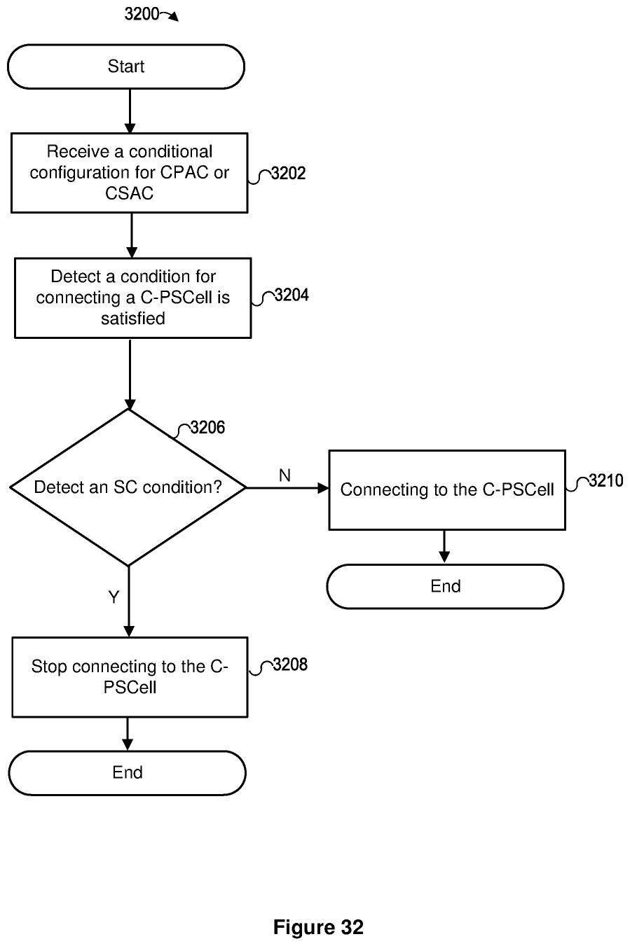

Now referring to FIG. 32, an example method 3200 for processing an SC condition and a condition for connecting to a C-PSCell begins at block 3202, where a conditional configuration and a network-specified condition for applying this configuration is received from the RAN 105. The conditional configuration pertains to CPAC or CSAC. At block 3204, the UE 102 determines that a condition for connecting to a C-PSCell (and thus performing the CSAC or CPAC procedure) is satisfied. At block 3206, the UE 102 determines whether the SC condition of the UE 102 is satisfied.

When the SC condition is satisfied, the flow proceeds to block 3208, where the UE 102 stops connecting to the C-PSCell. The UE 102 thus inhibits the application of the conditional configuration. On the other hand, when the UE 102 does not detect an SC condition at block 3206, the flow proceeds to block 3210, where the UE 102 connects to the C-PSCell.

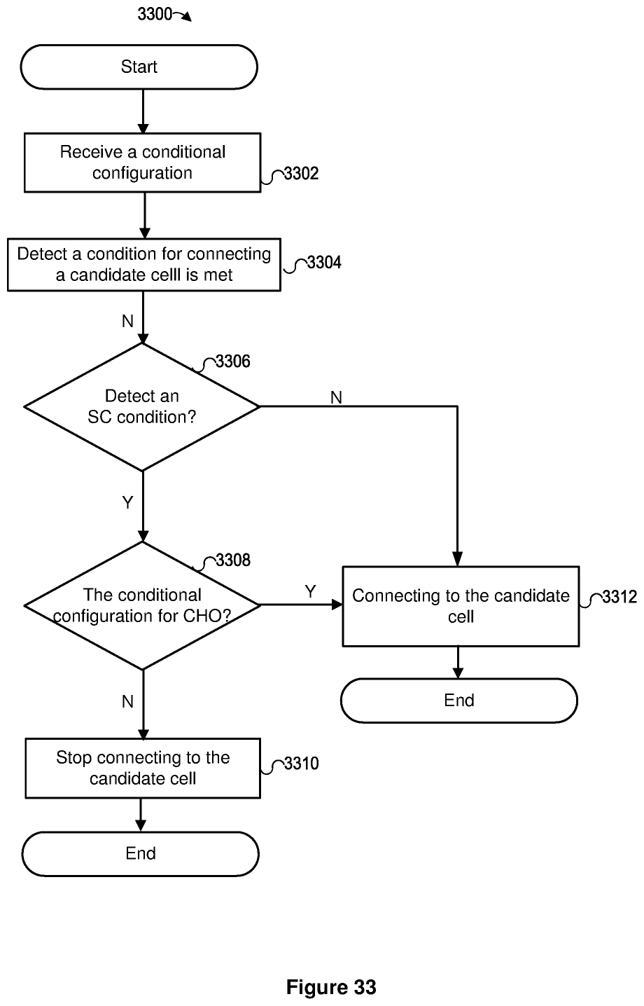

Now referring to FIG. 33, an example method 3300 for processing an SC condition and a condition for connecting to a candidate cell begins at block 3302, where a conditional configuration and a network-specified condition for applying this configuration is received from the RAN 105. The conditional configuration can pertain to a conditional procedure related to DC, such as CSAC, CPAC, or CHO. At block 3304, the UE 102 determines that a condition for connecting to the candidate cell is satisfied. At block 3306, the UE 102 determines whether the SC condition of the UE 102 is satisfied.

When the SC condition is satisfied, the flow proceeds to block 3308, where the UE 102 determines whether the conditional configuration is for CHO. Otherwise, when the SC condition is not satisfied, the flow proceeds to block 3312, where the UE 102 connects to the candidate cell.

When the UE 102 determines at block 3308 that the conditional configuration is for CHO, the flow proceeds to block 3312. However, if the conditional configuration is for another conditional procedure related to DC (e.g., CSAC or CPAC), the flow proceeds to block 3310, where the UE 102 stops connecting to the candidate cell.

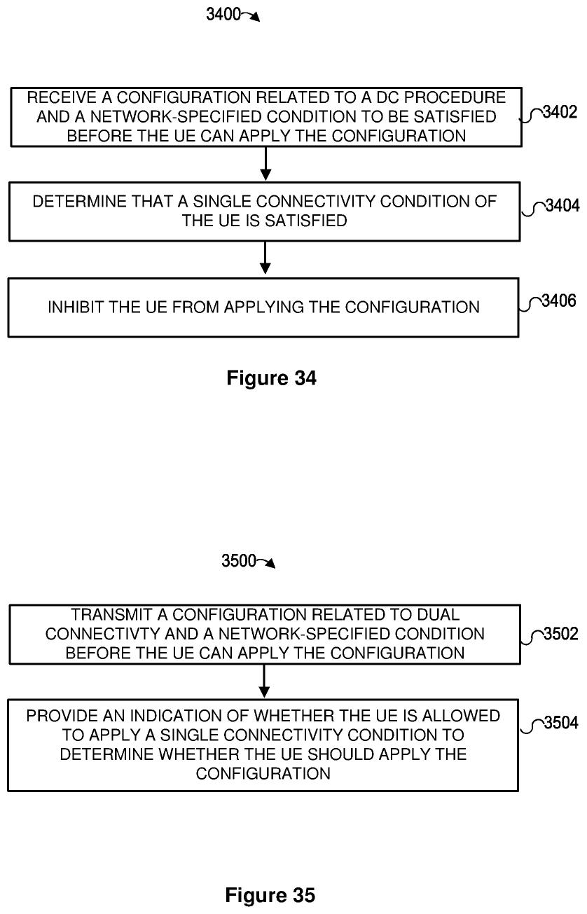

FIG. 34 is a flow diagram of an example method 3400 for processing conditional configuration related to DC, which can be implemented in a UE such as the UE 102. At block 3402, a UE capable of operating in DC with an MN and SN receives, from the RAN, a configuration related to a DC procedure and a network-specified condition to be satisfied before the UE applies the configuration (event 2550 of FIG. 25, event 2650 of FIG. 26, event 2820 of FIG. 28, event 2920 of FIG. 29, block 3202 of FIG. 32, block 3302 of FIG. 33). At block 3402, the UE 102 determines that an SC condition of the UE is satisfied (event 2572 of event FIG. 25, event 2672 of event FIG. 25, event 2872 of event FIG. 28, event 2972 of FIG. 29, block 3002 of FIG. 30, block 3104 of FIG. 31, block 3206 of FIG. 32, block 3306 of FIG. 33). At block 3406 the UE 102 inhibits the UE from applying the configuration (event 2574 of event FIG. 25; event 2678 of FIG. 26, event 2876 of FIG. 28, even 2978 of FIG. 29, block 3008 of FIG. 30, block 3108 of FIG. 30, block 3208 of FIG. 32, block 3310 of FIG. 33).

FIG. 35 is a flow diagram of an example method 3500 for managing conditional configuration at a UE, which can be implemented in a base station such as the MN 104A or 104B. At block 3502, the base station transmits to the UE a configuration related to a DC procedure and a network-specified condition to be satisfied before the UE applies the configuration. At block 3504, the base station provides, to the UE, an indication of whether the UE is allowed to apply an SC condition to determine whether the UE should apply the configuration.

The following additional considerations apply to the foregoing discussion.

“Carrier frequency” may be interchangeable with “cell,” “secondary cell (SCell)” or “primary secondary cell (PSCell).” The cell or SCell may be a frequency division duplex (FDD) cell or a time division duplex (TDD) cell. In case of the TDD cell, the UE may be configured by the SN to receive downlink transmissions on a carrier frequency of the TDD cell but may or may not be configured to transmit uplink transmissions on the carrier frequency of the TDD cell. In case of the FDD cell, the UE may be configured by the SN to receive downlink transmissions on a downlink carrier frequency of the FDD cell but may or may not be configured to transmit uplink transmissions on an uplink carrier frequency of the FDD cell.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC), a digital signal processor (DSP)) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The following list of examples reflects a variety of the embodiments explicitly contemplated by the present disclosure.

Example 1. A method in a UE capable of operating in DC with an MN and an of a RAN includes receiving, by processing hardware and from the RAN, a configuration related to a DC procedure and a network-specified condition to be satisfied before the UE applies the configuration; determining, by processing hardware, whether a single connectivity (SC) condition of the UE is satisfied; and when SC condition is satisfied: inhibiting, by the processing hardware, the UE from applying the configuration.\

Example 2. The method of example 1, further comprising: receiving, from the RAN, an indication that the UE is allowed to apply the SC condition.

Example 3. The method of example 2, wherein: the SC condition is a first SC condition; the indication is a first indication; and the method further comprising: receiving, from the RAN, a second indication that the UE is not allowed to apply a second SC condition.

Example 4. The method of example 1 or 2, wherein the SC condition is a low data requirement at the UE, the low data requirement corresponding to a minimum required data rate for the UE being below a threshold level.

Example 5. The method of example 1 or 2, wherein the SC condition is a requirement that no applications requiring DC currently are running on the UE.

Example 6. The method of example 1 or 2, wherein the SC condition is a quality of a carrier of the SN being below a threshold level.

Example 7. The method of example 1 or 2, wherein the SC condition is a low-power condition of a battery of the UE.

Example 8. The method of example 1 or 2, wherein the SC condition is a hot-temperature condition of the UE.

Example 9. The method of any of the preceding examples, wherein the DC procedure is a conditional SN addition or change (CSAC) procedure.

Example 10. The method of examples 1-8, wherein the DC procedure is a conditional PSCell addition or change (CPAC) procedure.

Example 11. The method of example 9 or 10, further comprising, in a second instance: receiving, by the processing hardware and from the RAN, a second configuration related to a conditional handover (CHO) procedure and a second network-specified condition to be satisfied before the UE applies the configuration; and when SC condition is satisfied: allowing, by the processing hardware, the UE to apply the second configuration.

Example 12. The method of any of the preceding examples, wherein the inhibiting includes: in response to determining that the SC condition is satisfied, inhibiting the UE from monitoring the network-specified condition.

Example 13. The method of example 12, further comprising: subsequently to the inhibiting the UE from monitoring the network-specified condition, determining that the SC condition is no longer satisfied; and resuming, by the processing hardware, the monitoring of the network-specified condition.

Example 14. The method of any claims 1-11, wherein the inhibiting includes: in response to determining that the SC condition is satisfied, preventing the UE from applying the configuration, irrespective of the network-specified condition.

Example 15. The method of any of the preceding examples, wherein: the SC condition corresponds to a first threshold value; the method further comprising: in response to detecting a second threshold value, disabling MN carrier aggregation (CA).

Example 16. The method of any of examples 1-14, the method further comprising: determining, by processing hardware, whether a non-CA condition of the UE is satisfied; and when non-CA condition is satisfied: disabling MN CA.

Example 17. The method of any of the preceding examples, wherein inhibiting the UE from applying the configuration includes disabling DC.

Example 18. The method of any of examples 17, wherein inhibiting the UE from operating in DC includes suspending measurements on a carrier frequency of the SN.

Example 19. The method of example 17, wherein inhibiting the UE from operating in DC includes transmitting a report of measurements on a carrier frequency of the SN, the report indicating at least one of a low signal strength or a low signal quality.

Example 20. The method of example 17, further comprising: operating in SC prior to determining the SC condition; and transmitting, from the UE to the MN, an indication that the UE has disabled DC.

Example 21. The method of example 20, wherein transmitting the indication includes transmitting, from the UE to the MN, a UE capability information message.

Example 22. The method of example 21, wherein transmitting the UE capability information message includes: generating a radio access capability information element (IE); and including a DC band combination in the radio access capability IE to indicate that the UE has enabled DC, and not including a DC band combination in the radio access capability IE to indicate that the UE has disabled DC.

Example 23. The method of example 21, wherein transmitting the UE capability information message includes: generating a radio access capability IE; and including at least one of a DC support indicator or a list of DC-supported bands in the radio access capability IE to indicate that the UE has enabled DC, and not including a DC support indicator or a list of DC-supported bands in the radio access capability IE to indicate that the UE has disabled DC.

Example 24. The method of example 21, wherein transmitting the UE capability information message comprises: including a radio access capability IE with a DC band combination in the UE capability information message to indicate that the UE has enabled DC, and not including a radio access capability IE in the UE capability information message to indicate that the UE has disabled DC.

Example 25. The method of example 17, wherein the MN operates using a first radio access technology (RAT), and the second SN operates using a second RAT, and wherein inhibiting the UE from operating in DC includes: disabling a chip of the UE that supports communication according to the second RAT.

Example 26. A UE including processing hardware and configured to implement a method according to any of examples 1-25.

Example 27. A method in a radio access network (RAN) for configuring a user equipment (UE), the method comprising: transmitting, by processing hardware and to the UE, a configuration related to a dual connectivity (DC) procedure and a network-specified condition to be satisfied before the UE applies the configuration; and providing, by the processing hardware to the UE, an indication of whether the UE is allowed to apply a single connectivity (SC) condition to determine whether the UE should apply the configuration.

Example 28. The method of example 27, wherein proving the indication includes transmitting a flag to the UE indicating whether the UE is allowed to the SC condition.

Example 29. A base station including processing hardware and configured to implement a method according to example 27 or 28.

1. A method performed in a user device (UE) capable of operating in dual-mode connectivity (DC) with a master node (MN) and a secondary node (SN) of a radio access network (RAN), the method comprising:
receiving, from the RAN, a configuration related to a DC procedure and a network-specified condition to be satisfied before the UE applies the configuration;
determining, whether a single connectivity (SC) condition of the UE is satisfied; and
when SC condition is satisfied:
inhibiting, the UE from applying the configuration.

2. The method of claim 1, further comprising:
receiving, from the RAN and prior to checking whether the SC condition is satisfied, an indication that the UE is allowed to apply the SC condition.

3. The method of claim 2, wherein:
the indication is a first indication; and
the method further comprising:
receiving, from the RAN, a second indication that the UE is not allowed to apply a a carrier aggregation (CA) condition.

4. The method of claim 1, wherein the SC condition includes one of:
(i) a low data requirement at the UE, the low data requirement corresponding to a minimum required data rate for the UE being below a threshold level,
(ii) a requirement that no applications requiring DC currently are running on the UE,
(iii) a requirement that a quality of a carrier of the SN be below a threshold level,
(iv) a low-power condition of a battery of the UE, or
(v) a hot-temperature condition of the UE.

5. The method of claim 1, wherein the DC procedure is one of:
(i) a conditional SN addition or change (CSAC) procedure, or
(ii) a conditional PSCell addition or change (CPAC) procedure.

6. The method of claim 5, wherein:
the receiving of the configuration, the determining of whether the SC condition of the UE is satisfied, and the inhibiting occur in a first instance; the method further comprising, in a second instance:
receiving, by the UE and from the RAN, a second configuration related to a conditional handover (CHO) procedure and a second network-specified condition to be satisfied before the UE applies the configuration; and
when the SC condition is satisfied:
allowing, by the UE, the UE to apply the second configuration.

7. The method of claim 1, wherein the inhibiting includes:
in response to determining that the SC condition is satisfied, inhibiting the UE from monitoring the network-specified condition.

8. The method of claim 6, further comprising:
subsequently to the inhibiting the UE from monitoring the network-specified condition, determining that the SC condition is no longer satisfied; and
resuming, by the UE, the monitoring of the network-specified condition.

9. The method of claim 1, wherein the inhibiting includes:
in response to determining that the SC condition is satisfied, preventing the UE from applying the configuration, irrespective of whether the network-specified condition is satisfied.

10. The method of claim 1, wherein:
the SC condition corresponds to a first threshold value of a parameter associated with the UE;
the method further comprising:
in response to detecting a second threshold value of the parameter, disabling MN carrier aggregation (CA).

11. The method of claim 1, wherein inhibiting the UE from applying the configuration includes disabling DC.

12. The method of claim 11, wherein the inhibiting of the UE from operating in DC includes at least one of:
(i) suspending measurements on a carrier frequency of the SN, or
(ii) transmitting a report of the measurements on the carrier frequency of the SN, the report indicating at least one of a low signal strength or a low signal quality.

13. (canceled)

14. A method performed in a radio access network (RAN) for configuring a user equipment (UE), the method comprising:
transmitting, to the UE, a configuration related to a dual connectivity (DC) procedure and a network-specified condition to be satisfied before the UE applies the configuration; and
providing, to the UE, an indication of whether the UE is allowed to apply a single connectivity (SC) condition to determine whether the UE is to apply, subject to the network-specified condition, the configuration.

15. (canceled)

16. The method of claim 14, wherein the SC condition includes one of:
(i) a low data requirement at the UE, the low data requirement corresponding to a minimum required data rate for the UE being below a threshold level,
(ii) a requirement that no applications requiring DC currently are running on the UE,
(iii) a requirement that a quality of a carrier of the SN be below a threshold level,
(iv) a low-power condition of a battery of the UE, or
(v) a hot-temperature condition of the UE.

17. The method of claim 14, wherein:
the indication is a first indication; and
the method further comprising:
transmitting, to the UE, a second indication that the UE is not allowed to apply a carrier aggregation (CA) condition.

18. A user equipment (UE) capable of operating in dual-mode connectivity (DC) with a master node (MN) and a secondary node (SN) of a radio access network (RAN), the UE comprising:
a transceiver component; and
a processing component configured to:
receive, from the RAN, a configuration related to a DC procedure and a network-specified condition to be satisfied before the UE applies the configuration;
determine whether a single connectivity (SC) condition of the UE is satisfied; and
when SC condition is satisfied:
inhibit UE from applying the configuration.

19. The UE of claim 18, wherein the processing component is configured to:
receive, from the RAN, an indication that the UE is allowed to apply the SC condition.

20. The UE of claim 19, wherein:
the indication is a first indication; and
the method further comprising:
transmitting, to the UE, a second indication that the UE is not allowed to apply a a carrier aggregation (CA) condition.

21. The UE of claim 18, wherein the SC condition includes one of:
(i) a low data requirement at the UE, the low data requirement corresponding to a minimum required data rate for the UE being below a threshold level,
(ii) a requirement that no applications requiring DC currently are running on the UE,
(iii) a requirement that a quality of a carrier of the SN be below a threshold level,
(iv) a low-power condition of a battery of the UE, or
(v) a hot-temperature condition of the UE.

22. The UE of claim 18, wherein the DC procedure is one of:
(i) a conditional SN addition or change (CSAC) procedure, or
(ii) a conditional PSCell addition or change (CPAC) procedure.
